(19) United States
(12) Patent Application Publication
(10) Pub. No.: US 2023/0122061 A1
(43) Pub. Date: Apr. 20, 2023

(54) SOFT MAGNETIC COMPOSITION, SINTERED BODY, COMPOSITE BODY, PASTE, COIL COMPONENT, AND ANTENNA

(71) Applicant: Murata Manufacturing Co., Ltd., Nagaokakyo-shi (JP)

(72) Inventor: Terunobu ISHIKAWA, Nagaokakyo-shi (JP)

(21) Appl. No.: 18/067,860

(22) Filed: Dec. 19, 2022

Related U.S. Application Data
(63) Continuation of application No. PCT/JP2021/029193, filed on Aug. 5, 2021.

(30) Foreign Application Priority Data
Aug. 6, 2020 (JP) 2020-133710

(51) Int. Cl. H01F 1/34; H01F 3/08

(52) U.S. Cl. CPC H01F 1/348; H01F 3/08

(57) ABSTRACT

A soft magnetic composition that includes an oxide containing a W-type hexagonal ferrite having a compositional formula of ACaMe₂Fe₁₆O₂₇ as a main phase, wherein A is one or more selected from Ba, Sr, Na, K, La, and Bi at 4.7 mol % to 5.8 mol %; Me is one or more selected from Co, Cu, Mg, Mn, Ni, and Zn at 9.4 mol % to 18.1 mol %, the Ca is 0.2 mol % to 5.0 mol %, the Fe is 67.4 mol % to 84.5 mol %, and the soft magnetic composition has a coercivity Hcj of 100 kA/m or less.

### CROSS REFERENCE TO RELATED APPLICATIONS

The present application is a continuation of International application No. PCT/JP2021/029193, filed Aug. 5, 2021, which claims priority to Japanese Patent Application No. 2020-133710, filed Aug. 6, 2020, the entire contents of each of which are incorporated herein by reference.

### FIELD OF THE INVENTION

The present invention relates to a soft magnetic composition, a sintered body, a composite body, a paste, a coil component, and an antenna.

### BACKGROUND OF THE INVENTION

Magnetic materials such as ferrite materials are widely used as materials constituting components such as inductors, antennas, noise filters, radio wave absorbers, and LC filters combined with capacitors. These components utilize the properties of the magnetic permeability μ′, which is a real term, or the magnetic loss component μ″, which is an imaginary term, of the complex magnetic permeability μ of the magnetic material depending on the purpose. For example, an inductor or an antenna is required to have a high magnetic permeability μ′. Furthermore, it is also preferable that an inductor or an antenna has a low magnetic loss component μ″, and thus the magnetic loss tan δ obtained by a ratio of μ″/μ′ is required to be low.

In recent years, the frequency band used by electronic appliances has become higher, and magnetic materials that satisfy the properties required in the GHz band have been in demand. For example, in a communication market such as a part of 5G (5th Generation) which is a mobile information communication standard, electronic toll collection system (ETC), and Wi-Fi (registered trademark) of a 5 GHz band, it is assumed that electronic appliances are used in a range of about 4 to 6 GHz.

Patent Document 1 discloses a W-type ferrite sintered magnet composed of a hexagonal W-type ferrite phase having a composition formula represented by AO.n(BO).mFe₂O₃, (wherein A is one or two or more of Ba, Sr, Ca, and Pb, B is one or two or more of Fe, Co, Ni, Mn, Mg, Cr, Cu, and Zn, 7.4≤m≤8.8, and 1.2≤n≤2.5), having an average crystal grain size of 0.3 to 4 μm, and having magnetic anisotropy in a specific direction.

Patent Document 2 discloses a ferrite magnet having a main phase of W-type ferrite containing A (A is Sr, Ba, or Ca), Co, and Zn, and having a basic composition in which a constituent ratio of a total of the respective metal elements (A, Fe, Co, and Zn) is A: 1 to 13 atom %, Fe: 78 to 95 atom %, Co: 0.5 to 15 atom %, and Zn: 0.5 to 15 atom % with respect to the total metal element amount.

Patent Document 3 discloses a W-type ferrite powder represented by a composition formula (Sr₁₋ₓCaₓ)O.(Fe_{2-y}M_{y})O.n(Fe₂O₃) (provided that M is at least one element selected from Ni, Zn, and Co), wherein x, y, and n representing a molar ratio are 0.05≤x≤0.3, 0.5<y<2, and 7.2≤n≤7.7, and having a constituent phase which is a W single phase.

Patent Document 4 discloses a ferrite radio wave absorbing material containing a c-axis anisotropic compound having a crystal structure of a W-type hexagonal ferrite whose composition formula is AMe₂Fe₁₆O₂₇, wherein A in the composition formula is one or two or more of Ca, Ba, Sr, and Pb, Me having a total amount of 2 moles contains 0.8 moles or less of Co, and one or two or more of Mg, Mn, Fe, Ni, Cu, and Zn. Further, Patent Document 4 discloses a ferrite radio wave absorbing material containing a c-axis anisotropic compound having a crystal structure of a W-type hexagonal ferrite represented by AO: 8 to 10 mol %, MeO: 17 to 19 mol %, and Fe₂O₃: 71 to 75 mol %, wherein A is one or two or more of Ca, Ba, Sr, and Pb, and MeO contains 7 mol % or less of CoO and one or two or more of MgO, MnO, FeO, NiO, CuO, and ZnO.

Patent Document 5 discloses a method for producing W-phase type oxide magnetic particles, in which a coprecipitate is obtained from a mixed aqueous solution including at least one of a salt of R²⁺ (provided that R is at least one of Ba, Sr, Pb, and Ca), a salt of Me²⁺ (provided that Me is at least one of Ni, Co, Cu, Cd, Zn, Mg, and iron), a ferrous salt, and a ferric salt in the presence of an alkali or an oxalate salt, the coprecipitate is separated, washed, filtered, and dried, and then fired to obtain ferrite particles of a W-phase single phase or a composite phase containing a W-phase.
Patent Document 1: Japanese Patent Application Laid-Open No. 2000-311809
Patent Document 2: Japanese Patent Application Laid-Open No. 2003-133119
Patent Document 3: Japanese Patent Application Laid-Open No. 2017-69365
Patent Document 4: Japanese Patent Application Laid-Open No. 2005-347485
Patent Document 5: Japanese Patent Application Laid-Open No. S59-174530

### SUMMARY OF THE INVENTION

Patent Documents 1 and 2 each describe a ferrite magnet. FIG. 1 of Patent Document 1 describes that the coercivity is 100 kA/m or more. Examples 9, 10, and 11 of Patent Document 2 describe that the coercivity is 159.2 kA/m, 175.1 kA/m, and 175.1 kA/m, respectively. Thus, the ferrite materials described in Patent Documents 1 and 2 are effective as magnet materials, but have too high coercivity to be used as materials for inductors and antennas.

Patent Document 3 describes that a ferrite material can be suitably used as a sintered magnet or a bonded magnet. Furthermore, Patent Document 3 points out a problem that the coercivity decreases when the M element becomes 2, that is, when Fe′ becomes 0. In the ferrite material, a low-temperature demagnetization phenomenon is known. If the coercivity is as low as 100 kA/m or less in the case of being used as a magnet material, as shown in FIG. 2, a problem that the magnetic force decreases when the temperature is returned from low temperature to normal temperature is likely to occur due to the low-temperature demagnetization phenomenon. In practical use, the ferrite material described in Patent Document 3 is made to have a high coercivity in order to prevent a low-temperature demagnetization phenomenon of the magnet material, and thus it is estimated that the coercivity is too high for use as a material of an inductor or an antenna.

Patent Document 4 describes that in a material of a radio wave absorber requiring a high magnetic loss, the imaginary part μ″ is increased. Thus, the ferrite material described in Patent Document 4 is greatly different in application and properties from materials of inductors and antennas that require a low magnetic loss tan δ=μ″/μ′.

Patent Document 5 describes a composition formula of a W phase of BaMe₂Fe₁₆O₂₇. However, in the examples, only examples of Cd, Cu, Fe, and Zn are disclosed as Me, compositions using Co, Mg, or Ni are not disclosed, and Mn is outside the scope of the claims. The application of the patent is for magnetic recording, and there is no mention of high magnetic permeability or low loss required for inductors and antennas. In the example in which Ca is contained in the Ba site, the Me element is only Fe, and the example of Zn₂-W-type ferrite does not contain Ca, and thus, in the patent, there is no example composition overlapping with the present invention. When the Ca substitution amount is changed with respect to Ba as in Example 1, Fe enters the Me site, so that it is considered that a composition represented by Ba₁₋ₓCaₓFe²⁺₂Fe³⁺₁₆O₂₇ is obtained. That is, Fe²⁺ and Fe³⁺ are distinguished from each other as divalent Fe and trivalent Fe.

As described above, although various ferrite materials are described in Patent Documents 1 to 5, at present, a ferrite material which is a soft magnetic material having a low coercivity, and has a high magnetic permeability μ′ and a low magnetic loss tan δ in a high frequency range is not obtained.

The present invention has been made to solve the above problems, and an object thereof is to provide a soft magnetic composition having a high magnetic permeability μ′ and a low magnetic loss tan δ in a high frequency range such as 6 GHz. Furthermore, an object of the present invention is to provide a sintered body, a composite body, and a paste using the soft magnetic composition, and to provide a coil component and an antenna using the sintered body, the composite body, or the paste.

The soft magnetic composition of the present invention includes an oxide containing a W-type hexagonal ferrite having a compositional formula of ACaMe₂Fe₁₆O₂₇ as a main phase, wherein:

A is one or more selected from Ba, Sr, Na, K, La, and Bi,

Ba+Sr+Na+K+La+Bi: 4.7 mol % to 5.8 mol %,

Ba: 0 mol % to 5.8 mol %,

Sr: 0 mol % to 5.8 mol %;

Na: 0 mol % to 5.2 mol %,

K: 0 mol % to 5.2 mol %,

La: 0 mol % to 2.1 mol %,

Bi: 0 mol % to 1.0 mol %,

Ca: 0.2 mol % to 5.0 mol %

Fe: 67.4 mol % to 84.5 mol %,

Me is one or more selected from Co, Cu, Mg, Mn, Ni, and Zn,

Co+Cu+Mg+Mn+Ni+Zn: 9.4 mol % to 18.1 mol %,

Cu: 0 mol % to 1.6 mol %,

Mg: 0 mol % to 17.1 mol %,

Mn: 0 mol % to 17.1 mol %,

Ni: 0 mol % to 17.1 mol %,

Zn: 0 mol % to 17.1 mol %,

Co: 0 mol % to 2.6 mol %,

a charge balance D is 7.8 mol % to 11.6 mol %, when: Me (I)=Na+K+Li, Me (II)=Co+Cu+Mg+Mn Ni Zn, Me (IV)=Ge+Si+Sn+Ti+Zr+Hf, Me (V)=Mo+Nb+Ta+Sb+W+V, and D=Me (I)+Me (II)−Me (IV)−2×Me (V),

at least part of the Fe is substituted with M_{2d} in an amount of 0 mol % to 7.8 mol %,

M_{2d} is at least one of In, Sc, Sn, Zr, or Hf,

Sn: 0 mol % to 7.8 mol %,

Zr+Hf: 0 mol % to 7.8 mol %,

In: 0 mol % to 7.8 mol %,

Sc: 0 mol % to 7.8 mol %,

Ge: 0 mol % to 2.6 mol %,

Si: 0 mol % to 2.6 mol %,

Ti: 0 mol % to 2.6 mol %,

Al: 0 mol % to 2.6 mol %,

Ga: 0 mol % to 2.6 mol %,

Mo: 0 mol % to 2.6 mol %,

Nb+Ta: 0 mol % to 2.6 mol %,

Sb: 0 mol % to 2.6 mol %,

W: 0 mol % to 2.6 mol %,

V: 0 mol % to 2.6 mol %,

Li: 0 mol % to 2.6 mol %, and

the soft magnetic composition has a coercivity Hcj of 100 kA/m or less.

The sintered body of the present invention is obtained by firing the soft magnetic composition of the present invention.

The composite body of the present invention is obtained by mixing the soft magnetic composition of the present invention and a nonmagnetic body, and is integrated.

The paste of the present invention is obtained by mixing the soft magnetic composition of the present invention and a nonmagnetic body, and has fluidity and high viscosity. Since the paste has fluidity, it is easy to form in a space with an opening or the like.

A coil component of the present invention includes a core portion and a winding portion provided around the core portion, the core portion is formed by using the sintered body, the composite body, or the paste of the present invention, and the winding portion contains an electric conductor.

The antenna of the present invention is formed by using the sintered body, the composite body, or the paste of the present invention and an electric conductor.

According to the present invention, it is possible to provide a soft magnetic composition having a high magnetic permeability and a low magnetic loss tan δ in a high frequency range of, for example, 6 GHz.

### BRIEF EXPLANATION OF THE DRAWINGS

FIG. 1 is a schematic view showing a crystal structure of W-type hexagonal ferrite.

FIG. 2 is a BH curve for explaining low-temperature demagnetization.

FIG. 3 is an X-ray diffraction chart of a composition formula BaCa_{0.3}Me₂Fe₁₆O₂₇ (Me=Co, Mg, Mn, Ni, Zn, or Cu).

FIG. 4 is an X-ray diffraction chart of a composition formula BaCaₓMn₂Fe₁₆O₂₇ (x=0, 0.3, or 1.0).

FIG. 5 is a surface SEM image of a sintered body of composition formula BaCa_{0.3}Mg_{1.8}Co_{0.2}Fe₁₆O₂₇.

FIG. 6 is a surface SEM image of a sintered body of composition formula BaCa_{0.3}Mn_{1.8}Co_{0.2}Fe₁₆O₂₇.

FIG. 7 is a surface SEM image of a sintered body of composition formula BaCa_{0.3}Ni_{1.8}Co_{0.2}Fe₁₆O₂₇.

FIG. 8 is a surface SEM image of a sintered body of composition formula BaCa_{0.3}Zn_{1.8}Co_{0.2}Fe₁₆O₂₇.

FIG. 9 is a graph showing frequency characteristics of magnetic permeability μ in a composition formula BaCa_{0.3}Me₂Fe₁₆O₂₇ (Me=Co, Mg, or Mn).

FIG. 10 is a graph showing frequency characteristics of magnetic loss tan δ in a composition formula BaCa_{0.3}Me₂Fe₁₆O₂₇ (Me=Co, Mg, or Mn).

FIG. 11 is a graph showing frequency characteristics of magnetic permeability μ in a composition formula BaCa_{0.3}Me₂Fe₁₆O₂₇ (Me=Co, Ni, or Zn).

FIG. 12 is a graph showing frequency characteristics of magnetic loss tan δ in a composition formula BaCa_{0.3}Me₂Fe₁₆O₂₇ (Me=Co, Ni, or Zn).

FIG. 13 is a graph showing frequency characteristics of magnetic permeability μ in a composition formula BaCaₓMn_{1.8}Co_{0.2}Fe₁₆O₂₇ (x=0 or 0.3).

FIG. 14 is a graph showing frequency characteristics of magnetic loss tan δ in a composition formula BaCaₓMn_{1.8}Co_{0.2}Fe₁₆O₂₇ (x=0 or 0.3).

FIG. 15 is a graph showing frequency characteristics of magnetic permeability μ in a composition formula BaCa_{0.3}Mn₂₋ₓCoₓFe₁₆O₂₇ (x=0, 0.2, or 0.5).

FIG. 16 is a graph showing frequency characteristics of magnetic loss tan δ in a composition formula BaCa_{0.3}Mn₂₋ₓCoₓFe₁₆O₂₇ (x=0, 0.2, or 0.5).

FIG. 17 is a graph showing frequency characteristics of magnetic permeability μ in a composition formula BaCa_{0.3}Ni₂₋ₓCoₓFe₁₆O₂₇ (x=0, 0.2, or 0.5).

FIG. 18 is a graph showing frequency characteristics of magnetic loss tan δ in a composition formula BaCa_{0.3}Ni₂₋ₓCoₓFe₁₆O₂₇ (x=0, 0.2, or 0.5).

FIG. 19 is a graph showing frequency characteristics of magnetic permeability μ in a composition formula BaCa_{0.3}Zn₂₋ₓCoₓFe₁₆O₂₇ (x=0, 0.2, or 0.5).

FIG. 20 is a graph showing frequency characteristics of magnetic loss tan δ in a composition formula BaCa_{0.3}Zn₂₋ₓCoₓFe₁₆O₂₇ (x=0, 0.2, or 0.5).

FIG. 21 is a graph showing frequency characteristics of magnetic permeability μ in composition formulas (Ba₁₋ₓSrₓ)Ca_{0.3}Mn_{1.8}Co_{0.2}Fe₁₆O₂₇ (x=0 or 1.0) and (Ba_{1-y}Bi_{y})Ca_{0.3}Mn_{1.8+y}Co_{0.2}Fe_{16-y}O₂₇ (y=0 or 0.2).

FIG. 22 is a graph showing frequency characteristics of magnetic loss tan δ in composition formulas (Ba₁₋ₓSrₓ)Ca_{0.3}Mn_{1.8}Co_{0.2}Fe₁₆O₂₇ (x=0 or 1.0) and (Ba_{1-y}Bi_{y})Ca_{0.3}Mn_{1.8+y}Co_{0.2}Fe_{16-y}O₂₇ (y=0 or 0.2).

FIG. 23 is a graph showing frequency characteristics of magnetic permeability μ and magnetic loss tan δ in a composition formula BaCa_{0.3}Mn_{1.8-x}CuₓCo_{0.2}Fe₁₆O₂₇ (x=0 or 0.3).

FIG. 24 is a graph showing frequency characteristics of magnetic permeability μ and magnetic loss tan δ in a composition formula BaCa_{0.3}Mn_{1.8-y}Ni_{y}Co_{0.2}Fe₁₆O₂₇ (y=0 or 0.9).

FIG. 25 is a graph showing frequency characteristics of magnetic permeability μ in a composition formula BaCa_{0.3}Mn_{1.8-x}Co_{0.2}ZnₓFe₁₆O₂₇ (x=0, 0.5, or 0.9).

FIG. 26 is a graph showing frequency characteristics of magnetic loss tan δ in a composition formula BaCa_{0.3}Mn_{1.8-x}Co_{0.2}ZnₓFe₁₆O₂₇ (x=0, 0.5, or 0.9).

FIG. 27 is a graph showing frequency characteristics of magnetic permeability μ in a composition formula BaCa_{0.3}Mn_{1.8+x}Co_{0.2}Fe₁₆₋₂ₓMeₓO₂₇ (x=0 or 0.5, Me=Si or Ti).

FIG. 28 is a graph showing frequency characteristics of magnetic loss tan δ in a composition formula BaCa_{0.3}Mn_{1.8+x}Co_{0.2}Fe₁₆₋₂ₓMeₓO₂₇ (x=0 or 0.5, Me=Si or Ti).

FIG. 29 is a graph showing frequency characteristics of magnetic permeability μ and magnetic loss tan δ in a composition formula BaCa_{0.3}Mn_{1.8+x}Co_{0.2}Fe₁₆₋₂ₓ (Zr+Hf)ₓO₂₇ (x=0 or 1).

FIG. 30 is a graph showing a magnetization curve in a composition formula BaCa_{0.3}Mn_{1.8}Co_{0.2}ZnSnFe₁₄O₂₇.

FIG. 31 is a graph showing frequency characteristics of magnetic permeability μ in a composition formula BaCa_{0.3}Mn_{1.8}Co_{0.2}ZnₓSnₓFe₁₆₋₂ₓO₂₇ (x=0, 1.0, or 2.0).

FIG. 32 is a graph showing frequency characteristics of magnetic loss tan δ in a composition formula BaCa_{0.3}Mn_{1.8}Co_{0.2}ZnₓSnₓFe₁₆₋₂ₓO₂₇ (x=0, 1.0, or 2.0).

FIG. 33 is a graph showing frequency characteristics of magnetic permeability μ in a composition formula BaCa_{0.3}Ni_{1.8}Co_{0.2}Fe₁₆₋ₓScₓO₂₇ (x=0, 0.2, or 1.0).

FIG. 34 is a graph showing frequency characteristics of magnetic loss tan δ in a composition formula BaCa_{0.3}Ni_{1.8}Co_{0.2}Fe₁₆₋ₓScₓO₂₇ (x=0, 0.2, or 1.0).

FIG. 35 is a graph showing frequency characteristics of magnetic permeability μ in a composition formula BaCa_{0.3}Zn_{1.8}Co_{0.2}Fe₁₆₋ₓScₓO₂₇ (x=0, 0.5, or 1.0).

FIG. 36 is a graph showing frequency characteristics of magnetic loss tan δ in a composition formula BaCa_{0.3}Zn_{1.8}Co_{0.2}Fe₁₆₋ₓScₓO₂₇ (x=0, 0.5, or 1.0).

FIG. 37 is a perspective view schematically showing an example of a winding coil.

FIG. 38 is a graph showing frequency characteristics of inductance L of a coil.

FIG. 39 is a graph showing frequency characteristics of Q of a coil.

FIG. 40 is a transparent perspective view schematically showing an example of a multilayer coil.

FIG. 41 is a transparent perspective view schematically showing another example of the multilayer coil.

FIG. 42 is a perspective view schematically showing an example of an antenna.

FIG. 43 is a perspective view schematically showing another example of the antenna.

FIG. 44 is a graph showing frequency characteristics of magnetic permeability μ in a composition formula BaCa_{0.3}Me₂Fe₁₆O₂₇ (Me=Mn, Ni, or Zn).

FIG. 45 is a graph showing frequency characteristics of the sum of squares of the magnetic permeability: |μ|=√{μ″²+μ′²} in a composition formula BaCa_{0.3}Me₂Fe₁₆O₂₇ (Me=Mn, Ni, or Zn).

### DETAILED DESCRIPTION OF THE INVENTION

Hereinafter, the soft magnetic composition, the sintered body, the composite body, the paste, the coil component, and the antenna of the present invention will be described.

However, the present invention is not limited to the following configuration, and can be applied with appropriate modifications without changing the gist of the present invention. Any combination of two or more individual desirable configurations described below is also within the scope of the present invention.

[Soft Magnetic Composition]

The soft magnetic composition of the present invention contains W-type hexagonal ferrite as a main phase.

The soft magnetic composition means soft ferrite defined in JIS R 1600.

In the present specification, the main phase means a phase having the largest abundance ratio. Specifically, the case where the W-type hexagonal ferrite is the main phase is defined as a case where all of the following five conditions are satisfied when the measurement is performed in a non-oriented powder state. (1) When the total of the peak intensity ratios of peaks at lattice spacing=4.11, 2.60, 2.17 [nm] (diffraction angle 2θ=21.6, 34.5, 41.6° when a copper source X-ray is used; provided that the lattice spacing and the diffraction angle are based on hexagonal ferrite composed only of Ba, Co, Fe, and O, and when the lattice constant decreases due to the substitution element, the lattice spacing narrows, and when the lattice constant increases due to the substitution element, the lattice spacing widens; note that the difference in diffraction angle 20 between BaCo₂Fe₁₆O₂₇.BaMg₂Fe₁₆O₂₇.BaMn₂Fe₁₆O₂₇.BaNi₂Fe₁₆O₂₇.BaZn₂Fe₁₆O₂₇ is about ±0.3 degrees) around which peaks derived from non-W-type hexagonal ferrites and having an intensity of 10% or more are absent is defined as A, A exceeds 80%. (2) The peak intensity ratio of a peak at lattice spacing=2.63 [nm] (diffraction angle 2θ=34.1° when a copper source X-ray is used) around which peaks derived from non-M-type hexagonal ferrites and having an intensity of 10% or more are absent is less than 80%. (3) The peak intensity ratio of a peak at lattice spacing=2.65 [nm] (diffraction angle 2θ=33.8° when a copper source X-ray is used) around which peaks derived from non-Y-type hexagonal ferrites and having an intensity of 10% or more are absent is less than 30%. (4) The peak intensity ratio of a peak at lattice spacing=2.68 [nm] (diffraction angle 2θ=33.4° when a copper source X-ray is used) around which peaks derived from non-Z-type hexagonal ferrites and having an intensity of 10% or more are absent is less than 30%. (5) The peak intensity ratio of a peak at lattice spacing=2.53 [nm] (diffraction angle 2θ=35.4° when a copper source X-ray is used), which is the main peak of spinel ferrite, is less than 90%. In the soft magnetic composition of the present invention, the W-type hexagonal ferrite may be a single phase, that is, the molar ratio of the W-type hexagonal ferrite phase may be substantially 100%.

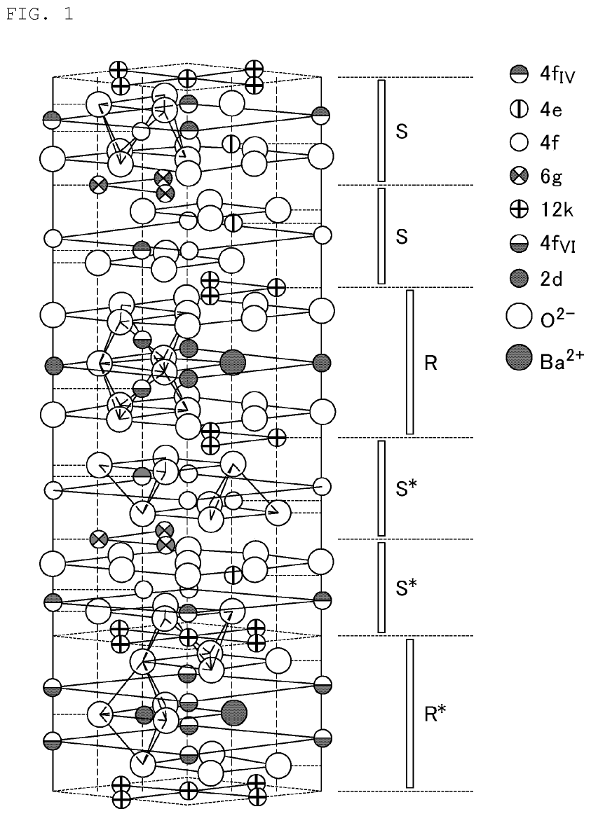

FIG. 1 is a schematic view showing a crystal structure of W-type hexagonal ferrite. FIG. 1 shows a crystal structure of Ba²⁺Fe²⁺₂Fe₁₆O₂₇.

The crystal structure of the W-type hexagonal ferrite is represented by the structural formula A²⁺Me²⁺₂Fe₁₆O₂₇, and is composed of stacking structures in the c-axis direction called an S block and an R block. In FIG. 1, * indicates a block rotated by 180° with respect to the c axis.

As the crystal structure of the hexagonal ferrite, M-type, U-type, X-type, Y-type, and Z-type in addition to the W-type are known. Among them, the W-type has a feature that the saturation magnetization Is is higher than those of the M-type, the U-type, the X-type, the Y-type, and the Z-type. This is because W-type has a crystal factor of SSR, M-type has a crystal factor of SR, U-type has a crystal factor of SRSRST, X-type has a crystal factor of SRSSR, Y-type has a crystal factor of ST, and Z-type has a crystal factor of SRST in a combination of three crystal factors of R block, S block, and T block, W-type does not include a T crystal factor having saturation magnetization=0, and the ratio of the S crystal factor having the highest saturation magnetization is 2/3 for W-type, 3/5 for X-type, and 1/2 for M-type, U-type, Y-type, and Z-type, that is, W-type ferrite is the highest. As seen from the Snoek's relational expression of hexagonal ferrite: fr×(μ−1)=(γIs)÷(6πμ₀)×{√(H_{A1}/H_{A2})+√(H_{A2}/H_{A1})}, the saturation magnetization Is can be increased and the resonance frequency fr can be increased, and thus, it is considered that high magnetic permeability can be obtained at high frequencies. In the Snoek's relational expression of the hexagonal ferrite, the resonance frequency fr is the frequency of the maximum value of the magnetic loss component μ″, μ is magnetic permeability, y is gyromagnetic ratio, Is is saturation magnetization, μ₀ is vacuum magnetic permeability, HA is anisotropic magnetic field, H_{A1} is anisotropic magnetic field in one direction, H_{A2} is anisotropic magnetic field in two directions, and the directions are set such that the difference between H_{A1} and H_{A2} is the highest. Hexagonal ferrite is characterized in that the difference between H_{A1} and H_{A2} is as large as 10 times or more.

In the soft magnetic composition of the present invention, it is desirable that the W-type hexagonal ferrite is a single phase from the viewpoint of increasing the resonance frequency by increasing the saturation magnetization. However, small amounts of different phases such as M-type hexagonal ferrite, Y-type hexagonal ferrite, Z-type hexagonal ferrite, and spinel ferrite may be contained.

The soft magnetic composition of the present invention is an oxide having the following metal element ratio.

In the present specification, the description of “Ba+Sr” or the like means the sum of the respective elements. In addition, the following composition is a composition of a magnetic body, and in a case where inorganic glass or the like is added, the composition is treated as a composite matter described later.

The content of each element contained in the soft magnetic composition can be determined by composition analysis using Inductively Coupled Plasma Atomic Emission Spectroscopy (ICP-AES).

### Configuration 1-1: Essential Elements (Ba+Sr+Na+K+La+Bi: 4.7 Mol % to 5.8 Mol %)

In the W-type hexagonal ferrite (structural formula A²⁺Me₂²⁺Fe₁₆O₂₇), in order to constitute A site elements corresponding to the Ba positions of the crystal structure shown in FIG. 1, the total amount of barium Ba, strontium Sr, sodium Na, potassium K, lanthanum La, and bismuth Bi, which are cations having a relatively large ionic radius, needs to be 4.7 mol % to 5.8 mol %.

When the amount of the A site elements is small (A=Ba+Sr+Na+K+La+Bi<4.7 mol %), or when the amount of the A site elements is large (A>5.8 mol %), the magnetic loss at 6 GHz becomes as large as tan δ>0.06, and thus magnetic properties difficult to use in an inductor or the like are exhibited.

The upper limit of the A site elements will be described in the upper limit setting of the Ba amount and the Sr amount described later. Details of setting the lower limit amount of the A site elements to 4.7 mol % are as follows.

When the A site element is only Ba and Ba amount=4.7 mol %, the magnetic permeability μ′ is 1.1 or more, and the magnetic loss tan δ is 0.06 or less, as seen from all No. 18 in Table 1, No. 36 in Table 2, No. 54 in Table 3, and No. 72 in Table 4.

When the A site element is only Ba and Ba amount <4.7 mol %, the magnetic loss tan δ is 0.06 or more as seen from all No. 19 in Table 1, No. 37 in Table 2, No. 55 in Table 3, and No. 73 in Table 4. Thus, the lower limit of the amount of the A site elements such as Ba is set to 4.7 mol %.

The content of each element is Ba: 0 mol % to 5.8 mol %, Sr: 0 mol % to 5.8 mol %, Na: 0 mol % to 5.2 mol %, K: 0 mol % to 5.2 mol %, La: 0 mol % to 2.1 mol %, and Bi: 0 mol % to 1.0 mol %.

Details of setting Ba: 0 mol % to 5.8 mol % are as follows.

When Ba amount=5.8 mol %, in the composition system of the structural formula BaMg₂Fe₁₆O₂₇ (hereinafter referred to as Mg₂-W-type ferrite), the magnetic permeability μ′ is 1.1 or more, and the magnetic loss tan δ is 0.06 or less, as seen from No. 16 in Table 1.

When Ba amount >5.8 mol %, in the Mg₂-W-type ferrite, the magnetic loss tan δ is 0.06 or more as seen from No. 15 in Table 1. Thus, in the Mg₂-W-type ferrite, the range of Ba is set to 0 mol % to 5.8 mol %.

When Ba amount=5.8 mol %, in the composition system of the structural formula BaMn₂Fe₁₆O₂₇ (hereinafter referred to as Mn₂-W-type ferrite), the magnetic permeability μ′ is 1.1 or more, and the magnetic loss tan δ is 0.06 or less, as seen from No. 34 in Table 2.

When Ba amount >5.8 mol %, in the Mn₂-W-type ferrite, the magnetic loss tan δ is 0.06 or less as seen from No. 33 in Table 2. Thus, also in the Mn₂-W-type ferrite, the range of Ba is set to 0 mol % to 5.8 mol %.

When Ba amount=5.8 mol %, in the composition system of the structural formula BaNi₂Fe₁₆O₂₇ (hereinafter referred to as Ni₂-W-type ferrite), the magnetic permeability μ′ is 1.1 or more, and the magnetic loss tan δ is 0.06 or less, as seen from No. 52 in Table 3.

When Ba amount >5.8 mol %, in the Ni₂-W-type ferrite, the magnetic permeability μ′ is less than 1.1, and the magnetic loss tan δ is 0.06 or more, as seen from No. 51 in Table 3. Thus, also in the Ni₂-W-type ferrite, the range of Ba is set to 0 mol % to 5.8 mol %.

When Ba amount=5.8 mol %, in the composition system of the structural formula BaZn₂Fe₁₆O₂₇ (hereinafter referred to as Zn₂-W-type ferrite), the magnetic permeability μ′ is 1.1 or more, and the magnetic loss tan δ is 0.06 or more, as seen from No. 70 in Table 4.

When Ba amount >5.8 mol %, in the Zn₂-W-type ferrite, the magnetic permeability μ′ is less than 1.1, and the magnetic loss tan δ is 0.06 or more, as seen from No. 69 in Table 4. Thus, also in the Zn₂-W-type ferrite, the range of Ba is set to 0 mol % to 5.8 mol %.

Details of setting Sr: 0 mol % to 5.8 mol % are as follows.

When Sr amount=5.8 mol %, in the Mg₂-W-type ferrite, the magnetic permeability μ′ is 1.1 or more, and the magnetic loss tan δ is 0.06 or less, as seen from No. 307 in Table 17.

When Sr amount >5.8 mol %, in the Mg₂-W-type ferrite, the magnetic loss tan δ is 0.06 or more as seen from No. 306 in Table 17. Thus, in the Mg₂-W-type ferrite, the range of Sr is set to 0 mol % to 5.8 mol %.

When Sr amount=5.8 mol %, in the Mn₂-W-type ferrite, the magnetic permeability μ′ is 1.1 or more, and the magnetic loss tan δ is 0.06 or less, as seen from No. 312 in Table 17.

When Sr amount >5.8 mol %, in the Mn₂-W-type ferrite, the magnetic loss tan δ is 0.06 or more as seen from No. 311 in Table 17. Thus, also in the Mn₂-W-type ferrite, the range of Sr is set to 0 mol % to 5.8 mol %.

When Sr amount=5.8 mol %, in the Ni₂-W-type ferrite, the magnetic permeability μ′ is 1.1 or more, and the magnetic loss tan δ is 0.06 or less, as seen from No. 317 in Table 17.

When Sr amount >5.8 mol %, in the Ni₂-W-type ferrite, the magnetic loss tan δ is 0.06 or more as seen from No. 316 in Table 17. Thus, also in the Ni₂-W-type ferrite, the range of Sr is set to 0 mol % to 5.8 mol %.

When Sr amount=5.8 mol %, in the Zn₂-W-type ferrite, the magnetic permeability μ′ is 1.1 or more, and the magnetic loss tan δ is 0.06 or less, as seen from No. 322 in Table 17.

When Sr amount >5.8 mol %, in Zn₂-W-type ferrite, the magnetic loss tan δ is 0.06 or more as seen from No. 321 in Table 17. Thus, also in the Zn₂-W-type ferrite, the range of Sr is set to 0 mol % to 5.8 mol %.

When Na amount=5.2 mol %, the magnetic permeability μ′ is 1.1 or more, and the magnetic loss tan δ is 0.06 or less, as seen from No. 346 in Table 21. Thus, the range of Na is set to 0 mol % to 5.2 mol %.

When K amount=5.2 mol %, the magnetic permeability μ′ is 1.1 or more, and the magnetic loss tan δ is 0.06 or less, as seen from No. 348 in Table 21. Thus, the range of K is set to 0 mol % to 5.2 mol %.

When La amount=2.1 mol %, the magnetic permeability μ′ is 1.1 or more, and the magnetic loss tan δ is 0.06 or less, as seen from No. 342 in Table 20. When La amount >2.1 mol %, the magnetic loss tan δ is 0.06 or more as seen from No. 343 in Table 20. Thus, the range of La is set to 0 mol % to 2.1 mol %.

When Bi amount=1.0 mol %, the magnetic permeability μ′ is 1.1 or more, and the magnetic loss tan δ is 0.06 or less, as seen from all Nos. 77, 82, 87, and 92 in Table 5. When Bi amount >1.0 mol %, the magnetic loss tan δ is 0.06 or more as seen from all Nos. 78, 83, 88, and 93 in Table 5. Thus, the range of Bi is set to 0 mol % to 1.0 mol %.

The amount of Sr may be 0 mol %. When Sr is not contained, the dielectric constant decreases. Details are as follows.

In the Mg₂-W-type ferrite, when Sr is contained, the dielectric constant is 30 or more as seen from No. 75 and 76 in Table 5, and when Sr is not contained the dielectric constant is 10 as seen from No. 74 in Table 5, and thus the dielectric constant can be made lower when Sr is not contained.

In the Mn₂-W-type ferrite, when Sr is contained, the dielectric constant is 30 or more as seen from No. 80 and 81 in Table 5, and when Sr is not contained, the dielectric constant is 10 as seen from No. 79 in Table 5, and thus the dielectric constant can be made lower when Sr is not contained.

In the Ni₂-W-type ferrite, when Sr is contained, the dielectric constant is 30 or more as seen from No. 85 and 86 in Table 5, and when Sr is not contained, the dielectric constant is 10 as seen from No. 84 in Table 5, and thus the dielectric constant can be made lower when Sr is not contained.

In the Zn₂-W-type ferrite, when Sr is contained, the dielectric constant is 30 or more as seen from No. 90 and 91 in Table 5, and when Sr is not contained, the dielectric constant is 10 as seen from No. 89 in Table 5, and thus the dielectric constant can be made lower when Sr is not contained.

### Configuration 1-2: Essential Element (Ca: 0.2 Mol % to 5.0 Mol %)

In order to synthesize the W-type hexagonal ferrite (structural formula A²⁺Me₂²⁺Fe₁₆O₂₇) as a single phase, it is effective to add calcium Ca. Patent Document 3 also shows a similar effect, but unlike the reducing atmosphere in Patent Document 3 in which the generation of Fe²⁺ is essential, the effect is obtained by firing in the atmosphere in which Fe²⁺ is not generated. Patent Document 5 also shows a similar effect, but unlike the wet method in Patent Document 5 in which coprecipitate production of an aqueous solution is essential, the effect is obtained by a solid phase reaction of an oxide or the like. The amount of Ca added is defined outside the structural formula of the W-type hexagonal ferrite because Ca is considered not only to enter the A site and the Fe site but also to be deposited at the grain boundary.

By adding Ca in an amount of 0.2 mol % to 5.0 mol %, the synthesis of the W-type hexagonal ferrite is promoted, and the coercivity can be reduced to 100 kA/m or less as seen from Tables 1 to 4.

When the amount of Ca is small (Ca<0.2 mol %), or when the amount of Ca is large (Ca>5.0 mol %), the magnetic permeability at 6 GHz drops to μ′<1.10, and the magnetic loss at 6 GHz is as large as tan δ>0.06, and thus magnetic properties difficult to use in an inductor or the like are exhibited. Details are as follows.

In the Mg₂-W-type ferrite, when Ca=0.2 mol %, the magnetic permeability μ′ at 6 GHz is 1.1 or more, and the magnetic loss tan δ is 0.06 or less, as seen from No. 3 in Table 1. On the other hand, when Ca is small (Ca<0.2 mol %), the magnetic permeability μ′ at 6 GHz is 1.10 or less, or the magnetic loss tan δ is 0.06 or more, as seen from Nos. 1 and 2 in Table 1.

In the Mg₂-W-type ferrite, when Ca=5.0 mol %, the magnetic permeability μ′ at 6 GHz is 1.1 or more, and the magnetic loss tan δ is 0.06 or less, as seen from No. 7 in Table 1. On the other hand, when Ca is large (Ca>5.0 mol %), the magnetic loss tan δ at 6 GHz is 0.06 or more as seen from No. 8 in Table 1.

In the Mn₂-W-type ferrite, when Ca=0.2 mol %, the magnetic permeability μ′ at 6 GHz is 1.1 or more, and the magnetic loss tan δ is 0.06 or less, as seen from No. 22 in Table 2. On the other hand, when Ca is small (Ca<0.2 mol %), the magnetic permeability μ′ at 6 GHz is 1.10 or less, or the magnetic loss tan δ is 0.06 or more, as seen from Nos. 20 and 21 in Table 2.

In the Mn₂-W-type ferrite, when Ca=5.0 mol %, the magnetic permeability μ′ at 6 GHz is 1.1 or more, and the magnetic loss tan δ is 0.06 or less, as seen from No. 26 in Table 2. On the other hand, when Ca is large (Ca>5.0 mol %), the magnetic loss tan δ at 6 GHz is 0.06 or more as seen from No. 27 in Table 2.

In the Ni₂-W-type ferrite, when Ca=0.2 mol %, the magnetic permeability μ′ at 6 GHz is 1.1 or more, and the magnetic loss tan δ is 0.06 or less, as seen from No. 40 in Table 3. On the other hand, when Ca is small (Ca<0.2 mol %), the magnetic loss tan δ at 6 GHz is 0.06 or more as seen from Nos. 38 and 39 in Table 3.

In the Ni₂-W-type ferrite, when Ca=5.0 mol %, the magnetic permeability μ′ at 6 GHz is 1.1 or more, and the magnetic loss tan δ is 0.06 or less, as seen from No. 44 in Table 3. On the other hand, when Ca is large (Ca>5.0 mol %), the magnetic permeability μ′ at 6 GHz is 1.10 or less, and the magnetic loss tan δ is 0.06 or more, as seen from No. 45 in Table 3.

In the Zn₂-W-type ferrite, when Ca=0.2 mol %, the magnetic permeability μ′ at 6 GHz is 1.1 or more, and the magnetic loss tan δ is 0.06 or less, as seen from No. 58 in Table 4. On the other hand, when Ca is small (Ca<0.2 mol %), the magnetic loss tan δ at 6 GHz is 0.06 or more as seen from Nos. 56 and 57 in Table 4.

In the Zn₂-W-type ferrite, when Ca=5.0 mol %, the magnetic permeability μ′ at 6 GHz is 1.1 or more, and the magnetic loss tan δ is 0.06 or less, as seen from No. 62 in Table 4. On the other hand, when Ca is large (Ca>5.0 mol %), the magnetic permeability μ′ at 6 GHz is 1.10 or less, and the magnetic loss tan δ is 0.06 or more, as seen from No. 63 in Table 4.

### Configuration 1-3: Essential Element (Fe: 67.4 Mol % to 84.5 Mol %)

In order to constitute the W-type hexagonal ferrite (structural formula A²⁺Me₂²⁺Fe₁₆O₂₇) and exhibit ferromagnetism, iron Fe is required. Among the hexagonal ferrite phases (M-type, U-type, W-type, X-type, Y-type, or Z-type), the W-type ferrite is a crystal phase in which a large amount of Fe is required. It is generally known that when the amount of Fe is insufficient, other hexagonal ferrite phases (for example, M-type=AFe₁₂O₁₉, Y-type=A₂Me₂Fe₁₂O₂₂, and the like) are likely to be formed, and when the amount of Fe is excessive, a spinel ferrite phase (MeFe₂O₄) is likely to be formed.

When the amount of Fe is small (Fe<67.4 mol %), or when the amount of Fe is large (Fe>84.5 mol %), the magnetic loss at 6 GHz becomes as large as tan δ>0.06, and thus magnetic properties difficult to use in an inductor or the like are exhibited. Details are as follows.

In the Mg₂-W-type ferrite, when Fe=67.4 mol %, the magnetic permeability μ′ at 6 GHz is 1.1 or more, and the magnetic loss tan δ is 0.06 or less, as seen from Nos. 129, 135, 144, and 151 in Table 9. On the other hand, when the amount of Fe is small (Fe<67.4 mol %), the magnetic loss tan δ at 6 GHz is 0.06 or more as seen from Nos. 130, 136, 145, and 152 in Table 9.

In the Mg₂-W-type ferrite, when Fe=84.5 mol %, the magnetic permeability μ′ at 6 GHz is 1.1 or more, and the magnetic loss tan δ is 0.06 or less, as seen from No. 18 in Table 1. On the other hand, when the amount of Fe is large (Fe>84.5 mol %), the magnetic loss tan δ at 6 GHz is 0.06 or more as seen from No. 19 in Table 1.

In the Mn₂-W-type ferrite, when Fe=67.4 mol %, the magnetic permeability μ′ at 6 GHz is 1.1 or more, and the magnetic loss tan δ is 0.06 or less, as seen from Nos. 160, 166, 175, and 182 in Table 10. On the other hand, when the amount of Fe is small (Fe<67.4 mol %), the magnetic loss tan δ at 6 GHz is 0.06 or more as seen from Nos. 161, 167, 176, and 183 in Table 10.

In the Mn₂-W-type ferrite, when Fe=84.5 mol %, the magnetic permeability μ′ at 6 GHz is 1.1 or more, and the magnetic loss tan δ is 0.06 or less, as seen from No. 36 in Table 2. On the other hand, when the amount of Fe is large (Fe>84.5 mol %), the magnetic loss tan δ at 6 GHz is 0.06 or more as seen from No. 37 in Table 2.

In the Ni₂-W-type ferrite, when Fe=67.4 mol %, the magnetic permeability μ′ at 6 GHz is 1.1 or more, and the magnetic loss tan δ is 0.06 or less, as seen from Nos. 191, 197, 206, and 213 in Table 11. On the other hand, when the amount of Fe is small (Fe<67.4 mol %), the magnetic loss tan δ is 0.06 or more as seen from Nos. 192, 198, 207, and 214 in Table 11.

In the Ni₂-W-type ferrite, when Fe=84.5 mol %, the magnetic permeability μ′ at 6 GHz is 1.1 or more, and the magnetic loss tan δ is 0.06 or less, as seen from No. 54 in Table 3. On the other hand, when the amount of Fe is large (Fe>84.5 mol %), the magnetic permeability μ′ at 6 GHz is 1.1 or less, and the magnetic loss tan δ is 0.06 or more, as seen from No. 55 in Table 3.

In the Zn₂-W-type ferrite, when Fe=67.4 mol %, the magnetic permeability μ′ at 6 GHz is 1.1 or more, and the magnetic loss tan δ is 0.06 or less, as seen from Nos. 222, 228, 237, and 244 in Table 12. On the other hand, when the amount of Fe is small (Fe<67.4 mol %), the magnetic loss tan δ is 0.06 or more as seen from Nos. 223, 229, 238, and 245 in Table 12.

In the Zn₂-W-type ferrite, when Fe=84.5 mol %, the magnetic permeability μ′ at 6 GHz is 1.1 or more, and the magnetic loss tan δ is 0.06 or less, as seen from No. 72 in Table 4. On the other hand, when the amount of Fe is large (Fe>84.5 mol %), the magnetic loss tan δ at 6 GHz is 0.06 or more as seen from No. 73 in Table 4.

### Configuration 1-4: Selective Essential Element

In order to constitute the W-type hexagonal ferrite (structural formula A²⁺Me₂²⁺Fe₁₆O₂₇), the Me (II) element is required.

Me (II) is 9.4 mol % to 18.1 mol % when definition is as follows: Me (II)=Co+Cu+Mg+Mn+Ni+Zn.

When the amount of the Me (II) element is small (Me (II)<9.4 mol %), or when the amount of the Me (II) element is large (Me (II)>18.1 mol %), the magnetic loss at 6 GHz becomes as large as tan δ>0.06, and thus magnetic properties difficult to use in an inductor or the like are exhibited. Details are as follows.

In the case of Mg₂-W-type ferrite, when Me (II) element=9.4 mol %, the magnetic loss tan δ at 6 GHz is 0.06 or less as seen from No. 18 in Table 1. On the other hand, when the amount of the Me (II) element is small (Me (II)<9.4 mol %), the magnetic loss tan δ at 6 GHz is 0.06 or more as seen from No. 19 in Table 1.

In the case of Mg₂-W-type ferrite, when the Me (II) element=18.1 mol %, the magnetic loss tan δ at 6 GHz is 0.06 or less as seen from Nos. 129, 135, 144, and 151 in Table 9. On the other hand, when the amount of the Me (II) element is large (Me (II)>18.1 mol %), the magnetic loss tan δ at 6 GHz is 0.06 or more as seen from Nos. 130, 136, 145, and 152 in Table 9.

In the case of Mn₂-W-type ferrite, when the Me (II) element=9.4 mol %, the magnetic loss tan δ at 6 GHz is 0.06 or less as seen from No. 36 in Table 2. On the other hand, when the amount of the Me (II) element is small (Me (II)<9.4 mol %), the magnetic loss tan δ at 6 GHz is 0.06 or more as seen from No. 37 in Table 2.

In the case of Mn₂-W-type ferrite, when the Me (II) element=18.1 mol %, the magnetic loss tan δ at 6 GHz is 0.06 or less as seen from Nos. 160, 166, 175, and 182 in Table 10. On the other hand, when the amount of the Me (II) element is large (Me (II)>18.1 mol %), the magnetic loss tan δ at 6 GHz is 0.06 as seen from Nos. 161, 167, 176, and 183 in Table 10.

In the case of Ni₂-W-type ferrite, when Me (II) element=9.4 mol %, the magnetic loss tan δ at 6 GHz is 0.06 or less as seen from No. 54 in Table 3. On the other hand, when the amount of the Me (II) element is small (Me (II)<9.4 mol %), the magnetic loss tan δ at 6 GHz is 0.06 or more as seen from No. 55 in Table 3.

In the case of Ni₂-W-type ferrite, when Me (II) element=18.1 mol %, the magnetic loss tan δ at 6 GHz is 0.06 or less as seen from Nos. 191, 197, 206, and 213 in Table 11. On the other hand, when the amount of the Me (II) element is large (Me (II)>18.1 mol %), the magnetic loss tan δ at 6 GHz is 0.06 or more as seen from Nos. 192, 198, 207, and 214 in Table 11.

In the case of Zn₂-W-type ferrite, when the Me (II) element=9.4 mol %, the magnetic loss tan δ at 6 GHz is 0.06 or less as seen from No. 72 in Table 4. On the other hand, when the amount of the Me (II) element is small (Me (II)<9.4 mol %), the magnetic loss tan δ at 6 GHz is 0.06 or more as seen from No. 73 in Table 4.

In the case of Zn₂-W-type ferrite, when Me (II) element=18.1 mol %, the magnetic loss tan δ at 6 GHz is 0.06 or less as seen from Nos. 222, 228, 237, and 244 in Table 12. On the other hand, when the amount of the Me (II) element is large (Me (II)>18.1 mol %), the magnetic loss tan δ at 6 GHz is 0.06 or more as seen from Nos. 223, 229, 238, and 245 in Table 12.

Further, Meₕ (II) is 7.8 mol % to 17.1 mol % when definition is as follows: Men (II)=Mg+Mn+Ni+Zn.

When at least one of Mg, Mn, Ni, and Zn is contained as the element of the Me site, the magnetic loss tan δ can be suppressed in a state where a high magnetic permeability μ′ is obtained in a high frequency range of, for example, 6 GHz. Thus, magnetic properties suitable for inductors and antennas can be obtained.

When the amount of Meₕ (II) element is small (Meₕ (II)<7.8 mol %), or when the amount of Meₕ (II) element is large (Meₕ (II)>17.1 mol %), the magnetic loss at 6 GHz becomes as large as tan δ>0.06, and thus magnetic properties difficult to use in an inductor or the like are exhibited. Details are as follows.

In the case of Ni₂-W-type ferrite, when Meₕ (II)=7.8 mol %, the magnetic loss tan δ at 6 GHz is 0.06 or more as seen from No. 49 in Table 3.

On the other hand, when the amount of the Meₕ (II) element is small (Meₕ (II)<7.8 mol %), the magnetic loss tan δ at 6 GHz becomes as large as 0.06 as seen from No. 50 in Table 3. The lower limit value of Meₕ (II) of the Mg₂-W-type.Mn₂-W-type.Zn₂-W-type is 8.3 mol % as seen from No. 12 in Table 1, No. 31 in Table 2, and 67 in Table 4.

In the case of Mg₂-W-type ferrite, when Meₕ (II)=17.1 mol %, the magnetic loss tan δ at 6 GHz is 0.06 or less as seen from Nos. 129, 135, 144, and 151 in Table 9. On the other hand, when the amount of the Meₕ (II) element is large (Meₕ (II)>17.1 mol %), the magnetic loss tan δ at 6 GHz is 0.06 or less as seen from Nos. 130, 136, 145, and 152 in Table 9.

In the case of Mn₂-W-type ferrite, when Meₕ (II)=17.1 mol %, the magnetic loss tan δ at 6 GHz is 0.06 or less as seen from Nos. 160, 166, 175, and 182 in Table 10. On the other hand, when the amount of the Meₕ (II) element is large (Meₕ (II)>17.1 mol %), the magnetic loss tan δ at 6 GHz is 0.06 or more as seen from Nos. 161, 167, 176, and 183 in Table 10.

In the case of Ni₂-W-type ferrite, when Meₕ (II)=17.1 mol %, the magnetic loss tan δ at 6 GHz is 0.06 or less as seen from Nos. 191, 197, 206, and 213 in Table 11. On the other hand, when the amount of the Meₕ (II) element is large (Meₕ (II)>17.1 mol %), the magnetic loss tan δ at 6 GHz is 0.06 or more as seen from Nos. 192, 198, 207, and 214 in Table 11.

In the case of Zn₂-W-type ferrite, when Meₕ (II)=17.1 mol %, the magnetic loss tan δ at 6 GHz is 0.06 or less as seen from Nos. 222, 228, 237, and 244 in Table 12. On the other hand, when the amount of the Meₕ (II) element is large (Meₕ (II)>17.1 mol %), the magnetic loss tan δ at 6 GHz is 0.06 or more as seen from Nos. 223, 229, 238, and 245 in Table 12.

The content of each element is Cu: 0 mol % to 1.6 mol %, Mg: 0 mol % to 17.1 mol %, Mn: 0 mol % to 17.1 mol %, Ni: 0 mol % to 17.1 mol %, Zn: 0 mol % to 17.1 mol %, and Co: 0 mol % to 2.6 mol %.

When the amount of Cu is large (Cu>1.6 mol %), the magnetic permeability μ′ at 6 GHz is 1.10 or less, and the magnetic loss tan δ at 6 GHz is 0.06 or more, and thus magnetic properties difficult to use in an inductor or the like are exhibited. Details are as follows.

When Cu=1.6 mol %, the magnetic permeability μ′ at 6 GHz is as high as 1.10 or more, and the magnetic loss tan δ at 6 GHz is as low as 0.06 or less, as seen from No. 95 in Table 6 for Mg₂-W-type ferrite, No. 99 in Table 6 for Mn₂-W-type ferrite, No. 102 in Table 6 for Ni₂-W-type ferrite, and No. 105 in Table 6 for Zn₂-W-type ferrite.

When the amount of Cu is large (Cu>1.6 mol %), the magnetic permeability μ′ at 6 GHz is as low as 1.10 or less, and the magnetic loss tan δ at 6 GHz becomes as large as 0.06 or more, as seen from Nos. 96 and 97 in Table 6 for Mg₂-W-type ferrite, No. 100 in Table 6 for Mn₂-W-type ferrite, No. 103 in Table 6 for Ni₂-W-type ferrite, and No. 106 in Table 6 for Zn₂-W-type ferrite, and thus magnetic properties difficult to use in an inductor or the like are exhibited. Thus, the upper limit of the amount of Cu is set to 1.6 mol %.

When Mg=17.1 mol %, the magnetic loss tan δ at 6 GHz is 0.06 or more as seen from Nos. 129 and 135 in Table 9. On the other hand, when Mg>17.1 mol %, the magnetic loss tan δ at 6 GHz is 0.06 or more as seen from Nos. 130 and 136 in Table 9. Thus, the upper limit of the amount of Mg is set to 17.1 mol %.

When Mn=17.1 mol %, the magnetic loss tan δ at 6 GHz is 0.06 or less as seen from Nos. 160 and 166 in Table 10. On the other hand, when Mn>17.1 mol %, the magnetic loss tan δ at 6 GHz is 0.06 or more as seen from Nos. 161 and 167 in Table 10. Thus, the upper limit of the amount of Mn is set to 17.1 mol %.

When Ni=17.1 mol %, the magnetic loss tan δ at 6 GHz is 0.06 or less as seen from Nos. 191 and 197 in Table 11. On the other hand, when Ni>17.1 mol %, the magnetic loss tan δ at 6 GHz is 0.06 or more as seen from Nos. 192 and 198 in Table 11. Thus, the upper limit of the amount of Ni is set to 17.1 mol %.

When Zn=17.1 mol %, the magnetic loss tan δ at 6 GHz is 0.06 or less as seen from Nos. 222 and 228 in Table 12. On the other hand, when Zn>17.1 mol %, the magnetic loss tan δ at 6 GHz is 0.06 or more as seen from Nos. 223 and 229 in Table 12. Thus, the upper limit of the amount of Zn is set to 17.1 mol %.

When Co=2.6 mol %, the magnetic permeability μ′ at 6 GHz is as high as 1.10 or more, and the magnetic loss tan δ at 6 GHz is as low as 0.06 or less, as seen from No. 49 in Table 3. On the other hand, when Co>2.6 mol %, the magnetic loss tan δ at 6 GHz is 0.06 or more as seen from No. 50 in Table 3.

When Co=0 mol %, the magnetic permeability μ′ at 6 GHz is as high as 1.10 or more, and the magnetic loss tan δ at 6 GHz is as low as 0.06 or less, as seen from No. 9 in Table 1, No. 28 in Table 2, No. 46 in Table 3, and No. 64 in Table 4. Thus, the range of Co is set to 0 mol % to 2.6 mol %.

### Configuration 1-5: Co: 0.5 Mol % to 2.1 Mol %

As described above, the amount of Co may be 0 mol % to 2.6 mol %, but is desirably 0.5 mol % or more. Details are as follows.

In the case of Mg₂-W ferrite, when the Co amount is 0 mol %, the magnetic permeability at 6 GHz is 1.63 as seen from No. 9 in Table 1. On the other hand, at Co>0.5 mol %, when substitution with the later-described M_{2d} element is not performed, the maximum value of the magnetic permeability at 6 GHz can be increased to 2.00 as seen from No. 12 in Table 1.

In the case of Mn₂-W-type ferrite, when the Co amount is 0 mol %, the magnetic permeability at 6 GHz is 1.20 as seen from No. 28 in Table 2. On the other hand, at Co≥0.5 mol %, when substitution with the later-described M_{2d} element is not performed, the maximum value of the magnetic permeability at 6 GHz can be increased to 1.62 as seen from No. 30 in Table 2.

In the case of Ni₂-W-type ferrite, when the Co amount is 0 mol %, the magnetic permeability at 6 GHz is 1.26 as seen from No. 46 in Table 3. On the other hand, at Co≥0.5 mol %, when substitution with the later-described M_{2d} element is not performed, the maximum value of the magnetic permeability at 6 GHz can be increased to 1.71 as seen from No. 49 in Table 3.

In the case of Zn₂-W-type ferrite, when the Co amount is 0 mol %, the magnetic permeability at 6 GHz is 1.27 as seen from No. 64 in Table 4. On the other hand, at Co≥0.5 mol %, when substitution with the later-described M_{2d} element is not performed, the maximum value of the magnetic permeability at 6 GHz can be increased to 2.12 as seen from No. 67 in Table 4.

It is known that W-type hexagonal ferrite not containing Co (structural formula A²⁺Me₂²⁺Fe₁₆O₂₇) exhibits hard magnetism suitable as a magnet material as shown in Patent Documents 1, 2, and 3 since it usually has c-axis anisotropy (the spin tends to be directed in the direction of the c-axis) due to the influence of the Fe ions on the five-coordinate sites (2d sites in FIG. 1). In order for W-type hexagonal ferrite to exhibit soft magnetism and to have an increased magnetic permeability, it is necessary to make it easier for the spin to be directed in the c-plane direction of the hexagonal ferrite, and thus it is desirable to perform substitution with cobalt Co on the six-coordinate sites (4f, 4f_{VI}, 6g, or 12k sites in FIG. 1). It is also known that when substitution with cobalt Co is performed on the four-coordinate sites (4e or 4f_{IV} sites in FIG. 1), the coercivity increases, the hard magnetism is strengthened, and the magnetic permeability decreases. Thus, the oxygen atmosphere is desirably less than 90%.

When Co<0.5 mol % and Co is not added, the magnetic permeability μ′ at 6 GHz is 1.63 for Mg₂-W-type ferrite as seen from No. 9 in Table 1, 1.20 for Mn₂-W-type ferrite as seen from No. 28 in Table 2, 1.26 for Ni₂-W-type ferrite as seen from No. 46 in Table 3, and 1.27 for Zn₂-W-type ferrite as seen from No. 64 in Table 4, and the upper limit is 1.63.

The amount of Co is desirably 2.1 mol % or less.

When Co>2.1 mol %, the magnetic loss tan δ at 6 GHz is 0.06 or more for Mg₂-W-type ferrite as seen from No. 13 in Table 1, for Mn₂-W-type ferrite as seen from No. 32 in Table 2, and for Zn₂-W-type ferrite as seen from No. 68 in Table 4, and thus magnetic properties difficult to use in an inductor or the like are exhibited.

Only for the Ni₂-W-type ferrite, when Co=2.6 mol %, the magnetic loss tan δ is 0.06 or less as seen from No. 49 in Table 3. However, when Co>2.6 mol %, the magnetic loss tan δ at 6 GHz is 0.06 or more as seen from No. 50 in Table 3, and thus magnetic properties difficult to use in an inductor or the like are exhibited.

### Configuration 1-6: Balance Between Multiple Elements (D: 7.8 Mol % to 11.6 Mol % when Definitions are as Follows: Me (I)=Na+K+Li, Me (II)=Co+Cu+Mg+Mn+Ni+Zn, Me (IV)=Ge+Si+Sn+Ti+Zr+Hf, Me (V)=Mo+Nb+Ta+Sb+W+V, and D=Me (I)+Me (II)−Me (IV)−2×Me (V))

Me (I) is defined as an element that tends to be a monovalent cation, Me (II) is defined as an element that tends to be a divalent cation, Me (IV) is defined as an element that tends to be a tetravalent cation, and Me (V) is defined as an element that tends to be a pentavalent or more cation. However, since it is difficult to measure the amount of the electric charge of polycrystalline which is an insulator, that the charge balance is achieved is assumed from the fact that the specific resistance is high.

When the charge balance amount D is large (D>11.6 mol %), or when the charge balance amount D is small (D<7.8 mol %), the magnetic loss at 6 GHz becomes as large as tan δ>0.06, and thus magnetic properties difficult to use in an inductor or the like are exhibited. Details are as follows.

When the charge balance amount D=11.6 mol %, the magnetic permeability μ′ at 6 GHz is 1.1 or more, and the magnetic loss tan δ is 0.06 or less, as seen from No. 16 in Table 1, No. 34 in Table 2, No. 52 in Table 3, No. 70 in Table 4, No. 307, No. 312, No. 317, and No. 322 in Table 17. On the other hand, when the charge balance amount D is large (D>11.6 mol %), the magnetic loss tan δ is 0.06 or more as seen from No. 15 in Table 1, No. 33 in Table 2, No. 51 in Table 3, No. 69 in Table 4, and No. 306, No. 311, No. 316, and No. 321 in Table 17.

When the charge balance amount D=7.8 mol %, the magnetic permeability μ′ at 6 GHz is 1.1 or more, and the magnetic loss tan δ is 0.06 or less, as seen from No. 338 in Table 19. On the other hand, when the charge balance amount D is small (D<7.8 mol %), the magnetic loss tan δ is 0.06 or more as seen from No. 339 in Table 19.

### Configuration 1-7: M_{2d}=In+Sc+Sn+Zr+Hf: 0 Mol % to 7.8 Mol %

In, Sc, Sn, Zr, and Hf are nonmagnetic elements having the function of replacing Fe on the five-coordinate sites in the hexagonal ferrite. Fe on the five-coordinate site has an effect of hard magnetism in which the spin is easily directed in the direction of the c-axis of the hexagonal ferrite. When substitution with at least one of In, Sc, Sn, Zr, and Hf, which are nonmagnetic elements, is performed on the five-coordinate sites of the hexagonal ferrite, the saturation magnetization decreases, but as a result of weakening the effect of hard magnetism exhibited by Fe on the five-coordinate sites, the coercivity rapidly decreases. As a result, the magnetic permeability μ′ at 6 GHz can be increased to a maximum of 3.15 at M_{2d}>1.0 mol % with respect to a maximum of 2.12 at M_{2d}=0 mol. Thus, the M_{2d} amount is desirably 1.0 mol % or more. Each element of M_{2d} (Sn.Zr+Hf.In.Sc) for each of the W-type ferrite material systems (Mg₂-W-type ferrite.Mn₂-W-type ferrite.Ni₂-W-type ferrite.Zn₂-W-type ferrite) will be described below separately.

In the case of Mg₂-W-type ferrite, when substitution with the M_{2d} element is not performed, the maximum value of the magnetic permeability μ′ at 6 GHz is μ′=2.00 as seen from No. 12 in Table 1.

In Mg₂-W-type ferrite, when substitution with an In element is performed, the maximum value of the magnetic permeability μ′ at 6 GHz is as high as μ′=2.51 as seen from No. 253 in Table 13.

In Mg₂-W-type ferrite, when substitution with a Sc element is performed, the maximum value of the magnetic permeability μ′ at 6 GHz is as high as μ′=2.49 as seen from No. 258 in Table 13.

In Mg₂-W-type ferrite, when substitution with a Sn element is performed, the maximum value of the magnetic permeability μ′ at 6 GHz is as high as μ′=3.15 as seen from No. 143 in Table 9.

In Mg₂-W-type ferrite, when substitution with Zr+Hf elements is performed, the maximum value of the magnetic permeability μ′ at 6 GHz is as high as μ′=3.15 as seen from No. 150 in Table 9.

In the case of Mn₂-W-type ferrite, when substitution with the M_{2d} element is not performed, the maximum value of the magnetic permeability μ′ at 6 GHz is μ′=1.62 as seen from No. 30 in Table 2.

In the Mn₂-W-type ferrite, when substitution with an In element is performed, the maximum value of the magnetic permeability μ′ at 6 GHz is as high as μ′=2.45 as seen from No. 268 in Table 14.

In the Mn₂-W-type ferrite, substitution with a Sc element is performed, the maximum value of the magnetic permeability μ′ at 6 GHz is as high as μ′=2.51 as seen from No. 273 in Table 14.

In the Mn₂-W-type ferrite, when substitution with a Sn element is performed, the maximum value of the magnetic permeability μ′ at 6 GHz is as high as μ′=3.15 as seen from No. 174 in Table 10.

In the Mn₂-W-type ferrite, when substitution with Zr+Hf elements is performed, the maximum value of the magnetic permeability μ′ at 6 GHz is as high as μ′=3.15 as seen from No. 181 in Table 10.

In the case of Ni₂-W-type ferrite, when substitution with the M_{2d} element is not performed, the maximum value of the magnetic permeability μ′ at 6 GHz is μ′=1.71 as seen from No. 49 in Table 3.

In the Ni₂-W-type ferrite, when substitution with an In element is performed, the maximum value of the magnetic permeability μ′ at 6 GHz is as high as μ′=2.26 as seen from No. 283 in Table 15.

In the Ni₂-W-type ferrite, substitution with a Sc element is performed, the maximum value of the magnetic permeability μ′ at 6 GHz is as high as μ′=2.27 as seen from No. 288 in Table 15.

In the Ni₂-W-type ferrite, when substitution with a Sn element is performed, the maximum value of the magnetic permeability μ′ at 6 GHz is as high as μ′=2.68 as seen from No. 205 in Table 11.

In the Ni₂-W-type ferrite, when substitution with Zr+Hf elements is performed, the maximum value of the magnetic permeability μ′ at 6 GHz is as high as μ′=2.56 as seen from No. 212 in Table 11.

In the case of Zn₂-W-type ferrite, when substitution with the M_{2d} element is not performed, the maximum value of the magnetic permeability μ′ at 6 GHz is μ′=2.12 as seen from No. 67 in Table 4.

In the Zn₂-W-type ferrite, when substitution with an In element is performed, the maximum value of the magnetic permeability μ′ at 6 GHz is as high as μ′=2.49 as seen from No. 298 in Table 16.

In the Zn₂-W-type ferrite, when substitution with a Sc element is performed, the maximum value of the magnetic permeability μ′ at 6 GHz is as high as μ′=2.50 as seen from No. 303 in Table 16.

In the Zn₂-W-type ferrite, when substitution with a Sn element is performed, the maximum value of the magnetic permeability μ′ at 6 GHz is as high as μ′=2.97 as seen from No. 236 in Table 12.

In the Zn₂-W-type ferrite, when substitution with Zr+Hf elements is performed, the maximum value of the magnetic permeability μ′ at 6 GHz is as high as μ′=2.79 as seen from No. 243 in Table 12.

However, since the cations on the five-coordinate sites are 5.3 mol % in the crystal structure (AMe₂Fe₁₆O₂₇) of the W-type ferrite, substitution with the nonmagnetic ions also occurs on the six-coordinate Fe sites when the nonmagnetic ions are excessively added. When substitution with the nonmagnetic ions also occurs on the six-coordinate Fe sites, the effect of the ferromagnetic Fe is weakened, and as a result, the saturation magnetization decreases, and the magnetic loss increases. As a result, at M_{2d}>7.8 mol %, the magnetic loss at 6 GHz becomes as large as tan δ>0.06, and thus magnetic properties difficult to use in an inductor or the like are exhibited. Each element of Mai (Sn.Zr+Hf.In.Sc) will be described separately in Configuration 1-8 and Configuration 1-9.

### Configuration 1-8: Sn: 0 Mol % to 7.8 Mol %, Zr+Hf: 0 Mol % to 7.8 Mol %

Sn, Zr, and Hf have an effect of increasing the magnetic permeability by substitution on the five-coordinate sites of Fe. However, since all of them have a property of easily becoming a tetravalent cation, it is necessary to correct the charge balance amount D by adding an element of M (II) that tends to be a divalent cation or an element of M (I) that tends to be a monovalent cation.

Note that Zr and Hf are elements produced from the same ore, have the same effect, and are denoted as Zr+Hf because the cost increases if they are separated and purified.

When Sn>7.8 mol % or Zr+Hf>7.8 mol %, the magnetic loss at 6 GHz becomes as large as tan δ>0.06, and thus magnetic properties difficult to use in an inductor or the like are exhibited. Details are as follows.

When Sn=7.8 mol %, the magnetic loss tan δ at 6 GHz is 0.06 or less as seen from Nos. 129 and 144 in Table 9 for the Mg₂-W-type ferrite, Nos. 160 and 175 in Table 10 for the Mn₂-W-type ferrite, Nos. 191 and 206 in Table 11 for the Ni₂-W-type ferrite, and Nos. 222 and 237 in Table 12 for the Zn₂-W-type ferrite.

When Sn>7.8 mol %, the magnetic loss tan δ at 6 GHz is 0.06 or more as seen from Nos. 130 and 145 in Table 9 for the Mg₂-W-type ferrite, Nos. 161 and 176 in Table 10 for the Mn₂-W-type ferrite, Nos. 192 and 207 in Table 11 for the Ni₂-W-type ferrite, and Nos. 223 and 238 in Table 12 for the Zn₂-W-type ferrite, and thus magnetic properties difficult to use in an inductor or the like are exhibited.

When Zr+Hf=7.8 mol %, the magnetic loss tan δ at 6 GHz is 0.06 or less as seen from Nos. 135 and 151 in Table 9 for the Mg₂-W-type ferrite, Nos. 166 and 182 in Table 10 for the Mn₂-W-type ferrite, Nos. 197 and 213 in Table 11 for the Ni₂-W-type ferrite, and Nos. 228 and 244 in Table 12 for the Zn₂-W-type ferrite.

When Zr+Hf>7.8 mol %, the magnetic loss tan δ at 6 GHz is 0.06 or more as seen from Nos. 136 and 152 in Table 9 for the Mg₂-W-type ferrite, Nos. 167 and 183 in Table 10 for the Mn₂-W-type ferrite, Nos. 198 and 214 in Table 11 for the Ni₂-W-type ferrite, and Nos. 229 and 245 in Table 12 for the Zn₂-W-type ferrite, and thus magnetic properties difficult to use in an inductor or the like are exhibited.

### Configuration 1-9: In: 0 Mol % to 7.8 Mol %, Sc: 0 Mol % to 7.8 Mol %

When partial substitution with In or Sc is performed, the substitution occurs on the five-coordinate sites of Fe and provides an effect to increase the magnetic permeability. Since both of them have a property of easily becoming trivalent cations, the charge balance is not lost also in a case where trivalent Fe is substituted with In or Sc, and it is not necessary to correct the charge balance amount D.

When In >7.8 mol % or Sc>7.8 mol %, the magnetic loss at 6 GHz becomes as large as tan δ>0.06, and thus magnetic properties difficult to use in an inductor or the like are exhibited. Details are as follows.

When In=7.8 mol %, the magnetic loss tan δ at 6 GHz is 0.06 or less as seen from No. 254 in Table 13 for the Mg₂-W-type ferrite, No. 269 in Table 14 for the Mn₂-W-type ferrite, No. 284 in Table 15 for the Ni₂-W-type ferrite, and No. 299 in Table 16 for the Zn₂-W-type ferrite.

When In>7.8 mol %, the magnetic loss tan δ at 6 GHz is 0.06 or more as seen from No. 255 in Table 13 for the Mg₂-W-type ferrite, No. 270 in Table 14 for the Mn₂-W-type ferrite, No. 285 in Table 15 for the Ni₂-W-type ferrite, and No. 300 in Table 16 for the Zn₂-W-type ferrite, and thus magnetic properties difficult to use in an inductor or the like are exhibited.

When Sc=7.8 mol %, the magnetic loss tan δ at 6 GHz is 0.06 or less as seen from No. 259 in Table 13 for the Mg₂-W-type ferrite, No. 274 in Table 14 for the Mn₂-W-type ferrite, No. 289 in Table 15 for the Ni₂-W-type ferrite, and No. 304 in Table 16 for the Zn₂-W-type ferrite.

When Sc>7.8 mol %, the magnetic loss tan δ at 6 GHz is 0.06 or more as seen from No. 260 in Table 13 for Mg₂-W-type ferrite, No. 275 in Table 14 for Mn₂-W-type ferrite, No. 290 in Table 15 for Ni₂-W-type ferrite, and No. 305 in Table 16 for Zn₂-W-type ferrite, and thus magnetic properties difficult to use in an inductor or the like are exhibited.

### Configuration 1-10: Ge: 0 Mol % to 2.6 Mol %, Si: 0 Mol % to 2.6 Mol %, and Ti: 0 Mol % to 2.6 Mol %

It is necessary to correct the charge balance amount D by adding an element of M (II) that tends to be a divalent cation or an element of M (I) that tends to be a monovalent cation when partial substitution with Ge, Si, or Ti, which tends to be a tetravalent cation, is performed.

When Ge>2.6 mol %, Si>2.6 mol %, or Ti>2.6 mol %, the magnetic loss at 6 GHz becomes as large as tan δ>0.06, and thus magnetic properties difficult to use in an inductor or the like are exhibited. Details are as follows.

When Ge=2.6 mol %, the magnetic permeability μ′ at 6 GHz is 1.10 or more, and the magnetic loss tan δ is 0.06 or less, as seen from Nos. 123 and 137 in Table 9, Nos. 154 and 168 in Table 10, Nos. 185 and 199 in Table 11, and Nos. 216 and 230 in Table 12. However, when Ge>2.6 mol %, the magnetic loss tan δ at 6 GHz is 0.06 or more as seen from Nos. 124 and 138 in Table 9, Nos. 155 and 169 in Table 10, Nos. 186 and 200 in Table 11, and Nos. 217 and 231 in Table 12, and thus magnetic properties difficult to use in an inductor or the like are exhibited.

When Si=2.6 mol %, the magnetic permeability μ′ at 6 GHz is 1.10 or more, and the magnetic loss tan δ is 0.06 or less, as seen from Nos. 125 and 139 in Table 9, Nos. 156 and 170 in Table 10, Nos. 187 and 201 in Table 11, and Nos. 218 and 232 in Table 12. However, when Si>2.6 mol %, the magnetic loss tan δ at 6 GHz is 0.06 or more as seen from Nos. 126 and 140 in Table 9, Nos. 157 and 171 in Table 10, Nos. 188 and 202 in Table 11, and Nos. 219 and 233 in Table 12, and thus magnetic properties difficult to use in an inductor or the like are exhibited.

When Ti=2.6 mol %, the magnetic permeability μ′ at 6 GHz is 1.10 or more, and the magnetic loss tan δ is 0.06 or less, as seen from Nos. 131 and 146 in Table 9, Nos. 162 and 177 in Table 10, Nos. 193 and 208 in Table 11, and Nos. 224 and 239 in Table 12. However, when Ti>2.6 mol %, the magnetic loss tan δ at 6 GHz is 0.06 or more as seen from Nos. 132 and 147 in Table 9, Nos. 163 and 178 in Table 10, Nos. 194 and 209 in Table 11, and Nos. 225 and 240 in Table 12, and thus magnetic properties difficult to use in an inductor or the like are exhibited.

### Configuration 1-11: Al: 0 Mol % to 2.6 Mol %, Ga: 0 Mol % to 2.6 Mol %

When partial substitution with Al or Ga is performed, the substitution occurs on the six-coordinate sites of Fe, whereby the saturation magnetization decreases and the coercivity increases.

When Al>2.6 mol % or Ga>2.6 mol %, the magnetic permeability μ′ at 6 GHz drops to μ′<1.10, and the magnetic loss at 6 GHz becomes as large as tan δ>0.06, and thus magnetic properties difficult to use in an inductor or the like are exhibited. Details are as follows.

When Al=2.6 mol %, the magnetic permeability μ′ at 6 GHz is 1.10 or more, and the magnetic loss tan δ is 0.06 or less, as seen from No. 247 in Table 13, No. 262 in Table 14, No. 277 in Table 15, and No. 292 in Table 16. However, when Al>2.6 mol %, the magnetic loss tan δ at 6 GHz is 0.06 or more as seen from No. 248 in Table 13, No. 263 in Table 14, No. 278 in Table 15, and No. 293 in Table 16, and thus magnetic properties difficult to use in an inductor or the like are exhibited.

When Ga=2.6 mol %, the magnetic permeability μ′ at 6 GHz is 1.10 or more, and the magnetic loss tan δ is 0.06 or less, as seen from No. 249 in Table 13, No. 264 in Table 14, No. 279 in Table 15, and No. 294 in Table 16. However, when Ga>2.6 mol %, the magnetic loss tan δ at 6 GHz is 0.06 or more as seen from No. 250 in Table 13, No. 265 in Table 14, No. 280 in Table 15, and No. 295 in Table 16, and thus magnetic properties difficult to use in an inductor or the like are exhibited.

### Configuration 1-12: Mo: 0 Mol % to 2.6 Mol %, Nb+Ta: 0 Mol % to 2.6 Mol %, Sb: 0 mol % to 2.6 mol %, W: 0 mol % to 2.6 mol %, V: 0 mol % to 2.6 mol %

When partial substitution with Mo, Nb, Ta, Sb, W, or V is performed, they have a property of easily becoming a pentavalent or hexavalent cation, and thus the charge balance amount D needs to be corrected by adding an element of M (II) that tends to be a divalent cation or an element of M (I) that tends to be a monovalent cation.

When Mo>2.6 mol %, Nb+Ta>2.6 mol %, Sb>2.6 mol %, W>2.6 mol %, or V>2.6 mol %, the magnetic permeability μ′ at 6 GHz drops to μ′<1.10, and the magnetic loss at 6 GHz becomes as large as tan δ>0.06, and thus magnetic properties difficult to use in an inductor or the like are exhibited. Details are as follows.

When Mo=2.6 mol %, the magnetic permeability μ′ at 6 GHz is 1.10 or more, and the magnetic loss tan δ is 0.06 or less, as seen from No. 327 in Table 18. However, when Mo>2.6 mol %, the magnetic permeability μ′ at 6 GHz is 1.10 or less, and the magnetic loss tan δ is 0.06 or more, as seen from No. 328 in Table 18, and thus magnetic properties difficult to use in an inductor or the like are exhibited.

When Nb+Ta=2.6 mol %, the magnetic permeability μ′ at 6 GHz is 1.10 or more, and the magnetic loss tan δ is 0.06 or less, as seen from No. 329 in Table 18. However, when Nb+Ta>2.6 mol %, the magnetic permeability μ′ at 6 GHz is 1.10 or less, and the magnetic loss tan δ is 0.06 or more, as seen from No. 330 in Table 18, and thus magnetic properties difficult to use in an inductor or the like are exhibited.

When Sb=2.6 mol %, the magnetic permeability μ′ at 6 GHz is 1.10 or more, and the magnetic loss tan δ is 0.06 or less, as seen from No. 331 in Table 18. However, when Sb>2.6 mol %, the magnetic permeability μ′ at 6 GHz is 1.10 or less, and the magnetic loss tan δ is 0.06 or more, as seen from No. 332 in Table 18, and thus magnetic properties difficult to use in an inductor or the like are exhibited.

When W=2.6 mol %, the magnetic permeability μ′ at 6 GHz is 1.10 or more, and the magnetic loss tan δ is 0.06 or less, as seen from No. 333 in Table 18. However, when W>2.6 mol %, the magnetic permeability μ′ at 6 GHz is 1.10 or less, and the magnetic loss tan δ is 0.06 or more, as seen from No. 334 in Table 18, and thus magnetic properties difficult to use in an inductor or the like are exhibited.

When V=2.6 mol %, the magnetic permeability μ′ at 6 GHz is 1.10 or more, and the magnetic loss tan δ is 0.06 or less, as seen from No. 335 in Table 18. However, when V>2.6 mol %, the magnetic permeability μ′ at 6 GHz is 1.10 or less, and the magnetic loss tan δ is 0.06 or more, as seen from No. 336 in Table 18, and thus magnetic properties difficult to use in an inductor or the like are exhibited.

### Configuration 1-13: Li: 0 mol % to 2.6 mol %

When the amount of Li added=2.6 mol %, the magnetic permeability μ′ at 6 GHz is 1.1 or more, and the magnetic loss tan δ is 0.06 or less, as seen from No. 338 in Table 19. However, when the amount of Li added is >2.6 mol %, the magnetic loss tan δ at 6 GHz is 0.06 or more as seen from No. 339 in Table 19, and thus magnetic properties difficult to use in an inductor or the like are exhibited.

In the soft magnetic composition of the present invention, the coercivity Hcj is 100 kA/m or less.

By reducing the coercivity, the composition exhibits soft magnetic properties and the magnetic permeability μ′ at 6 GHz can be increase to 1.10 or more.

When the coercivity is low, in the case of a ferrite material, the residual magnetic field is reduced due to a low-temperature demagnetization phenomenon and thus it is difficult to practically use the ferrite material as a permanent magnet. On the other hand, in an inductor or an antenna, since the magnetic permeability is increased by utilizing magnetic force generated from a conductive wire having a coil shape or the like, which is the mechanism that a residual magnetic field is unnecessary, the ferrite material can be used.

FIG. 2 shows magnetization curves (BH curves) of a typical M-type hexagonal ferrite magnet and a W-type hexagonal ferrite soft magnetic body. In a typical ferrite magnet material, since the coercivity is as high as Hcj>300 kA/m, the BH curve is a straight line, it is possible to prevent low-temperature demagnetization regardless of the permeance coefficient, and it is possible to maintain the magnetic force from the magnet also in a case where the temperature changes. On the other hand, in the W-type ferrite soft magnetic body of the present invention, since the coercivity is as low as Hcj≤100 kA/m, when the W-type ferrite soft magnetic body is used as a magnet, low-temperature demagnetization cannot be prevented, and the magnetic force decreases due to temperature change. Thus, it cannot be practically used as a magnet material. In addition, in a magnetic recording material, when the coercivity is small, a weak external magnetic field or low-temperature demagnetization occurs, and the magnetic record disappears. Thus, it cannot be practically used as a magnetic recording material. For this reason, it is not suitable to use the materials exhibiting the magnet properties described in Patent Documents 1, 2, and 3 as an inductor as in the present invention.

The soft magnetic composition of the present invention may exclude at least one soft magnetic composition among soft magnetic compositions which are oxides containing a W-type hexagonal ferrite as a main phase and having the following metal element ratio, and have the following coercivity Hcj.

Ba: 5.18 mol %, Ca: 1.55 mol %, Co: 2.59 mol %, Zn: 7.77 mol %, Fe: 82.90 mol %, Hcj: 36.4 kA/m.

Ba: 5.18 mol %, Ca: 1.55 mol %, Co: 1.04 mol %, Zn: 9.33 mol %, In: 5.18 mol %, Fe: 77.72 mol %, Hcj: 80.0 kA/m.

Ba: 5.18 mol %, Ca: 1.55 mol %, Co: 1.04 mol %, Zn: 9.33 mol %, Sc: 5.18 mol %, Fe: 77.72 mol %, Hcj: 78.8 kA/m.

Ba: 5.18 mol %, Ca: 1.55 mol %, Co: 1.04 mol %, Ni: 5.18 mol %, Zn: 9.33 mol %, Sn: 5.18 mol %, Fe: 72.54 mol %, Hcj: 77.6 kA/m.

Ba: 5.18 mol %, Ca: 1.55 mol %, Co: 1.04 mol %, Ni: 5.18 mol %, Zn: 9.33 mol %, Zr+Hf: 5.18 mol %, Fe: 72.54 mol %, Hcj: 75.8 kA/m.

In the soft magnetic composition of the present invention, the saturation magnetization Is is desirably 200 mT or more.

It is generally known that increasing saturation magnetization Is of a material to increase saturation magnetic flux density Bs is effective for increasing DC superposition property. Patent Document 1 describes that in hexagonal ferrite, the W-type has higher saturation magnetization than the M-type and the Z-type. Due to the trends toward low voltage and high current in integrated circuits (ICs), the current value tends to increase not only in power supply circuits but also in communication circuits and the like, and thus a material having low saturation magnetization has the problem of deteriorating DC superposition property.

In the soft magnetic composition of the present invention, the specific resistance ρ is desirably 10⁶ Ω·m or more.

When the specific resistance is low, since the eddy current loss increases at low frequencies, the magnetic loss increases and the dielectric constant also increases. When the specific resistance is as high as ρ≥10⁶ [Ω·m], the eddy current loss decreases also in the GHz band, and the magnetic loss can be reduced.

In the soft magnetic composition of the present invention, the magnetic permeability μ′ at 6 GHz is desirably 1.10 or more, and more desirably 2 or more.

In a case where the magnetic permeability is as high as μ′≥1.1, the inductance of the coil can be made higher than that of an air-core coil when both coils are processed so as to have the same number of turns. When the magnetic permeability is as high as μ′≥2.0, an inductance equal to or higher than that of the air-core coil can be obtained also in a case where the number of turns of the coil is reduced as shown in FIG. 38. By reducing the number of turns of the coil, as shown in FIG. 38, the stray capacitance C of the inductor decreases, and the LC resonant frequency can be increased. Thus, as shown in FIG. 39, the high Q can be obtained until a higher frequency is reached, and the upper limit of the used frequency of the inductor can be increased.

The air-core coil is a coil using only a nonmagnetic body such as glass or resin as a winding core material.

In the soft magnetic composition of the present invention, the magnetic loss tan δ at 6 GHz is desirably 0.06 or less.

Since the reduction of the magnetic loss tan δ can reduce the magnetic loss, it is possible to suppress a decrease in Q of the coil due to insertion of a magnetic body core. By using a magnetic body, when a coil is formed, Q of the coil can be increased in a high frequency range as shown in FIG. 39.

In the soft magnetic composition of the present invention, the dielectric constant c is desirably 30 or less.

In a case where the stray capacitance between the windings of the coil is large, if the LC resonant frequency decreases to several GHz or less in the coil component, it does not function as an inductor no matter how high Q of the magnetic material is. Thus, in order to use as a GHz band inductor, it is desirable to suppress the dielectric constant of the magnetic material to ε≤30. However, as shown in FIG. 41, when a low dielectric constant material is used for the winding portion 21B and a magnetic material is used only for the core portion 21A, a low dielectric constant magnetic material is not necessarily required.

The soft magnetic composition of the present invention is in a powder state. For industrial utilization of such a soft magnetic composition, it is necessary to make it in a liquid or solid state. For example, in order to be used as a winding inductor, a sintered body is preferably formed. For use as a multilayer inductor, a sintered body may be acceptable, but it is effective to mix the composition with a nonmagnetic body such as glass or resin for achieving higher frequency by reducing the dielectric constant to decrease the stray capacitance. For use as a magnetic fluid, a paste form is desirable.

Such a sintered body obtained by firing the soft magnetic composition of the present invention, or a composite body or paste obtained by mixing the soft magnetic composition of the present invention and a nonmagnetic body composed of at least one of glass and a resin is also encompassed by the present invention. The sintered body, the composite body, or the paste of the present invention may contain a ferromagnetic body, another soft magnetic body, or the like.

The sintered body means fine ceramics defined in JIS R 1600. The composite body means a material in which two or more materials having different properties are integrated or combined by firmly bonding at an interface while maintaining the respective phases. The paste is a dispersion system in which a soft magnetic powder is suspended, and means a substance having fluidity and high viscosity.

In addition, the nonmagnetic body means a substance that is not a ferromagnetic body and has a saturation magnetization of 1 mT or less.

Furthermore, a coil component formed by using the sintered body, the composite body, or the paste of the present invention is also encompassed by the present invention. The coil component of the present invention can also be used as a noise filter utilizing LC resonance by combining it with a capacitor.

The coil component means an electronic component using a coil described in JIS C 5602.

A coil component of the present invention includes a core portion and a winding portion provided around the core portion, the core portion is formed by using the sintered body, the composite body, or the paste of the present invention, and the winding portion always contains an electric conductor such as silver or copper.

Note that the winding means a wire that connects a portion of the periphery or the inside of a substance having spontaneous magnetization with an electric conductor. The electric conductor means a structure which is composed of a material having an electrical conductivity σ of 10⁵ S/m to in which both ends of the windings are electrically connected.

An antenna formed by using the sintered body, the composite body, or the paste of the present invention is also encompassed by the present invention.

### EXAMPLE

Hereinafter, examples more specifically disclosing the present invention will be described. Note that the present invention is not limited only to these examples.

### Example 1

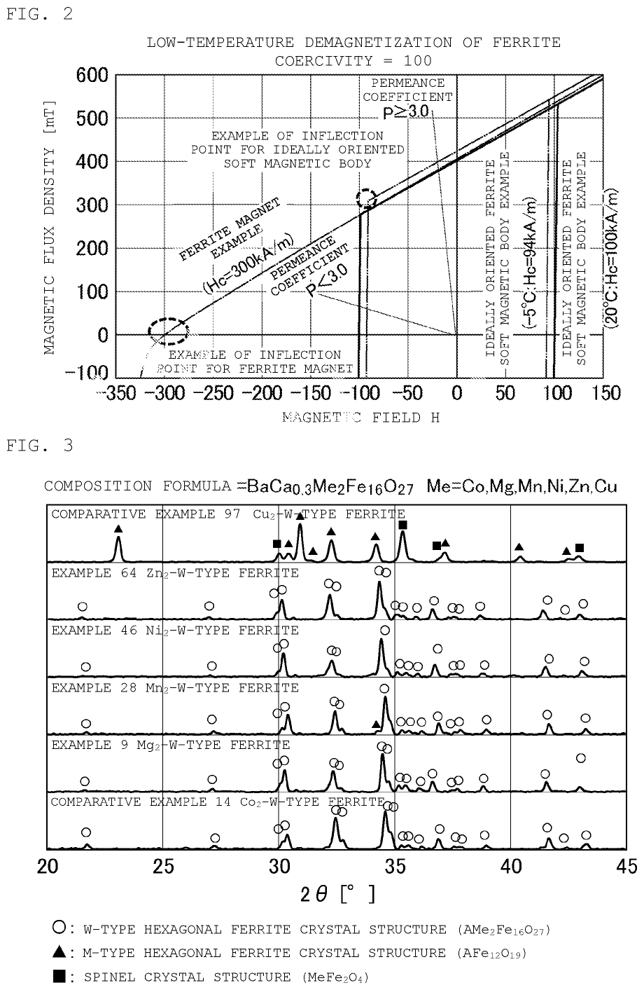

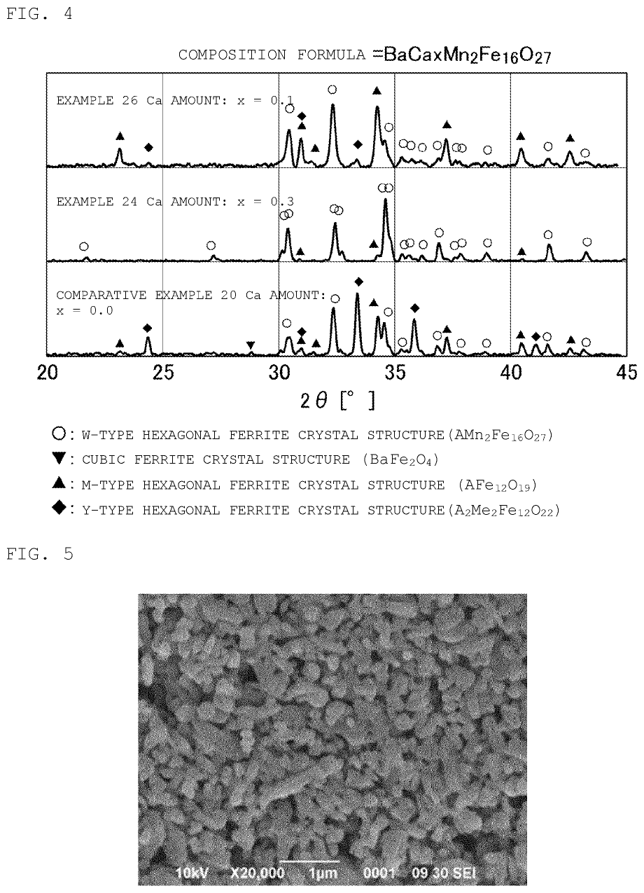

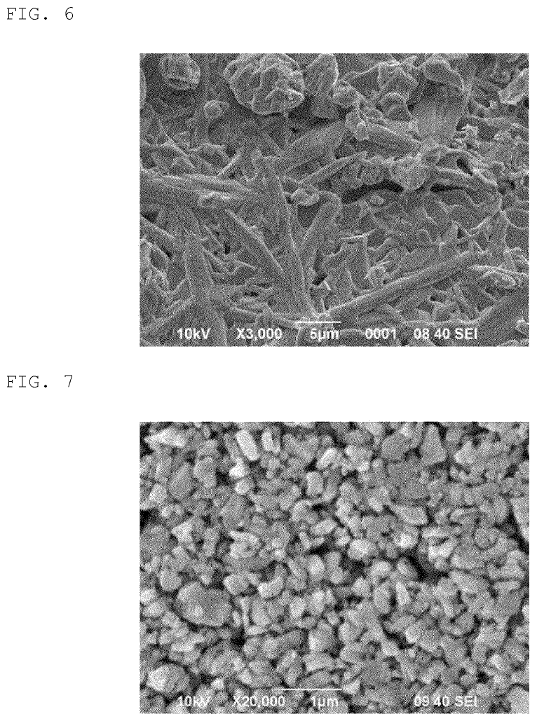

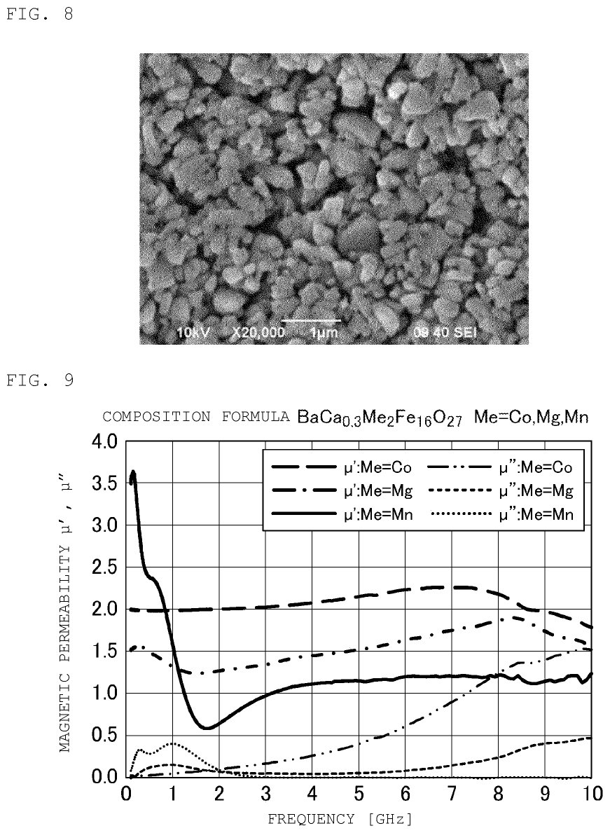

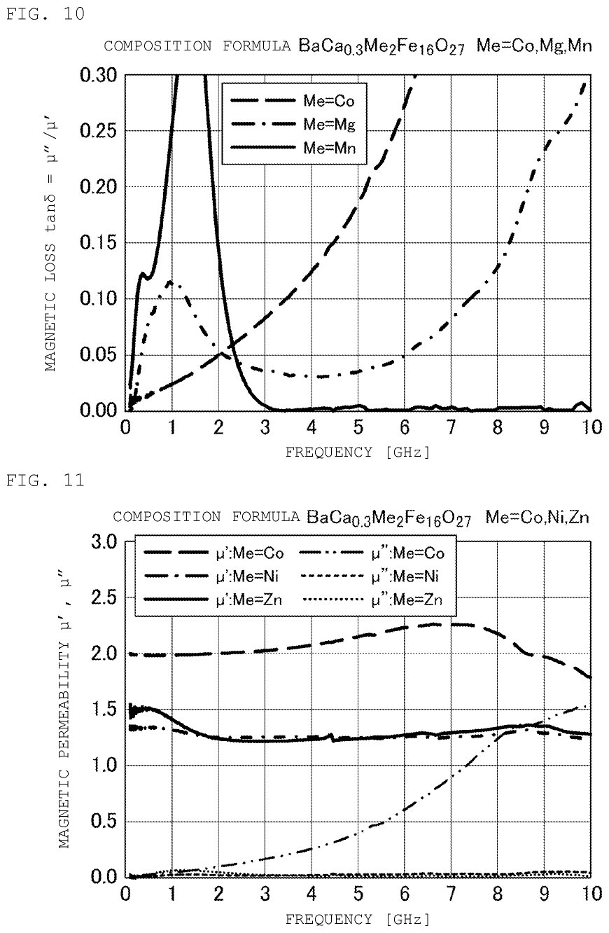

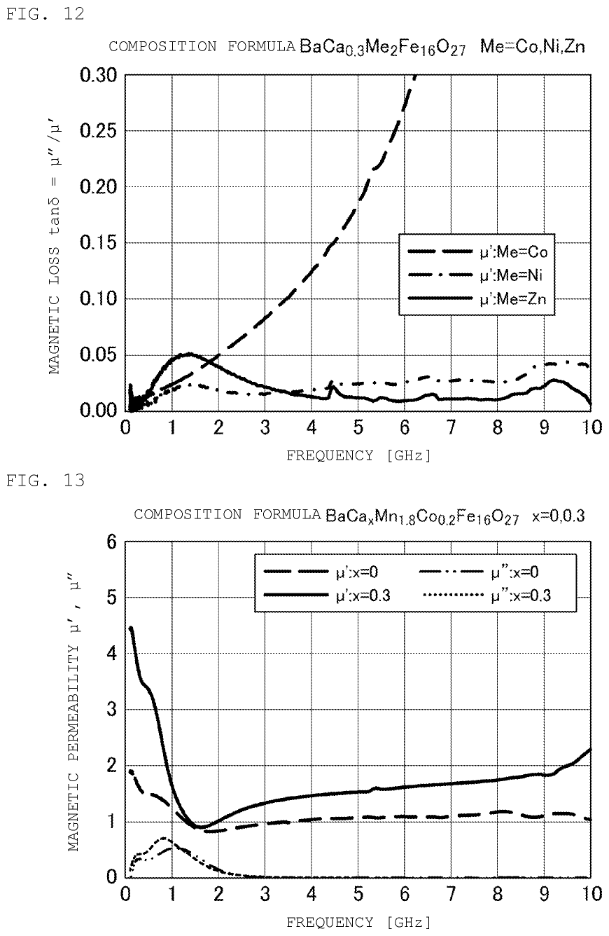

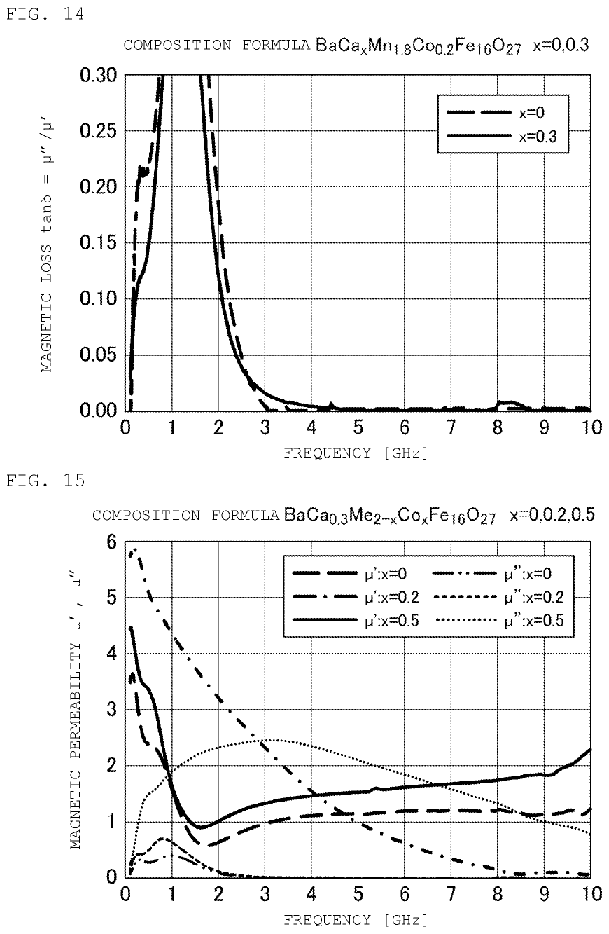

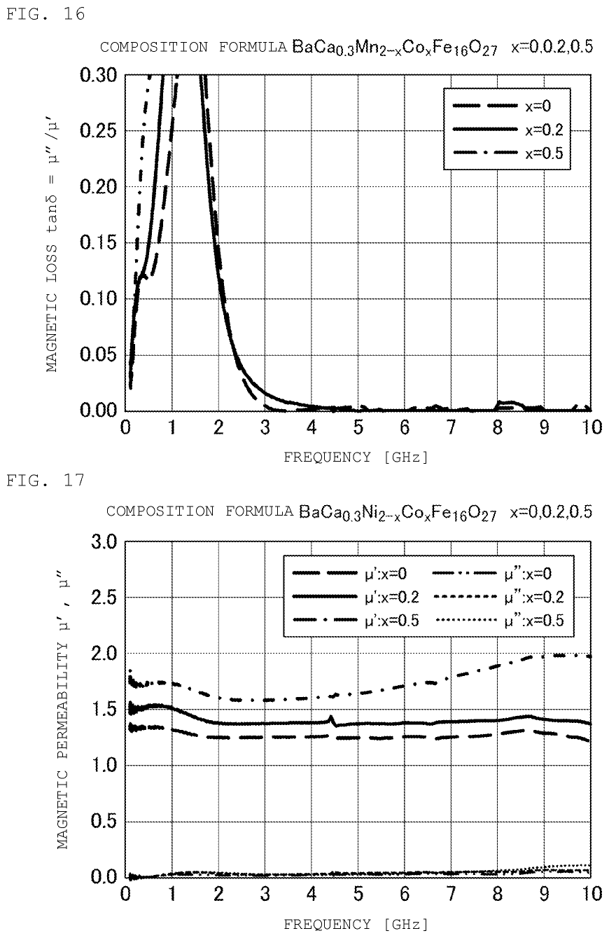

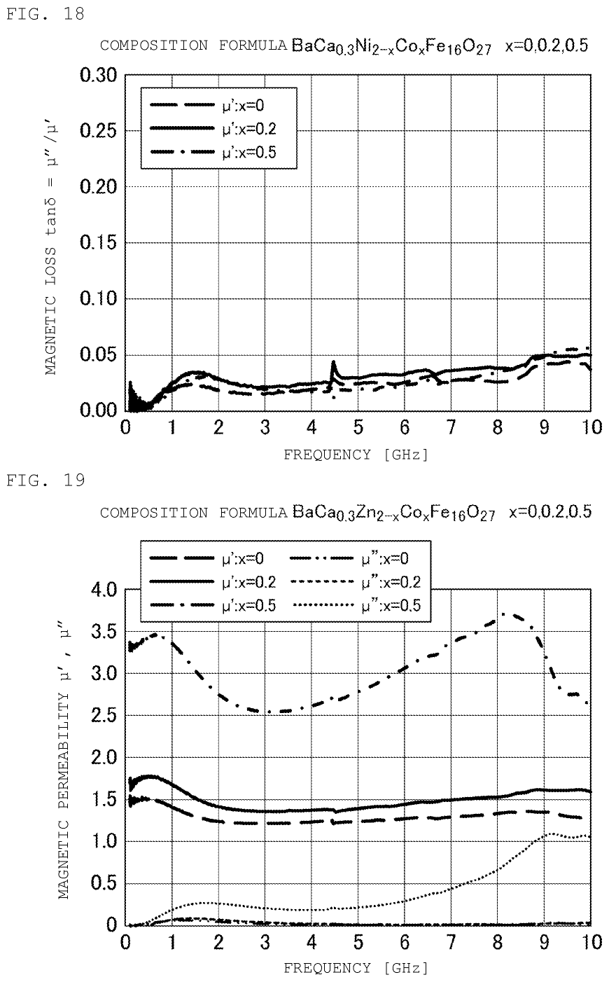

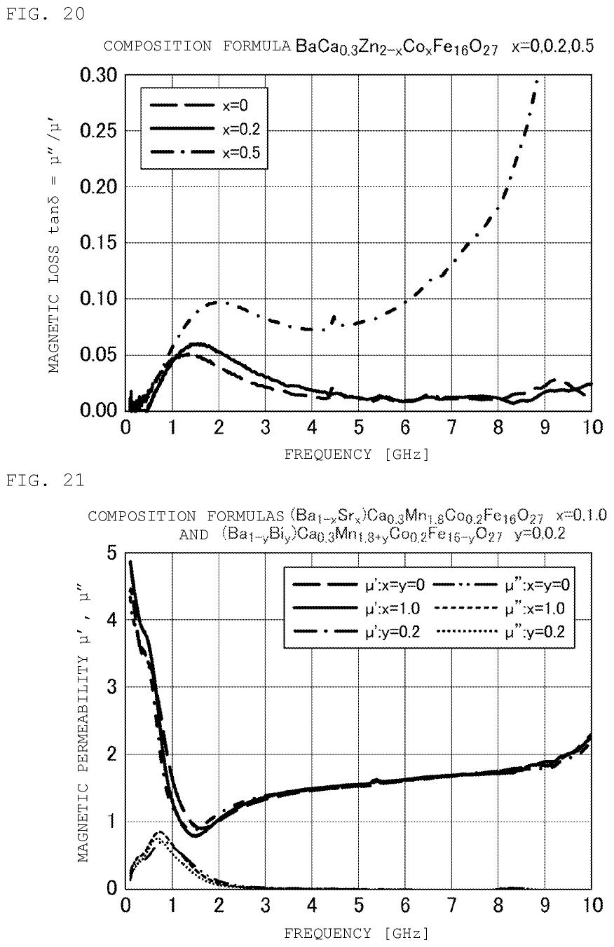

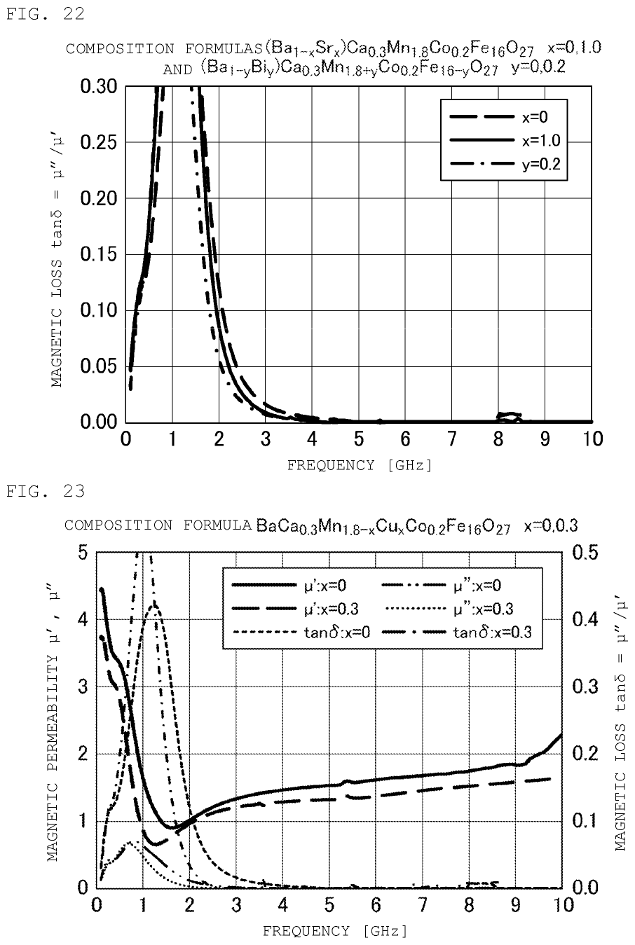

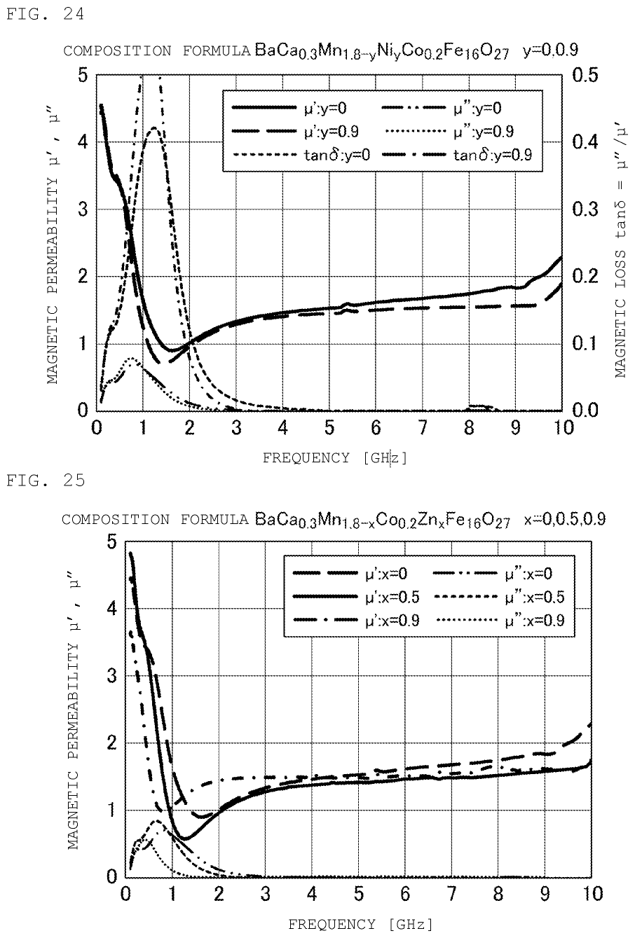

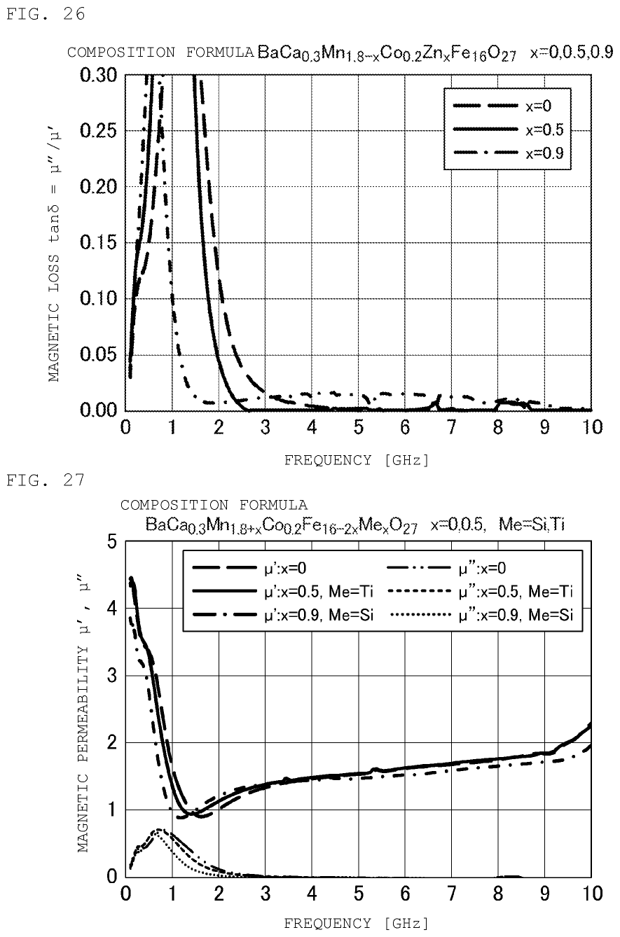

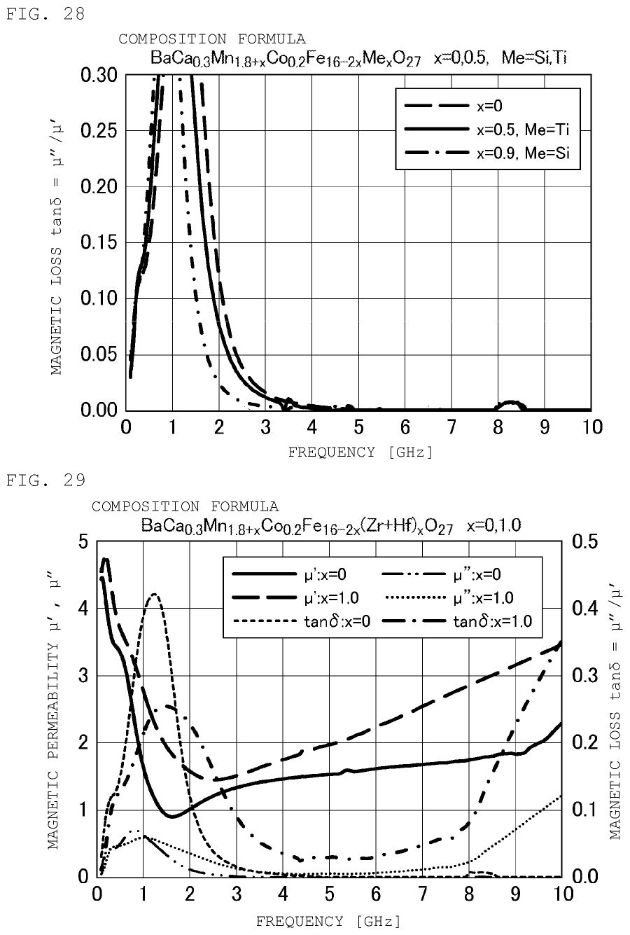

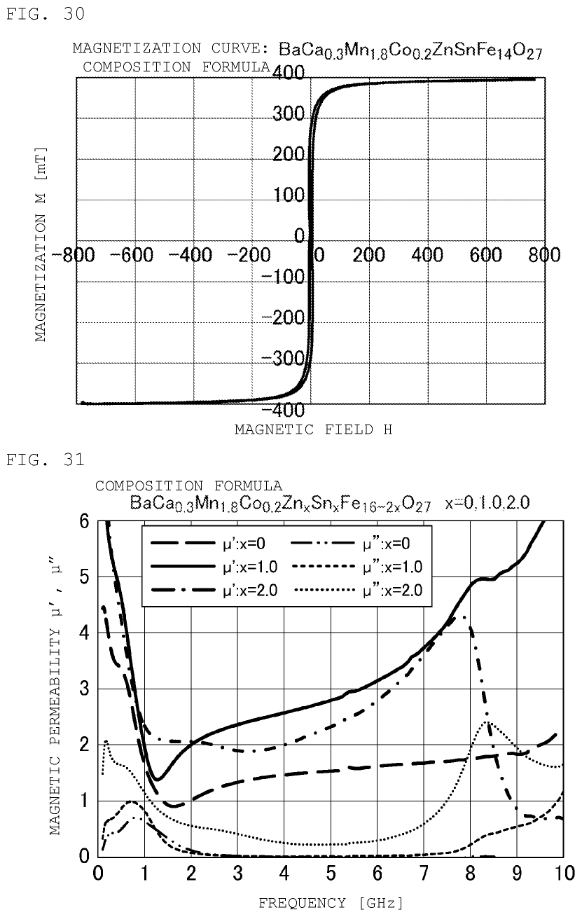

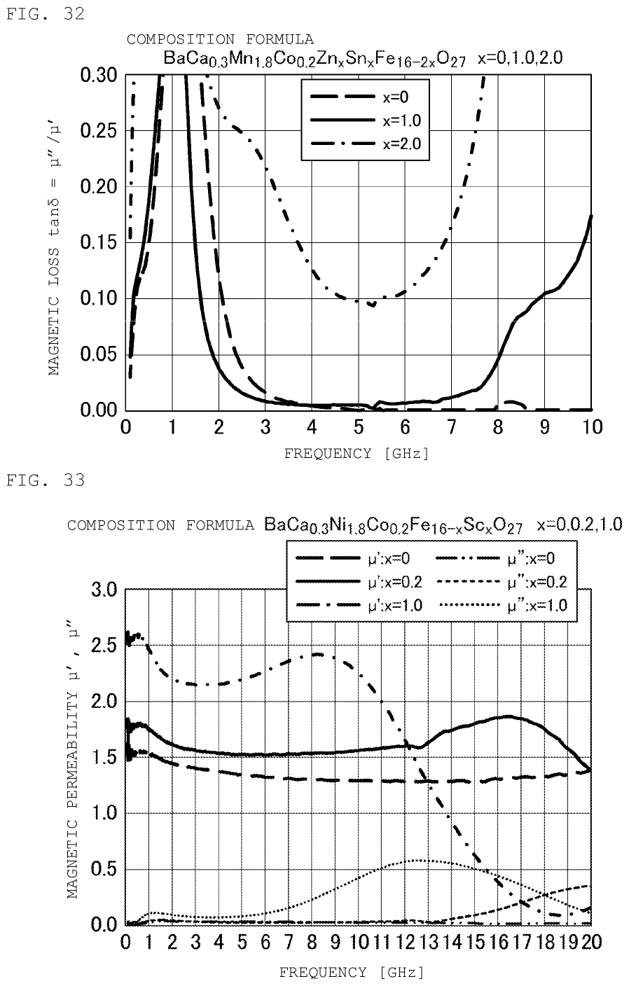

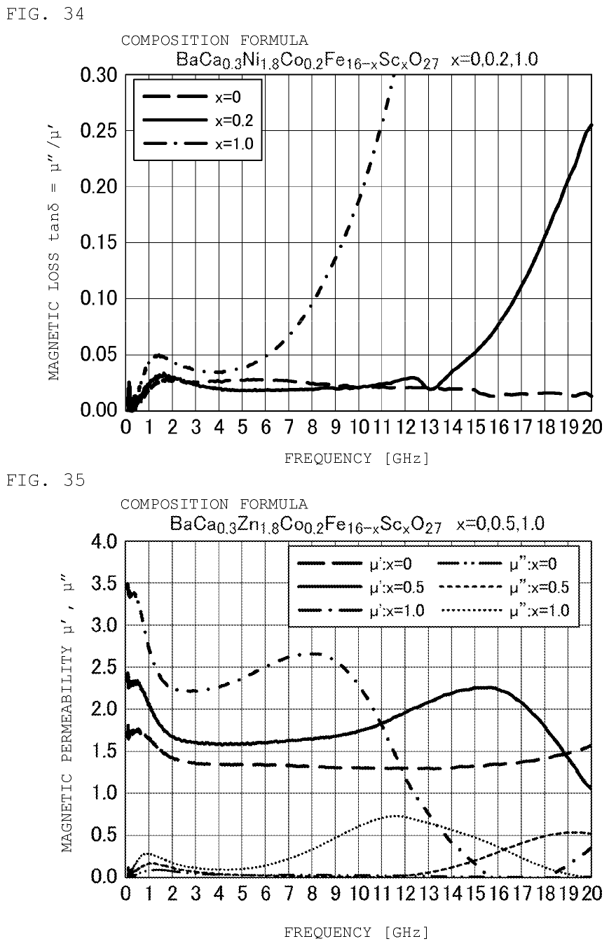

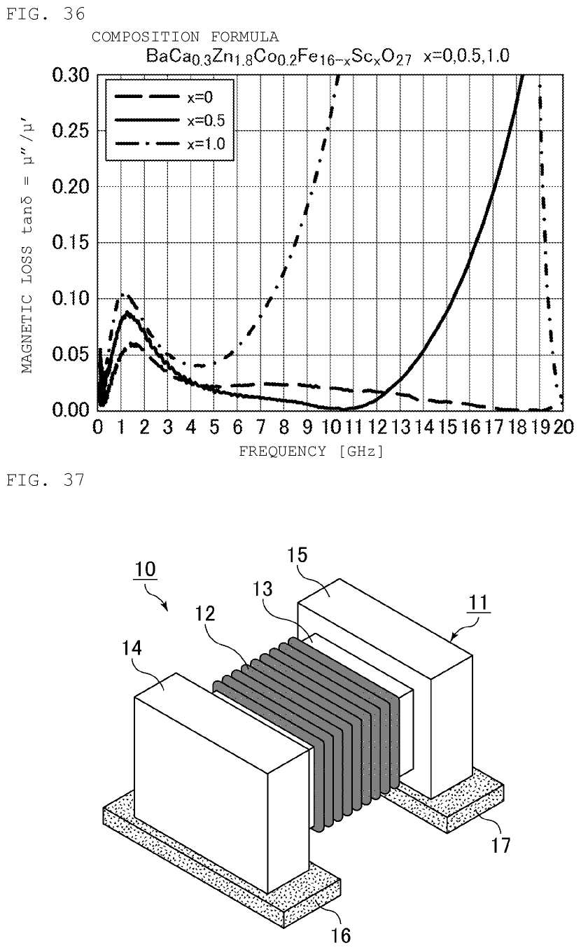

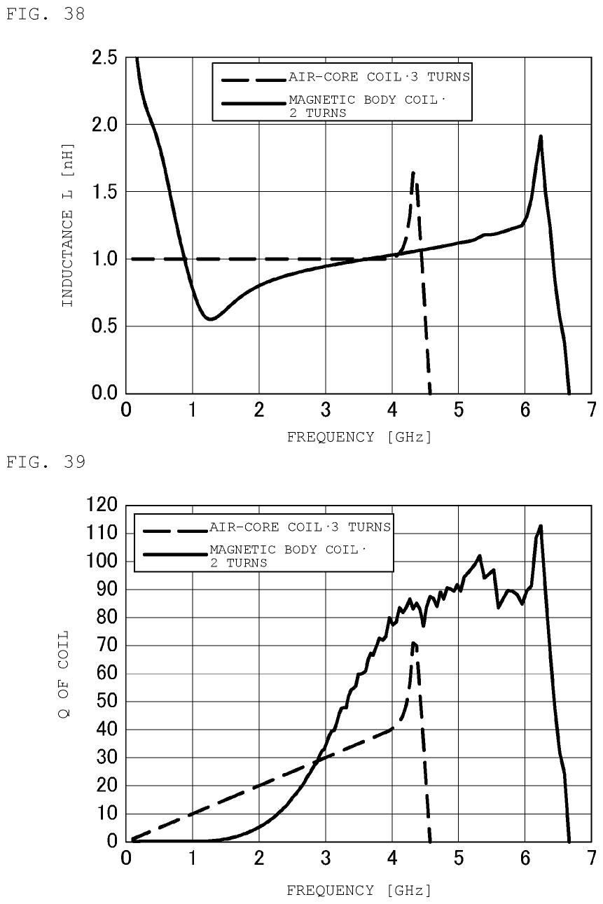

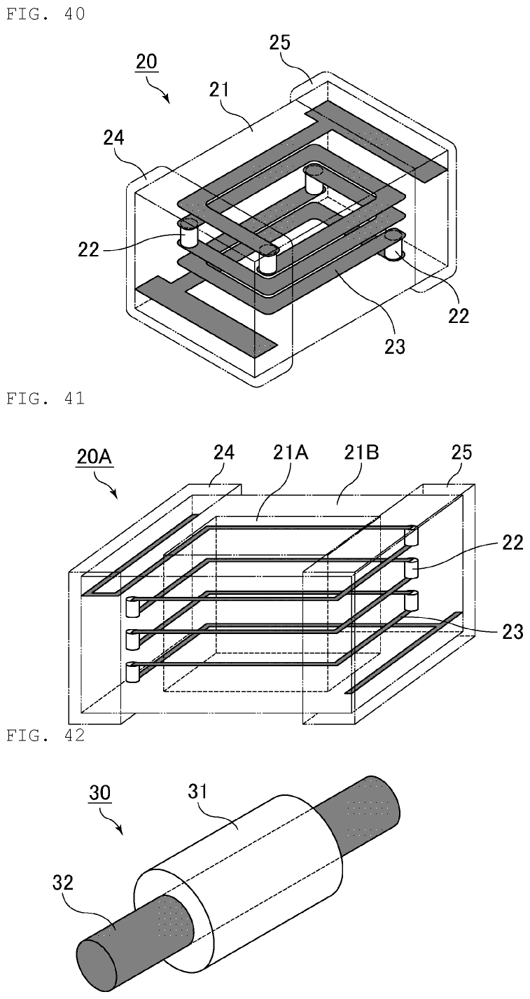

In the W-type ferrite (crystal structure: see FIG. 1, stoichiometric composition: BaMe₂Fe₁₆O₂₇), since calcium Ca can enter all of Ba, Fe, and grain boundaries, the composition formula is described in the form of BaCaₓMe_{y}Fe₂ₘO_{27-δ}. Powder materials of barium carbonate, calcium carbonate, iron oxide, cobalt oxide, magnesium oxide, manganese oxide, nickel oxide, and zinc oxide were set to select element Me=Co+Mg+Mn+Ni+Zn, and the respective powder compositions were blended such that the ratio of metal ions of Ba, Ca, Me, and Fe in the composition formula BaCaₓMe_{y}Fe₂ₘO_{27-δ} was a predetermined ratio shown in Tables 1 to 4, and the total amount of the materials was 100 g. Further, 80 to 120 g of pure water, 1 to 2 g of a dispersant of ammonium polycarboxylate, and 1 kg of 1 to 5 mmφ PSZ media were placed in a 500 cc pot made of polyester material, and mixed for 8 to 24 hours in a ball mill at a rotation speed of 100 to 200 rpm to form a slurry. The mixed slurry was dried by evaporation using a spray dryer or a freeze dryer to obtain a mixed and dried powder. The mixed and dried powder was passed through a sieve having an opening of 20 to 200 μm to obtain a sized powder. By calcining the sized powder in the atmosphere at 1000 to 1200° C., the calcined powder having the W-type hexagonal ferrite crystal structure shown in FIGS. 3 and 4 could be solid-phase synthesized.

FIG. 3 is an X-ray diffraction chart of a composition formula BaCa_{0.3}Me₂Fe₁₆O₂₇ (Me=Co, Mg, Mn, Ni, Zn, or Cu). In FIG. 3, the case where Me=Co element is No. 14 in Table 1, Me=Cu element is No. 97 in Table 6, Me=Mg element is No. 9 in Table 1, Me=Mn element is No. 28 in Table 2, Me=Ni element is No. 46 in Table 3, and Me=Zn element is No. 64 in Table 4.

In the case of Me=Co, Mg, Mn, Ni, or Zn, peaks of a W-type hexagonal ferrite crystal structure (structural formula=BaMe₂Fe₁₆O₂₇) were observed. However, in the case of Me=Cu, no peak of the W-type hexagonal ferrite crystal structure was observed, and peaks of the crystal structures of M-type hexagonal ferrite (structural formula=BaFe₁₂O₁₉) and spinel ferrite (structural formula=CuFe₂O₄) were observed.

FIG. 4 is an X-ray diffraction chart of a composition formula BaCaₓMn₂Fe₁₆O₂₇ (x=0, 0.3, or 1.0). In FIG. 4, the case where Ca is not added is No. 20 in Table 2, Ca: x=0.3 is No. 24 in Table 2, and Ca: x=1.0 is No. 26 in Table 2.

When the amount of Ca was x=0.3, peaks of a W-type hexagonal ferrite crystal structure (structural formula=BaMn₂Fe₁₆O₂₇) were mainly observed. When the amount of Ca is x=0 or 1.0, some peaks show the W-type hexagonal ferrite crystal structure, but different phases which are M-type hexagonal ferrite (structural formula=BaFe₁₂O₁₉) and Y-type hexagonal ferrite (structural formula=Ba₂Mn₂Fe₁₂O₂₂) remain. In particular, when the amount of Ca is x=0, the Y-type hexagonal ferrite phase is the main phase.

The calcined powder was coarsely pulverized by a dry pulverizer such that the secondary particles became fine particles of 50 μm or less. In a 500 cc pot made of polyester material, 80 g of the calcined powder in a form of fine particles, 60 to 100 g of pure water, 2 to 4 g of ammonium polycarboxylate as a dispersant, and 1000 g of 1 to 5 mmφ PSZ media were placed, and pulverized for 70 to 100 hours in a ball mill at a rotation speed of 100 to 200 rpm to obtain a slurry of finer particles. To the slurry of finer particles, 5 to 15 g of a vinyl acetate binder having a molecular weight of 5000 to 30000 was added, and the mixture was formed into a sheet by a doctor blade method using polyethylene terephthalate as a sheet material, at a gap between the blade and the sheet: 100 to 250 μm, a drying temperature: 50 to 70° C., and a sheet take-up speed: 5 to 50 cm/min. This sheet was die-cut into a 5.0 cm square pieces, from which the sheets of polyethylene terephthalate were peeled off. The resulting ferrite sheets were stacked such that the total sheet thickness was 0.3 to 2.0 mm and placed in a mold of a stainless steel material, and pressure-bonded from above and below at a pressure of 150 to 300 MPa in a state of being heated to 50 to 80° C. to obtain a pressure-bonded body. In a state of being warmed to 60 to 80° C., the pressure-bonded body was die-cut into thin plate shapes so as to have a size of 18 mm×5 mm×0.3 mm thick or 10 mm×2 mm×0.2 mm thick after sintering to obtain workpieces for measurement of magnetic permeability, and the press-bonded body was die-cut into 10 mmφ disks to obtain workpieces for measurement of specific resistance, density, and magnetization curve.

The disk-shaped and thin-plate-shaped workpieces were placed on a zirconia setter, and heated in the atmosphere at a temperature ramp rate of 0.1 to 0.5° C./min and a maximum temperature of 400° C. for a maximum temperature holding time of 1 to 2 hours to thermally decompose and remove the binder and the like, and then firing was performed in the atmosphere at a firing temperature selected from 900 to 1400° C. at which the magnetic loss component μ″ at 6 GHz is minimized at a temperature ramp rate of 1 to 5° C./min for a maximum temperature holding time of 1 to 10 hours (oxygen concentration: about 21%) to obtain a sintered body.

The surface SEM images of the sintered body of the composition formula BaCa_{0.3}Me_{1.8}Co_{0.2}Fe₁₆O₂₇ are shown in FIG. 5 when Me=Mg (No. 5 in Table 1), in FIG. 6 when Me=Mn (No. 24 in Table 2), in FIG. 7 when Me=Ni (No. 42 in Table 3), and in FIG. 8 when Me=Zn (No. 60 in Table 4).

As seen from FIGS. 5, 7, and 8, when Me=Mg, Ni, or Zn, it is an aggregate of hexagonal plate-shaped grains, and a large number of voids remain. The voids can reduce the magnetic loss tan δ.

As seen from FIG. 6, only when Me=Mn, the hexagonal plate-shaped grains undergo grain growth to reduce the number of voids, and are sintered. In spite of the small number of voids, when Me=Mn, the magnetic loss tan δ can be reduced.

For the measurement of the magnetic permeability, a short-circuited microstrip line jig for a rectangular sample (sample size: length 18.0 mm, width 5.0 mm, thickness ≤0.3 mm, model number ST-003C) manufactured by Keycom Corp. was used such that the magnetic permeability can be measured using a network analyzer manufactured by Keysight Technologies at a frequency of 1 to 10 GHz. A short circuit microstrip line jig for a thin film sample (sample size: length 10.0 mm, width 2.0 mm, thickness ≤0.2 mm, model number ST-005EG) manufactured by Keycom Corp. was used such that measurement of some samples can be performed at a frequency of 1 to 20 GHz.

The saturation magnetization (Is) and coercivity (Hcj=magnetic field at M=0 of MH curve) determined from the magnetization curve were measured at a maximum magnetic field of 10 kOe (796 kA/m) using a vibrating sample magnetometer (VSM). In order to calculate the saturation magnetization, the sintered density was separately measured by the Archimedes method according to HS R 1634. The saturation magnetization Is and the coercivity Hcj can be easily calculated because demagnetizing field correction based on the shape of the sample is not necessary.

Electrodes were formed using an InGa alloy on both flat surface positions of a 10 mmφ disk and then the specific resistance was measured with an ohmmeter.

For the dielectric constant, a dielectric constant at 1 GHz was measured using an impedance analyzer manufactured by Keysight Technologies by inserting a 20 mmφ flat and smooth single plate into a 16453A fixture.

The composition, magnetic properties, and the like of the composition formula BaCaₓMg_{y}Co_{z}Fe₂ₘO_{27-δ} are shown in Table 1.

TABLE 1
Composition formula: BaCaₓMg_{y}Co_{z}Fe₂ₘO_{27-δ}

| | | Composition formula | | | | | | | | | | | |
|---|---|---|---|---|---|---|---|---|---|---|---|---|---|
| | | [mol] | | | | Composition ratio | | | | | Composite composition | | |
| | | Ca | Mg | Co | Fe | [mol %] | | | | | amount [mol %] | | |
| No. | | x | y | z | m | Ba | Ca | Mg | Co | Fe | Me(II) | Me(IV) | D |
| 1 | * | 0.00 | 1.80 | 0.20 | 8.00 | 5.3 | 0.0 | 9.5 | 1.1 | 84.2 | 10.5 | 0.0 | 10.5 |
| 2 | * | 0.02 | 1.80 | 0.20 | 8.00 | 5.3 | 0.1 | 9.5 | 1.1 | 84.1 | 10.5 | 0.0 | 10.5 |
| 3 | | 0.03 | 1.80 | 0.20 | 8.00 | 5.3 | 0.2 | 9.5 | 1.1 | 84.1 | 10.5 | 0.0 | 10.5 |
| 4 | | 0.10 | 1.80 | 0.20 | 8.00 | 5.2 | 0.5 | 9.4 | 1.0 | 83.8 | 10.5 | 0.0 | 10.5 |
| 5 | | 0.30 | 1.80 | 0.20 | 8.00 | 5.2 | 1.6 | 9.3 | 1.0 | 82.9 | 10.4 | 0.0 | 10.4 |
| 6 | | 0.50 | 1.80 | 0.20 | 8.00 | 5.1 | 2.6 | 9.2 | 1.0 | 82.1 | 10.3 | 0.0 | 10.3 |
| 7 | | 1.00 | 1.80 | 0.20 | 8.00 | 5.0 | 5.0 | 9.0 | 1.0 | 80.0 | 10.0 | 0.0 | 10.0 |
| 8 | * | 1.20 | 1.80 | 0.20 | 8.00 | 5.0 | 5.9 | 8.9 | 1.0 | 79.2 | 9.9 | 0.0 | 9.9 |
| 9 | | 0.30 | 2.00 | 0.00 | 8.00 | 5.2 | 1.6 | 10.4 | 0.0 | 82.9 | 10.4 | 0.0 | 10.4 |
| 10 | | 0.30 | 1.90 | 0.10 | 8.00 | 5.2 | 1.6 | 9.8 | 0.5 | 82.9 | 10.4 | 0.0 | 10.4 |
| 11 | | 0.30 | 1.80 | 0.20 | 8.00 | 5.2 | 1.6 | 9.3 | 1.0 | 82.9 | 10.4 | 0.0 | 10.4 |
| 12 | | 0.30 | 1.60 | 0.40 | 8.00 | 5.2 | 1.6 | 8.3 | 2.1 | 82.9 | 10.4 | 0.0 | 10.4 |
| 13 | * | 0.30 | 1.50 | 0.50 | 8.00 | 5.2 | 1.6 | 7.8 | 2.6 | 82.9 | 10.4 | 0.0 | 10.4 |
| 14 | * | 0.30 | 0.00 | 2.00 | 8.00 | 5.2 | 1.6 | 0.0 | 10.4 | 82.9 | 10.4 | 0.0 | 10.4 |
| 15 | * | 0.30 | 1.80 | 0.20 | 6.50 | 6.1 | 1.8 | 11.0 | 1.2 | 79.8 | 12.3 | 0.0 | 12.3 |
| 16 | | 0.30 | 1.80 | 0.20 | 7.00 | 5.8 | 1.7 | 10.4 | 1.2 | 80.9 | 11.6 | 0.0 | 11.6 |
| 17 | | 0.30 | 1.80 | 0.20 | 8.00 | 5.2 | 1.6 | 9.3 | 1.0 | 82.9 | 10.4 | 0.0 | 10.4 |
| 18 | | 0.30 | 1.80 | 0.20 | 9.00 | 4.7 | 1.4 | 8.5 | 0.9 | 84.5 | 9.4 | 0.0 | 9.4 |
| 19 | * | 0.30 | 1.80 | 0.20 | 9.50 | 4.5 | 1.3 | 8.1 | 0.9 | 85.2 | 9.0 | 0.0 | 9.0 |

| | | | | Magnetization curve | | | |
|---|---|---|---|---|---|---|---|
| | Magnetic permeability | | | Saturation | | Specific | Dielectric |
| | at 6 GHz μ = μ′ − iμ″ | | | magnetization | Coercivity | resistance | constant |
| | | | tan δ | Is | Hcj | ρ | ε |
| No. | μ′ | μ″ | μ″/μ′ | [mT] | [kA/m] | [Ω · m] | 1 GHz |
| 1 | 1.08 | 0.035 | 0.032 | 258 | 180 | 2 × 10 [symbol] | 10 |
| 2 | 1.20 | 0.094 | 0.078 | 271 | 50 | 1 × 10⁷ | 9 |
| 3 | 1.55 | 0.064 | 0.041 | 276 | 38 | 4 × 10⁷ | 10 |
| 4 | 1.78 | 0.061 | 0.034 | 301 | 31 | 2 × 10⁸ | 10 |
| 5 | 1.88 | 0.050 | 0.027 | 322 | 29 | 2 × 10⁸ | 10 |
| 6 | 1.78 | 0.068 | 0.038 | 318 | 27 | 9 × 10⁷ | 10 |
| 7 | 1.59 | 0.089 | 0.056 | 251 | 38 | 3 × 10⁶ | 18 |
| 8 | 1.18 | 0.129 | 0.109 | 218 | 58 | 8 × 10³ | 39 |
| 9 | 1.63 | 0.083 | 0.051 | 312 | 51 | 2 × 10 [symbol] | 33 |
| 10 | 1.75 | 0.080 | 0.046 | 310 | 40 | 9 × 10⁸ | 25 |
| 11 | 1.88 | 0.050 | 0.027 | 322 | 29 | 2 × 10⁸ | 10 |
| 12 | 2.00 | 0.090 | 0.045 | 342 | 35 | 1 × 10⁸ | 10 |
| 13 | 1.35 | 0.500 | 0.370 | 351 | 70 | 2 × 10 [symbol] | 9 |
| 14 | 2.23 | 0.613 | 0.275 | 281 | 25 | 2 × 10 [symbol] | 9 |
| 15 | 1.49 | 0.100 | 0.067 | 315 | 119 | 1 × 10⁷ | 47 |
| 16 | 1.87 | 0.050 | 0.027 | 319 | 38 | 8 × 10⁷ | 21 |
| 17 | 1.88 | 0.050 | 0.027 | 322 | 29 | 2 × 10⁸ | 10 |
| 18 | 1.68 | 0.070 | 0.042 | 351 | 31 | 3 × 10⁸ | 21 |
| 19 | 1.21 | 0.300 | 0.248 | 383 | 101 | 2 × 10⁵ | 46 |

[symbol]

indicates data missing or illegible when filed

The composition, magnetic properties, and the like of the composition formula BaCaₓMn_{y}Co_{z}Fe₂ₘO_{27-δ} are shown in Table 2.

TABLE 2
Composition formula: BaCaₓMn_{y}Co_{z}Fe₂ₘO_{27-δ}

| | | Composition formula | | | | | | | | | | | |
|---|---|---|---|---|---|---|---|---|---|---|---|---|---|
| | | [mol] | | | | Composition ratio | | | | | Composite composition | | |
| | | Ca | Mg | Co | Fe | [mol %] | | | | | amount [mol %] | | |
| No. | | x | y | z | m | Ba | Ca | Mn | Co | Fe | Me(II) | Me(IV) | D |
| 20 | * | 0.00 | 1.80 | 0.20 | 8.00 | 5.3 | 0.0 | 9.5 | 1.1 | 84.2 | 10.5 | 0.0 | 10.5 |
| 21 | * | 0.02 | 1.80 | 0.20 | 8.00 | 5.3 | 0.1 | 9.5 | 1.1 | 84.1 | 10.5 | 0.0 | 10.5 |
| 22 | | 0.03 | 1.80 | 0.20 | 8.00 | 5.3 | 0.2 | 9.5 | 1.1 | 84.1 | 10.5 | 0.0 | 10.5 |
| 23 | | 0.10 | 1.80 | 0.20 | 8.00 | 5.2 | 0.5 | 9.4 | 1.0 | 83.8 | 10.5 | 0.0 | 10.5 |
| 24 | | 0.30 | 1.80 | 0.20 | 8.00 | 5.2 | 1.6 | 9.3 | 1.0 | 82.9 | 10.4 | 0.0 | 10.4 |
| 25 | | 0.50 | 1.80 | 0.20 | 8.00 | 5.1 | 2.6 | 9.2 | 1.0 | 82.1 | 10.3 | 0.0 | 10.3 |
| 26 | | 1.00 | 1.80 | 0.20 | 8.00 | 5.0 | 5.0 | 9.0 | 1.0 | 80.0 | 10.0 | 0.0 | 10.0 |
| 27 | * | 1.20 | 1.80 | 0.20 | 8.00 | 5.0 | 5.9 | 8.9 | 1.0 | 79.2 | 9.9 | 0.0 | 9.9 |
| 28 | | 0.30 | 2.00 | 0.00 | 8.00 | 5.2 | 1.6 | 10.4 | 0.0 | 82.9 | 10.4 | 0.0 | 10.4 |
| 29 | | 0.30 | 1.90 | 0.10 | 8.00 | 5.2 | 1.6 | 9.8 | 0.5 | 82.9 | 10.4 | 0.0 | 10.4 |
| 30 | | 0.30 | 1.80 | 0.20 | 8.00 | 5.2 | 1.6 | 9.3 | 1.0 | 82.9 | 10.4 | 0.0 | 10.4 |
| 31 | | 0.30 | 1.60 | 0.40 | 8.00 | 5.2 | 1.6 | 8.3 | 2.1 | 82.9 | 10.4 | 0.0 | 10.4 |
| 32 | * | 0.30 | 1.50 | 0.50 | 8.00 | 5.2 | 1.6 | 7.8 | 2.6 | 82.9 | 10.4 | 0.0 | 10.4 |
| 33 | * | 0.30 | 1.80 | 0.20 | 6.50 | 6.1 | 1.8 | 11.0 | 1.2 | 79.8 | 12.3 | 0.0 | 12.3 |
| 34 | | 0.30 | 1.80 | 0.20 | 7.00 | 5.8 | 1.7 | 10.4 | 1.2 | 80.9 | 11.6 | 0.0 | 11.6 |
| 35 | | 0.30 | 1.80 | 0.20 | 8.00 | 5.2 | 1.6 | 9.3 | 1.0 | 82.9 | 10.4 | 0.0 | 10.4 |
| 36 | | 0.30 | 1.80 | 0.20 | 9.00 | 4.7 | 1.4 | 8.5 | 0.9 | 84.5 | 9.4 | 0.0 | 9.4 |
| 37 | * | 0.30 | 1.80 | 0.20 | 9.50 | 4.5 | 1.3 | 8.1 | 0.9 | 85.2 | 9.0 | 0.0 | 9.0 |

| | | | | Magnetization curve | | | |
|---|---|---|---|---|---|---|---|
| | Magnetic permeability | | | Saturation | | Specific | Dielectric |
| | at 6 GHz μ = μ′ − iμ″ | | | magnetization | Coercivity | resistance | constant |
| | | | tan δ | Is | Hcj | ρ | ε |
| No. | μ′ | μ″ | μ″/μ′ | [mT] | [kA/m] | [Ω · m] | 1 GHz |
| 20 | 1.09 | 0.035 | 0.032 | 278 | 180 | 2 × 10⁸ | 10 |
| 21 | 1.20 | 0.094 | 0.078 | 301 | 50 | 1 × 10⁷ | 9 |
| 22 | 1.25 | 0.064 | 0.051 | 315 | 38 | 4 × 10⁷ | 10 |
| 23 | 1.40 | 0.035 | 0.025 | 368 | 28 | 8 × 10⁷ | 10 |
| 24 | 1.62 | 0.006 | 0.004 | 401 | 25 | 2 × 10 [symbol] | 10 |
| 25 | 1.53 | 0.011 | 0.007 | 385 | 27 | 9 × 10⁷ | 10 |
| 26 | 1.39 | 0.052 | 0.037 | 354 | 38 | 3 × 10⁸ | 18 |
| 27 | 1.19 | 0.117 | 0.098 | 257 | 57 | 8 × 10 [symbol] | 39 |
| 28 | 1.20 | 0.001 | 0.001 | 370 | 44 | 2 × 10 [symbol] | 33 |
| 29 | 1.41 | 0.003 | 0.002 | 389 | 30 | 1 × 10 [symbol] | 25 |
| 30 | 1.62 | 0.006 | 0.004 | 401 | 25 | 2 × 10 [symbol] | 10 |
| 31 | 1.21 | 0.067 | 0.055 | 410 | 18 | 1 × 10 [symbol] | 10 |
| 32 | 0.61 | 1.835 | 2.986 | 411 | 15 | 2 × 10 [symbol] | 9 |
| 33 | 1.15 | 0.100 | 0.087 | 400 | 119 | 1 × 10⁷ | 47 |
| 34 | 1.32 | 0.050 | 0.038 | 401 | 38 | 8 × 10⁷ | 21 |
| 35 | 1.62 | 0.006 | 0.004 | 401 | 25 | 2 × 10 [symbol] | 10 |
| 36 | 1.48 | 0.070 | 0.047 | 412 | 31 | 3 × 10 [symbol] | 21 |
| 37 | 1.21 | 0.300 | 0.248 | 425 | 101 | 2 × 10⁵ | 46 |

[symbol]

indicates data missing or illegible when filed

The composition, magnetic properties, and the like of the composition formula BaCaₓNi_{y}Co_{z}Fe₂ₘO_{27-δ} are shown in Table 3.

TABLE 3
Composition formula: BaCaₓNi_{y}Co_{z}Fe₂ₘO_{27-δ}

| | | Composition formula | | | | | | | | | | | |
|---|---|---|---|---|---|---|---|---|---|---|---|---|---|
| | | [mol] | | | | Composition ratio | | | | | Composite composition | | |
| | | Ca | Mg | Co | Fe | [mol %] | | | | | amount [mol %] | | |
| No. | | x | y | z | m | Ba | Ca | Ni | Co | Fe | Me(II) | Me(IV) | D |
| 38 | * | 0.00 | 1.80 | 0.20 | 8.00 | 5.3 | 0.0 | 9.5 | 1.1 | 84.2 | 10.5 | 0.0 | 10.5 |
| 39 | * | 0.02 | 1.80 | 0.20 | 8.00 | 5.3 | 0.1 | 9.5 | 1.1 | 84.1 | 10.5 | 0.0 | 10.5 |
| 40 | | 0.03 | 1.80 | 0.20 | 8.00 | 5.3 | 0.2 | 9.5 | 1.1 | 84.1 | 10.5 | 0.0 | 10.5 |
| 41 | | 0.10 | 1.80 | 0.20 | 8.00 | 5.2 | 0.5 | 9.4 | 1.0 | 83.8 | 10.5 | 0.0 | 10.5 |
| 42 | | 0.30 | 1.80 | 0.20 | 8.00 | 5.2 | 1.6 | 9.3 | 1.0 | 82.9 | 10.4 | 0.0 | 10.4 |
| 43 | | 0.50 | 1.80 | 0.20 | 8.00 | 5.1 | 2.6 | 9.2 | 1.0 | 82.1 | 10.3 | 0.0 | 10.3 |
| 44 | | 1.00 | 1.80 | 0.20 | 8.00 | 5.0 | 5.0 | 9.0 | 1.0 | 80.0 | 10.0 | 0.0 | 10.0 |
| 45 | * | 1.20 | 1.80 | 0.20 | 8.00 | 5.0 | 5.9 | 8.9 | 1.0 | 79.2 | 9.9 | 0.0 | 9.9 |
| 46 | | 0.30 | 2.00 | 0.00 | 8.00 | 5.2 | 1.6 | 10.4 | 0.0 | 82.9 | 10.4 | 0.0 | 10.4 |
| 47 | | 0.30 | 1.90 | 0.10 | 8.00 | 5.2 | 1.6 | 9.8 | 0.5 | 82.9 | 10.4 | 0.0 | 10.4 |
| 48 | | 0.30 | 1.80 | 0.20 | 8.00 | 5.2 | 1.6 | 9.3 | 1.0 | 82.9 | 10.4 | 0.0 | 10.4 |
| 49 | | 0.30 | 1.50 | 0 50 | 8.00 | 5.2 | 1.6 | 7.8 | 2.6 | 82.9 | 10.4 | 0.0 | 10.4 |
| 50 | * | 0.30 | 1.30 | 0.70 | 8.00 | 5.2 | 1.6 | 6.7 | 3.6 | 82.9 | 10.4 | 0.0 | 10.4 |
| 51 | * | 0.30 | 1.80 | 0.20 | 6.50 | 6.1 | 1.8 | 11.0 | 1.2 | 79.8 | 12.3 | 0.0 | 12.3 |
| 52 | | 0.30 | 1.80 | 0.20 | 7.00 | 5.8 | 1.7 | 10.4 | 1.2 | 80.9 | 11.6 | 0.0 | 11.6 |
| 53 | | 0.30 | 1.80 | 0.20 | 8.00 | 5.2 | 1.6 | 9.3 | 1.0 | 82.9 | 10.4 | 0.0 | 10.4 |
| 54 | | 0.30 | 1.80 | 0.20 | 9.00 | 4.7 | 1.4 | 8.5 | 0.9 | 84.5 | 9.4 | 0.0 | 9.4 |
| 55 | * | 0.30 | 1.80 | 0.20 | 9.50 | 4.5 | 1.3 | 8.1 | 0.9 | 85.2 | 9.0 | 0.0 | 9.0 |

| | | | | Magnetization curve | | | |
|---|---|---|---|---|---|---|---|
| | Magnetic permeability | | | Saturation | | Specific | Dielectric |
| | at 6 GHz μ = μ′ − iμ″ | | | magnetization | Coercivity | resistance | constant |
| | | | tan δ | Is | Hcj | ρ | ε |
| No. | μ′ | μ″ | μ″/μ′ | [mT] | [kA/m] | [Ω · m] | 1 GHz |
| 38 | 1.10 | 0.178 | 0.162 | 256 | 180 | 2 × 10 [symbol] | 10 |
| 39 | 1.20 | 0.092 | 0.077 | 271 | 110 | 1 × 10⁷ | 9 |
| 40 | 1.23 | 0.067 | 0.054 | 276 | 99 | 4 × 10⁷ | 10 |
| 41 | 1.33 | 0.055 | 0.041 | 280 | 95 | 8 × 10⁷ | 10 |
| 42 | 1.38 | 0.046 | 0.033 | 297 | 92 | 2 × 10 [symbol] | 10 |
| 43 | 1.29 | 0.059 | 0.046 | 281 | 95 | 9 × 10⁷ | 10 |
| 44 | 1.18 | 0.064 | 0.054 | 201 | 97 | 3 × 10 [symbol] | 18 |
| 45 | 1.09 | 0.112 | 0.103 | 198 | 150 | 8 × 10 [symbol] | 39 |
| 46 | 1.26 | 0.033 | 0.026 | 232 | 110 | 2 × 10 [symbol] | 33 |
| 47 | 1.33 | 0.039 | 0.029 | 265 | 98 | 1 × 10 [symbol] | 25 |
| 48 | 1.38 | 0.046 | 0.033 | 297 | 92 | 2 × 10 [symbol] | 10 |
| 49 | 1.71 | 0.040 | 0.023 | 315 | 55 | 1 × 10 [symbol] | 10 |
| 50 | 1.95 | 0.516 | 0.265 | 278 | 111 | 2 × 10 [symbol] | 9 |
| 51 | 1.09 | 0.100 | 0.092 | 272 | 119 | 1 × 10⁷ | 47 |
| 52 | 1.29 | 0.057 | 0.044 | 284 | 95 | 8 × 10⁷ | 19 |
| 53 | 1.38 | 0.046 | 0.033 | 297 | 92 | 2 × 10 [symbol] | 10 |
| 54 | 1.28 | 0.069 | 0.054 | 303 | 94 | 3 × 10 [symbol] | 20 |
| 55 | 1.09 | 0.305 | 0.280 | 312 | 101 | 2 × 10⁵ | 46 |

[symbol]

indicates data missing or illegible when filed

The composition, magnetic properties, and the like of the composition formula BaCaₓZn_{y}Co_{z}Fe₂ₘO_{27-δ} are shown in Table 4.

TABLE 4
Composition formula: BaCa [symbol] Zn_{y}Co_{z}Fe₂ₘO₂₇₋

[symbol]

| | | Composition formula | | | | | | | | | | | |
|---|---|---|---|---|---|---|---|---|---|---|---|---|---|
| | | [mol] | | | | Composition ratio | | | | | Composite composition | | |
| | | Ca | Zn | Co | Fe | [mol %] | | | | | amount [mol %] | | |
| No. | | x | y | z | m | Ba | Ca | Zn | Co | Fe | Me(II) | Me(IV) | D |
| 56 | * | 0.00 | 1.80 | 0.20 | 8.00 | 5.3 | 0.0 | 9.5 | 1.1 | 84.2 | 10.5 | 0.0 | 10.5 |
| 57 | * | 0.02 | 1.80 | 0.20 | 8.00 | 5.3 | 0.1 | 9.5 | 1.1 | 84.1 | 10.5 | 0.0 | 10.5 |
| 58 | | 0.03 | 1.80 | 0.20 | 8.00 | 5.3 | 0.2 | 9.5 | 1.1 | 84.1 | 10.5 | 0.0 | 10.5 |
| 59 | | 0.10 | 1.80 | 0.20 | 8.00 | 5.2 | 0.5 | 9.4 | 1.0 | 83. [symbol] | 10.5 | 0.0 | 10.5 |
| 60 | | 0.30 | 1.80 | 0.20 | 8.00 | 5.2 | 1.6 | 9.3 | 1.0 | 82.9 | 10.4 | 0.0 | 10.4 |
| 61 | | 0.50 | 1.80 | 0.20 | 8.00 | 5.1 | 2.6 | 9.2 | 1.0 | 82.1 | 10.3 | 0.0 | 10.3 |
| 62 | | 1.00 | 1.80 | 0.20 | 8.00 | 5.0 | 5.0 | 9.0 | 1.0 | 80.0 | 10.0 | 0.0 | 10.0 |
| 63 | * | 1.20 | 1.80 | 0.20 | 8.00 | 5.0 | 5.9 | 8.9 | 1.0 | 79.2 | 9.9 | 0.0 | 9.9 |
| 64 | | 0.30 | 2.00 | 0.00 | 8.00 | 5.2 | 1.6 | 10.4 | 0.0 | 82.9 | 10.4 | 0.0 | 10.4 |
| 65 | | 0.30 | 1.90 | 0.10 | 8.00 | 5.2 | 1.6 | 9.8 | 0.5 | 82.9 | 10.4 | 0.0 | 10.4 |
| 66 | | 0.30 | 1.80 | 0.20 | 8.00 | 5.2 | 1.6 | 9.3 | 1.0 | 82.9 | 10.4 | 0.0 | 10.4 |
| 67 | | 0.30 | 1.60 | 0.40 | 8.00 | 5.2 | 1.6 | 8.3 | 2.1 | 82.9 | 10.4 | 0.0 | 10.4 |
| 68 | * | 0.30 | 1.50 | 0.50 | 8.00 | 5.2 | 1.6 | 7.8 | 2.6 | 82.9 | 10.4 | 0.0 | 10.4 |
| 69 | * | 0.30 | 1.80 | 0.20 | 6.50 | 6.1 | 1.8 | 11.0 | 1.2 | 79.8 | 12.3 | 0.0 | 12.3 |
| 70 | | 0.30 | 1.80 | 0.20 | 7.00 | 5.8 | 1.7 | 10.4 | 1.2 | 80.9 | 11.6 | 0.0 | 11.6 |
| 71 | | 0.30 | 1.80 | 0.20 | 8.00 | 5.2 | 1.6 | 9.3 | 1.0 | 82.9 | 10.4 | 0.0 | 10.4 |
| 72 | | 0.30 | 1.80 | 0.20 | 9.00 | 4.7 | 1.4 | 8.5 | 0.9 | 84.5 | 9.4 | 0.0 | 9.4 |
| 73 | * | 0.30 | 1.80 | 0.20 | 9.50 | 4.5 | 1.3 | 8.1 | 0.9 | 85.2 | 9.0 | 0.0 | 9.0 |

| | | | | Magnetization curve | | | |
|---|---|---|---|---|---|---|---|
| | Magnetic permeability | | | Saturation | | Specific | Dielectric |
| | at 6 GHz μ = μ′ − iμ″ | | | magnetization | Coercivity | resistance | constant |
| | | | tan δ | Is | Hcj | ρ | ε |
| No. | μ′ | μ″ | μ″/μ′ | [mT] | [kA/m] | [Ω · m] | 1 GHz |
| 56 | 1.08 | 0.235 | 0.218 | 359 | 181 | 2 × 10⁸ | 10 |
| 57 | 1.18 | 0.104 | 0.088 | 371 | 86 | 1 × 10⁷ | 9 |
| 58 | 1.21 | 0.064 | 0.053 | 377 | 71 | 4 × 10⁷ | 10 |
| 59 | 1.38 | 0.024 | 0.017 | 387 | 58 | 8 × 10⁷ | 10 |
| 60 | 1.45 | 0.013 | 0.009 | 404 | 41 | 2 × 10 [symbol] | 10 |
| 61 | 1.39 | 0.022 | 0.016 | 389 | 45 | 9 × 10⁷ | 10 |
| 62 | 1.27 | 0.058 | 0.046 | 357 | 58 | 3 × 10⁸ | 18 |
| 63 | 1.08 | 0.112 | 0.104 | 263 | 101 | 8 × 10 [symbol] | 39 |
| 64 | 1.27 | 0.012 | 0.010 | 383 | 69 | 2 × 10⁸ | 33 |
| 65 | 1.35 | 0.014 | 0.010 | 394 | 55 | 1 × 10 [symbol] | 25 |
| 66 | 1.45 | 0.013 | 0.009 | 404 | 41 | 2 × 10 [symbol] | 10 |
| 67 | 2.12 | 0.092 | 0.043 | 415 | 25 | 1 × 10 [symbol] | 10 |
| 68 | 3.07 | 0.300 | 0.098 | 437 | 17 | 2 × 10 [symbol] | 9 |
| 69 | 1.09 | 0.156 | 0.143 | 361 | 118 | 1 × 10⁷ | 47 |
| 70 | 1.34 | 0.047 | 0.035 | 401 | 45 | 8 × 10⁷ | 21 |
| 71 | 1.45 | 0.013 | 0.009 | 404 | 41 | 2 × 10 [symbol] | 10 |
| 72 | 1.37 | 0.068 | 0.050 | 412 | 55 | 3 × 10 [symbol] | 21 |
| 73 | 1.31 | 0.246 | 0.188 | 426 | 101 | 2 × 10 [symbol] | 46 |

[symbol]

indicates data missing or illegible when filed

For example, Nos. 5, 11, and 17 in Table 1, Nos. 24, 30, and 35 in Table 2, Nos. 42, 48, and 53 in Table 3, or Nos. 60, 66, and 71 in Table 4 have the same composition and thus have the same properties. In Tables 1 to 4, those marked with * are comparative examples outside the scope of the present invention. The same applies to the following table.

As seen from Tables 1 to 4, by setting the Me site to Mg, Mn, Ni, Zn, or the like, the magnetic loss tan δ can be significantly reduced to 0.06 or less in a state where the magnetic permeability μ′ at 6 GHz is increased to 1.1 or more.

The frequency characteristics of the magnetic permeability μ in the composition formula BaCa_{0.3}Me₂Fe₁₆O₂₇ (Me=Co, Mg, or Mn) are shown in FIG. 9, and the frequency characteristics of the magnetic loss tan δ in the composition formula BaCa_{0.3}Me₂Fe₁₆O₂₇ (Me=Co, Mg, or Mn) are shown in FIG. 10.

In FIGS. 9 and 10, the case where Me=Co is No. 14 in Table 1, Me=Mg is No. 9 in Table 1, and Me=Mn is No. 28 in Table 2.

As seen from FIG. 9, at a frequency of 1 GHz or more, the magnetic permeability p: is the highest when Me=Co, but the magnetic loss component increases as the frequency increases when Me=Co. As seen from FIG. 10, at a frequency of 1 GHz, the magnetic loss tan δ is the lowest when Me=Co, but at a high frequency such as 6 GHz, the magnetic loss tan δ is lower when Me=Mg or Mn.

The frequency characteristics of the magnetic permeability μ in the composition formula BaCa_{0.3}Me₂Fe₁₆O₂₇ (Me=Co, Ni, or Zn) are shown in FIG. 11, and the frequency characteristics of the magnetic loss tan δ in the composition formula BaCa_{0.3}Me₂Fe₁₆O₂₇ (Me=Co, Ni, or Zn) are shown in FIG. 12.

In FIGS. 11 and 12, the case where Me=Co is No. 14 in Table 1, Me=Ni is No. 46 in Table 3, and Me=Zn is No. 64 in Table 1.

As seen from FIG. 11, when Me=Co, the magnetic permeability μ′ is the highest. When Me=Ni or Zn, the magnetic permeability μ′ is as low as about 1.2, but the magnetic loss component is also low. As seen from FIG. 12, at a frequency of 1 GHz, the magnetic loss tan δ is the lowest when Me=Co, but at a high frequency such as 6 GHz, the magnetic loss tan δ is lower when Me=Ni or Zn.

As shown in FIG. 4, the W-type ferrite phase can be detected regardless of the presence or absence of the addition of Ca, but an M-type ferrite and a Y-type ferrite phases are also observed without the addition of Ca. Thus, the proportion of the W-type ferrite phase can be increased by the addition of Ca. Further, as seen from Tables 1 to 4, the magnetic permeability is as low as μ′<1.10 when Ca is not added, but the magnetic permeability can be increased to μ′≥1.10 by adding Ca.

The frequency characteristics of the magnetic permeability μ in the composition formula BaCaₓMn_{1.8}Co_{0.2}Fe₁₆O₂₇ (x=0 or 0.3) are shown in FIG. 13, and the frequency characteristics of the magnetic loss tan δ in the composition formula BaCaₓMn_{1.8}Co_{0.2}Fe₁₆O₂₇ (x=0 or 0.3) are shown in FIG. 14.

In FIGS. 13 and 14, the case where x=0 is No. 20 in Table 2, and x=0.3 is No. 24 in Table 2.

As seen from FIG. 13, the magnetic permeability μ′ at 2 GHz or more can be increased by the addition of Ca. As seen from FIG. 14, it is possible to suppress the magnetic loss at 3 GHz or more to tan δ≤0.01 regardless of the Ca amount.

In addition, by partial substitution with Co, the magnetic permeability can be increased from 1.63 to 2.12 at the maximum.

The frequency characteristics of the magnetic permeability μ in the composition formula BaCa_{0.3}Mn₂₋ₓCoₓFe₁₆O₂₇ (x=0, 0.2, or 0.5) are shown in FIG. 15, and the frequency characteristics of the magnetic loss tan δ in the composition formula BaCa_{0.3}Mn₂₋ₓCoₓFe₁₆O₂₇ (x=0, 0.2, or 0.5) are shown in FIG. 16.

In FIGS. 15 and 16, the case where x=0 is No. 28 in Table 2, x=0.2 is No. 30 in Table 2, and x=0.5 is No. 32 in Table 2.

As seen from FIG. 15, when the amount of Co is increased from x=0 mol to x=0.2 mol, the magnetic permeability can be increased due to the enhanced soft magnetic property, but when the amount of Co is excessively increased to x=0.5 mol, the magnetic loss component of the magnetic permeability is also increased.

As seen from FIG. 16, when the Co amount is x=0 mol and x=0.2 mol, the magnetic loss at 3 GHz or more can be suppressed to tan δ≤0.01, but when the Co amount is x=0.5 mol, the magnetic loss at 0.5 GHz or more is as high as tan δ>0.30.

The frequency characteristics of the magnetic permeability μ in the composition formula BaCa_{0.3}Ni₂₋ₓCoₓFe₁₆O₂₇ (x=0, 0.2, or 0.5) are shown in FIG. 17, and the frequency characteristics of the magnetic loss tan δ in the composition formula BaCa_{0.3}Ni₂₋ₓCoₓFe₁₆O₂₇ (x=0, 0.2, or 0.5) are shown in FIG. 18.

In FIGS. 17 and 18, the case where x=0 is No. 46 in Table 3, x=0.2 is No. 48 in Table 3, and x=0.5 is No. 49 in Table 3.

As seen from FIG. 17, when the amount of Co is increased, the magnetic permeability can be slightly increased due to the enhanced soft magnetic property.

As seen from FIG. 18, regardless of the Co amount, the magnetic loss tan δ can be suppressed to 0.06 or less up to 10 GHz.

The frequency characteristics of the magnetic permeability μ in the composition formula BaCa_{0.3}Zn₂₋ₓCoₓFe₁₆O₂₇ (x=0, 0.2, or 0.5) are shown in FIG. 19, and the frequency characteristics of the magnetic loss tan δ in the composition formula BaCa_{0.3}Zn₂₋ₓCoₓFe₁₆O₂₇ (x=0, 0.2, or 0.5) are shown in FIG. 20.

In FIGS. 19 and 20, the case where x=0 is No. 64 in Table 4, x=0.2 is No. 66 in Table 4, and x=0.5 is No. 68 in Table 4.

As seen from FIG. 19, when the amount of Co was increased, the magnetic permeability could be increased due to the enhanced soft magnetic property, but when the amount of Co was excessively increased to x=0.5 mol, the magnetic loss component of the magnetic permeability was also increased.

As seen from FIG. 20, when the Co amount is x=0 mol and x=0.2 mol, the magnetic loss tan δ at 3 GHz or more can be suppressed to 0.06 or less, but when the Co amount is x=0.5 mol, the magnetic loss tan δ at 1 GHz or more is as high as 0.06 or more.

### Example 2

The composition formula of each powder material was set to ACa_{0.3}(Co_{0.2}M_{ii1.8})(Fe_{2m-a-b-c-d-e}LiₐM_{iib}M_{iiic}M_{ivd}Mᵥₑ)O_{27-δ}.

Oxides, hydroxides, or carbonates having metal ions of A, Ca, Co, Fe, Mᵢᵢ, Mᵢᵢᵢ, Mᵢᵥ, and Mᵥ were blended at a predetermined ratio shown in Tables 5 to 21 such that the total amount of the materials was 120 g. Note that A is an element that does not enter the Fe site but enters the A site due to a large ionic radius, and A=Ba, Sr, Bi, Na, K, or La; Mᵢᵢ is a divalent metal ion, and Mᵢᵢ=Co, Cu, Mg, Mn, Ni, or Zn; Mᵢᵢᵢ is a trivalent metal ion, and Mᵢᵢᵢ=Al, Ga, In, or Sc; Mᵢᵥ is a tetravalent metal ion, and Mᵢᵥ=Hf, Si, Sn, Ti, or Zr; and Mᵥ is a pentavalent or higher metal ion, and Mᵥ=Mo, Nb, Ta, Sb, W, or V. A mixed and dried powder, a sized powder, and a calcined powder were synthesized in the same manner as in Example 1, and the calcined powder was pulverized, then a molded sheet was produced, and a sintered body was obtained. The measurement was performed in the same manner as in Example 1.

The composition, magnetic properties, and the like of the composition formulas (Ba₁₋ₓSrₓ)Ca_{0.3}Me_{1.8}Co_{0.2}Fe₁₆O_{27-δ} and (Ba₁₋ₓBiₓ)Ca_{0.3}Me_{1.8+x}Co_{0.2}Fe₁₆₋ₓO_{27-δ} are shown in Table 5.

TABLE 5
Composition formulas: (Ba [symbol] Sr [symbol] )C [symbol] Me [symbol] Co [symbol] Fe [symbol] O [symbol] and (Ba [symbol] Bi [symbol] Ca [symbol] M [symbol] Co [symbol] Fe [symbol] O

[symbol]

| | | Composition | | | | | | | | | | | | | | | | | |
|---|---|---|---|---|---|---|---|---|---|---|---|---|---|---|---|---|---|---|---|
| | | formula [mol] | | | Me element | | | | Composition ratio | | | | | | | | | | Composite composition |
| | | Ba | Bi | Sr | [mol] | | | | [mol %] | | | | | | | | | | amount [mol %] |
| No. | | [symbol] | x | [symbol] | Mg | Mn | Ni | Zn | Ba | Bi | Sr | Ca | Mg | Mn | Ni | Zn | Co | Fe | Ba [symbol] Sr |
| 74 | | 1.0 | 0.0 | 0.0 | 1.8 | 0.0 | 0.0 | 0.0 | 5.2 | 0.0 | 0.0 | 1.6 | [symbol] .3 | 0.0 | 0.0 | 0.0 | 1.0 | [symbol] 2.9 | 5.2 |
| 75 | | 0. [symbol] | 0.0 | 0.5 | 1.8 | 0.0 | 0.0 | 0.0 | 2.6 | 0.0 | 2.6 | 1.6 | [symbol] .3 | 0.0 | 0.0 | 0.0 | 1.0 | 82.9 | 5.2 |
| 7 [symbol] | | 0.0 | 0.0 | 1.0 | 1.8 | 0.0 | 0.0 | 0.0 | 0.0 | 0.0 | 5.2 | 1. [symbol] | 9.3 | 0.0 | 0.0 | 0.0 | 1.0 | 82.9 | 5.2 |
| 77 | | 0.8 | 0.2 | 0.0 | 2.0 | 0.0 | 0.0 | 0.0 | 4.1 | 1.0 | 0.0 | 1. [symbol] | 10.4 | 0.0 | 0.0 | 0.0 | 1.0 | 81.9 | 4.1 |
| 78 | * | 0.5 | 0.5 | 0.0 | 2.3 | 0.0 | 0.0 | 0.0 | 2.6 | 2.6 | 0.0 | 1.6 | 11.9 | 0.0 | 0.0 | 0.0 | 1.0 | [symbol] 0.3 | 2. [symbol] |
| 79 | | 1.0 | 0.0 | 0.0 | 0.0 | 1.8 | 0.0 | 0.0 | 5.2 | 0.0 | 0.0 | 1. [symbol] | 0.0 | [symbol] .3 | 0.0 | 0.0 | 1.0 | 82.9 | 5.2 |
| 80 | | 0.5 | 0.0 | 0. [symbol] | 0.0 | 1.8 | 0.0 | 0.0 | 2.6 | 0.0 | 2.6 | 1. [symbol] | 0.0 | 9.3 | 0.0 | 0.0 | 1.0 | 82.9 | 5.2 |
| 81 | | 0.0 | 0.0 | 1.0 | 0.0 | 1.8 | 0.0 | 0.0 | 0.0 | 0.0 | 5.2 | 1. [symbol] | 0.0 | [symbol] .3 | 0.0 | 0.0 | 1.0 | 82.9 | 5.2 |
| 82 | | 0. [symbol] | 0.2 | 0.0 | 0.0 | 2.0 | 0.0 | 0.0 | 4.1 | 1.0 | 0.0 | 1. [symbol] | 0.0 | 10.4 | 0.0 | 0.0 | 1.0 | [symbol] 1.9 | 4.1 |
| 83 | * | 0.5 | 0.5 | 0.0 | 0.0 | 2.3 | 0.0 | 0.0 | 2.6 | 2.6 | 0.0 | 1. [symbol] | 0.0 | 11.3 | 0.0 | 0.0 | 1.0 | 80.3 | 2.6 |
| 84 | | 1.0 | 0.0 | 0.0 | 0.0 | 0.0 | 1.8 | 0.0 | 5.2 | 0.0 | 0.0 | 1.6 | 0.0 | 0.0 | 9.3 | 0.0 | 1.0 | 82.9 | 5.2 |
| 85 | | 0. [symbol] | 0.0 | 0.5 | 0.0 | 0.0 | 1.8 | 0.0 | 2.6 | 0.0 | 2.6 | 1. [symbol] | 0.0 | 0.0 | 9.3 | 0.0 | 1.0 | 82.9 | 5.2 |
| 86 | | 0.0 | 0.0 | 1.0 | 0.0 | 0.0 | 1.8 | 0.0 | 0.0 | 0.0 | 5.2 | 1. [symbol] | 0.0 | 0.0 | [symbol] .3 | 0.0 | 1.0 | 82.9 | 5.2 |
| 87 | | 0.8 | 0.2 | 0.0 | 0.0 | 0.0 | 2.0 | 0.0 | 4.1 | 1.0 | 0.0 | 1. [symbol] | 0.0 | 0.0 | 10.4 | 0.0 | 1.0 | 81.9 | 4.1 |
| 88 | * | 0.5 | 0.5 | 0.0 | 0.0 | 0.0 | 2.3 | 0.0 | 2. [symbol] | 2.6 | 0.0 | 1. [symbol] | 0.0 | 0.0 | 11. [symbol] | 0.0 | 1.0 | 80.3 | 2. [symbol] |
| 89 | | 1.0 | 0.0 | 0.0 | 0.0 | 0.0 | 0.0 | 1. [symbol] | 5.2 | 0.0 | 0.0 | 1. [symbol] | 0.0 | 0.0 | 0.0 | 9.3 | 1.0 | 82.9 | 5.2 |
| 90 | | 0.5 | 0.0 | 0.5 | 0.0 | 0.0 | 0.0 | 1.8 | 2. [symbol] | 0.0 | 2.6 | 1. [symbol] | 0.0 | 0.0 | 0.0 | 9.3 | 1.0 | 82.9 | 5.2 |
| 91 | | 0.0 | 0.0 | 1.0 | 0.0 | 0.0 | 0.0 | 1.8 | 0.0 | 0.0 | [symbol] .2 | 1. [symbol] | 0.0 | 0.0 | 0.0 | 9.3 | 1.0 | 82.9 | 5.2 |
| 92 | | 0.8 | 0.2 | 0.0 | 2.0 | 0.0 | 0.0 | 0.0 | 4.1 | 1.0 | 0.0 | 1. [symbol] | 10.4 | 0.0 | 0.0 | 0.0 | 1.0 | 81.9 | 4.1 |
| 93 | * | 0. [symbol] | 0. [symbol] | 0.0 | 2.3 | 0.0 | 0.0 | 0.0 | 2.6 | 2.6 | 0.0 | 1. [symbol] | 11.0 | 0.0 | 0.0 | 0.0 | 1.0 | 80.3 | 2.6 |

| | | | | | | | Magnetization curve | | | |
|---|---|---|---|---|---|---|---|---|---|---|
| | | | | Magnetic permeability | | | Saturation | | Specific | Dielectric |
| | Composite composition | | | at 6 GHz μ = μ′ − iμ″ | | | magnetization | Coercivity | resistance | constant |
| | amaount [mol %] | | | | | tan δ | Is | Hcj | ρ | ε |
| No. | Me(II) | Me(IV) | D | μ′ | μ″ | μ″/μ′ | [mT] | [kA/m] | [Ω · m] | 1 GHz |
| 74 | 10.4 | 0.0 | 10.4 | 1.8 [symbol] | 0.050 | 0.027 | 322 | 2 [symbol] | 2 × 10 [symbol] | 10 |
| 75 | 10.4 | 0.0 | 10.4 | 1. [symbol] 7 | 0.072 | 0.039 | 321 | 2 [symbol] | 8 × 10 [symbol] | 81 |
| 7 [symbol] | 10.4 | 0.0 | 10.4 | 1.8 [symbol] | 0.0 [symbol] 3 | 0.049 | 31 [symbol] | 23 | 5 × 10 [symbol] | 33 |
| 77 | 11.4 | 0.0 | 11.4 | 1.81 | 0.0 [symbol] 7 | 0.0 [symbol] 7 | 307 | 2 [symbol] | 2 × 10 [symbol] | 10 |
| 78 | 13.0 | 0.0 | 13.0 | 1.2 [symbol] | 0.549 | 0.42 [symbol] | 238 | 15 [symbol] | 2 × 10 [symbol] | [symbol] 9 |
| 79 | 10.4 | 0.0 | 10.4 | 1.62 | 0.008 | 0.004 | 401 | 25 | 2 × 10 [symbol] | 10 |
| 80 | 10.4 | 0.0 | 10.4 | 1.62 | 0.010 | 0.006 | 395 | 2 [symbol] | 8 × 10 [symbol] | [symbol] 0 |
| 81 | 10.4 | 0.0 | 10.4 | 1.62 | 0.012 | 0.007 | 387 | 33 | 5 × 10 [symbol] | 31 |
| 82 | 11.4 | 0.0 | 11.4 | 1.60 | 0.009 | 0.005 | 390 | 2 [symbol] | 2 × 10 [symbol] | 10 |
| 83 | 1 [symbol] . [symbol] | 0.0 | 13.0 | 1.19 | 0.159 | 0.134 | 322 | 101 | 2 × 10 [symbol] | 91 |
| 84 | 10.4 | 0.0 | 10.4 | 1.3 [symbol] | 0.046 | 0.033 | 297 | [symbol] 2 | 2 × 10 [symbol] | 10 |
| 85 | 10.4 | 0.0 | 10.4 | 1.39 | 0.051 | 0.037 | 290 | 84 | 8 × 10 [symbol] | [symbol] 5 |
| 86 | 10.4 | 0.0 | 10.4 | 1.36 | 0.078 | 0.057 | 284 | 87 | 5 × 10 [symbol] | 32 |
| 87 | 11.4 | 0.0 | 11.4 | 1.29 | 0.0 [symbol] 3 | 0.049 | 287 | 9 [symbol] | 2 × 10 [symbol] | 10 |
| 88 | 13.0 | 0.0 | 13.0 | 1.0 [symbol] | 0.124 | 0.115 | 201 | 215 | 2 × 10 [symbol] | 72 |
| 89 | 10.4 | 0.0 | 10.4 | 1.45 | 0.013 | 0.009 | 404 | 41 | 2 × 10 [symbol] | 10 |
| 90 | 10.4 | 0.0 | 10.4 | 1.44 | 0.010 | 0.013 | 398 | 44 | [symbol] × 10 [symbol] | 74 |
| 91 | 10.4 | 0.0 | 10.4 | 1.44 | 0.020 | 0.018 | 391 | 47 | 5 × 10 [symbol] | 33 |
| 92 | 11.4 | 0.0 | 11.4 | 1.35 | 0.072 | 0.053 | 387 | 49 | 2 × 10 [symbol] | 10 |
| 93 | 13.0 | 0.0 | 13.0 | 1.07 | 0.138 | 0.130 | 312 | 109 | 2 × 10 [symbol] | 75 |

[symbol]

indicates data missing or illegible when filed

The composition, magnetic properties, and the like of the composition formula BaCa_{0.3}CuₓMe_{1.8-x}Co_{0.2}Fe₁₆O_{27-δ} are shown in Table 6.

TABLE 6
Composition formula: BaCa [symbol] Cu [symbol] Me [symbol] Co [symbol] Fe [symbol] O

[symbol]

| | | Composition | Me element | | | | | | | | | | | | |
|---|---|---|---|---|---|---|---|---|---|---|---|---|---|---|---|
| | | [mol] | [mol] | | | | Composition ratio | | | | | | | | |
| | | Cu | Mg | Mn | Ni | Zn | [mol %] | | | | | | | | |
| No. | | x | 1.8-x | 1.8-x | 1.8-x | 1.8-x | Ba | Ca | Cu | Mg | Mn | Ni | Z [symbol] | Co | Fe |
| 94 | | 0.00 | 1.80 | 0.00 | 0.00 | 0.00 | 5.2 | 1.6 | 0.0 | 9.3 | 0.0 | 0.0 | 0.0 | 1.0 | 82.9 |
| 95 | | 0.30 | 1.50 | 0.00 | 0.00 | 0.00 | 5.2 | 1.6 | 1.6 | 7.8 | 0.0 | 0.0 | 0.0 | 1.0 | 82.9 |
| 96 | * | 0.50 | 1.30 | 0.00 | 0.00 | 0.00 | 5.2 | 1.6 | 2.6 | 6.7 | 0.0 | 0.0 | 0.0 | 1.0 | 82.9 |
| 97 | * | 1.80 | 0.00 | 0.00 | 0.00 | 0.00 | 5.2 | 1.6 | 9.3 | 0.0 | 0.0 | 0.0 | 0.0 | 1.0 | 82.9 |
| 98 | | 0.00 | 0.00 | 1.80 | 0.00 | 0.00 | 5.2 | 1.6 | 0.0 | 0.0 | 6.3 | 0.0 | 0.0 | 1.0 | 82.9 |
| 99 | | 0.30 | 0.00 | 1.50 | 0.00 | 0.00 | 5.2 | 1.6 | 1.6 | 0.0 | 7.8 | 0.0 | 0.0 | 1.0 | 82.9 |
| 100 | * | 0.50 | 0.00 | 1.30 | 0.00 | 0.00 | 5.2 | 1.6 | 2.6 | 0.0 | 6.7 | 0.0 | 0.0 | 1.0 | 82.9 |
| 101 | | 0.00 | 0.00 | 0.00 | 1.80 | 0.00 | 5.2 | 1.6 | 0.0 | 0.0 | 0.0 | 9.3 | 0.0 | 1.0 | 82.9 |
| 102 | | 0.30 | 0.00 | 0.00 | 1.50 | 0.00 | 5.2 | 1.6 | 1. [symbol] | 0.0 | 0.0 | 7.8 | 0.0 | 1.0 | 82.9 |
| 103 | * | 0.50 | 0.00 | 0.00 | 1.30 | 0.00 | 5.2 | 1.6 | 2.6 | 0.0 | 0.0 | [symbol] .7 | 0.0 | 1.0 | 82.9 |
| 104 | | 0.00 | 0.00 | 0.00 | 0.00 | 1.80 | 5.2 | 1.6 | 0.0 | 0.0 | 0.0 | 0.0 | 9.3 | 1.0 | 82.9 |
| 105 | | 0.30 | 0.00 | 0.00 | 0.00 | 1. [symbol] 0 | 5.2 | 1.6 | 1.6 | 0.0 | 0.0 | 0.0 | 7.8 | 1.0 | 82.9 |
| 106 | * | 0.50 | 0.00 | 0.00 | 0.00 | 1.30 | 5.2 | 1.6 | 2.6 | 0.0 | 0.0 | 0.0 | [symbol] .7 | 1.0 | 82.9 |

| | | | | Magnetic | | | | | | |
|---|---|---|---|---|---|---|---|---|---|---|
| | | | | permeability | | | | | | |
| | | | | at 6 GHz μ = | | | Magnetization curve | | | |
| | | | | μ′ − iμ″ | | | Saturation | | | |
| | | | | | | tan | magne- | Coer- | Specific | Dielectric |
| | Composite composition | | | | | δ | tization | civity | resistance | constant |
| | amount [mol %] | | | | | μ″/ | Is | Hcj | ρ | ε |
| No. | Me(II) | Me(IV) | D | μ′ | μ″ | μ′ | [mT] | [kA/m] | [Ω · m] | 1 GHz |
| 94 | 10.4 | 0.0 | 10.4 | 1.88 | 0.050 | 0.027 | 322 | 29 | 2 × 10⁸ | 10 |
| 95 | 10.4 | 0.0 | 10.4 | 1.49 | 0.042 | 0.028 | 301 | 34 | 8 × 10⁷ | 15 |
| 96 | 10.4 | 0.0 | 10.4 | 1.09 | 0.109 | 0.100 | 252 | 115 | 5 × 10⁷ | 79 |
| 97 | 10.4 | 0.0 | 10.4 | 0.98 | 1.0 [symbol] 0 | 1.112 | 201 | 210 | 5 × 10⁴ | 151 |
| 98 | 10.4 | 0.0 | 10.4 | 1.62 | 0.006 | 0.004 | 401 | 25 | 2 × 10⁸ | 10 |
| 99 | 10.4 | 0.0 | 10.4 | 1.37 | 0.002 | 0.001 | 3 [symbol] 4 | 30 | 8 × 10⁷ | 15 |
| 100 | 10.4 | 0.0 | 10.4 | 1.08 | 0.128 | 0.119 | 301 | 121 | 5 × 10⁷ | 84 |
| 101 | 10.4 | 0.0 | 10.4 | 1.38 | 0.046 | 0.033 | 297 | 92 | 2 × 10 [symbol] | 10 |
| 102 | 10.4 | 0.0 | 10.4 | 1.26 | 0.038 | 0.030 | 290 | 95 | 8 × 10⁷ | 15 |
| 103 | 10.4 | 0.0 | 10.4 | 1.05 | 0.214 | 0.204 | 251 | 251 | 5 × 10⁷ | 74 |
| 104 | 10.4 | 0.0 | 10.4 | 1.45 | 0.013 | 0.00 [symbol] | 404 | 41 | 2 × 10 [symbol] | 10 |
| 105 | 10.4 | 0.0 | 10.4 | 1.34 | 0.009 | 0.007 | 388 | 49 | 8 × 10⁷ | 15 |
| 106 | 10.4 | 0.0 | 10.4 | 1.06 | 0.099 | 0.093 | 312 | 315 | 5 × 10⁷ | 71 |

[symbol]

indicates data missing or illegible when filed

The composition, magnetic properties, and the like of the composition formula BaCa_{0.3}NiₓMe_{1.8-x}Co_{0.2}Fe₁₆O_{27-δ} are shown in Table 7.

TABLE 7
Composition formula: BaCa_{0.3}Ni [symbol] Me_{1.2-x}Co_{0.2}Fe [symbol] O₂₇₋

[symbol]

| | Composition | Me element | | | | | | | | | | | | |
|---|---|---|---|---|---|---|---|---|---|---|---|---|---|---|
| | formula [mol] | [mol] | | | Composition ratio | | | | | | | | Composite composition | |
| | Ni | Mg | Mn | Zn | [mol %] | | | | | | | | amount [mol %] | |
| No. | x | 1.8-x | 1.8-x | 1.8-x | Ba | Ca | Mg | Mn | Ni | Zn | Co | Fe | Me(II) | Me(IV) |
| 107 | 1.80 | 0.00 | 0.00 | 0.00 | 5.2 | 1.6 | 0.0 | 0.0 | 9.3 | 0.0 | 1.0 | 82.9 | 10.4 | 0.0 |
| 108 | 0.90 | 0.90 | 0.00 | 0.00 | 5.2 | 1.6 | 4.7 | 0.0 | 4.7 | 0.0 | 1.0 | 82.9 | 10.4 | 0.0 |
| 109 | 0.00 | 1.80 | 0.00 | 0.00 | 5.2 | 1.6 | 9.3 | 0.0 | 0.0 | 0.0 | 1.0 | 82.9 | 10.4 | 0.0 |
| 110 | 0.90 | 0.00 | 0.90 | 0.00 | 5.2 | 1.6 | 0.0 | 4.7 | 4.7 | 0.0 | 1.0 | 82.9 | 10.4 | 0.0 |
| 111 | 0.00 | 0.00 | 1.80 | 0.00 | 5.2 | 1.6 | 0.0 | 9.3 | 0.0 | 0.0 | 1.0 | 82.9 | 10.4 | 0.0 |
| 112 | 0.90 | 0.00 | 0.00 | 0.90 | 5.2 | 1.6 | 0.0 | 0.0 | 4.7 | 4.7 | 1.0 | 82.9 | 10.4 | 0.0 |
| 113 | 0.00 | 0.00 | 0.00 | 1.80 | 5.2 | 1.6 | 0.0 | 0.0 | 0.0 | 9.3 | 1.0 | 82.9 | 10.4 | 0.0 |

| | | | | | Magnetization curve | | | |
|---|---|---|---|---|---|---|---|---|
| | | Magnetic permeability | | | Saturation | | Specific | Dielectric |
| | Composite composition | at 6 GHz μ = μ′ − iμ″ | | | magnetization | Coercivity | resistance | constant |
| | amount [mol %] | | | tan δ | Is | Hcj | ρ | ε |
| No. | D | μ′ | μ″ | μ″/μ′ | [mT] | [kA/m] | [Ω · m] | 1 GHz |
| 107 | 10.4 | 1.38 | 0.046 | 0.033 | 297 | 92 | 2 × 10 [symbol] | 10 |
| 108 | 10.4 | 1.51 | 0.058 | 0.038 | 309 | 55 | 8 × 10⁷ | 15 |
| 109 | 10.4 | 1.88 | 0.050 | 0.027 | 322 | 29 | 2 × 10 [symbol] | 10 |
| 110 | 10.4 | 1.51 | 0.00 [symbol] | 0.003 | 387 | 41 | 8 × 10⁷ | 15 |
| 111 | 10.4 | 1.62 | 0.006 | 0.004 | 401 | 25 | 2 × 10 [symbol] | 10 |
| 112 | 10.4 | 1.43 | 0.031 | 0.022 | 3 [symbol] 8 | 78 | 8 × 10⁷ | 15 |
| 113 | 10.4 | 1.45 | 0.013 | 0.009 | 404 | 41 | 2 × 10 [symbol] | 10 |

[symbol]

indicates data missing or illegible when filed

The composition, magnetic properties, and the like of the composition formula BaCa_{0.3}ZnₓMe_{1.8-x}Co_{0.2}Fe₁₆O_{27-δ} are shown in Table 8.

TABLE 8
Composition formula: BaCa_{0.3}ZnₓMe [symbol] Co_{0.2}Fe₁ [symbol] O_{27-δ}

| | | Me element | | | | | | | | | | | | |
|---|---|---|---|---|---|---|---|---|---|---|---|---|---|---|
| | Composition[mol] | [mol] | | | Composition ratio | | | | | | | | Composite composition | |
| | Ni | Mg | Mn | Zn | [mol %] | | | | | | | | amount [mol %] | |
| No. | x | 1.8-x | 1.8-x | 1.8-x | Ba | Ca | Mg | Mn | Ni | Zn | Co | Fe | Me(II) | Me(IV) |
| 114 | 1.80 | 0.00 | 0.00 | 0.00 | 5.2 | 1.6 | 0.0 | 0.0 | 0.0 | 9.3 | 1.0 | 82.9 | 10.4 | 0.0 |
| 115 | 0.90 | 0.90 | 0.00 | 0.00 | 5.2 | 1.6 | 4.7 | 0.0 | 0.0 | 4.7 | 1.0 | 82.9 | 10.4 | 0.0 |
| 116 | 0.00 | 1.80 | 0.00 | 0.00 | 5.2 | 1.6 | 9.3 | 0.0 | 0.0 | 0.0 | 1.0 | 82.9 | 10.4 | 0.0 |
| 117 | 0.90 | 0.00 | 0.90 | 0.00 | 5.2 | 1.6 | 0.0 | 4.7 | 0.0 | 4.7 | 1.0 | 82.9 | 10.4 | 0.0 |
| 118 | 0.50 | 0.00 | 1.30 | 0.00 | 5.2 | 1.6 | 0.0 | 6.7 | 0.0 | 2.6 | 1.0 | 82.9 | 10.4 | 0.0 |
| 119 | 0 00 | 0.00 | 1.80 | 0.00 | 5.2 | 1.6 | 0.0 | 9.3 | 0.0 | 0.0 | 1.0 | 82.9 | 10.4 | 0.0 |
| 120 | 0.90 | 0.00 | 0.00 | 0.90 | 5.2 | 1.6 | 0.0 | 0.0 | 4.7 | 4.7 | 1.0 | 82.9 | 10.4 | 0.0 |
| 121 | 0.00 | 0.00 | 0.00 | 1. [symbol] 0 | 5.2 | 1.6 | 0.0 | 0.0 | 9.3 | 0.0 | 1.0 | 82.9 | 10.4 | 0.0 |

| | | | | | Magnetization curve | | | |
|---|---|---|---|---|---|---|---|---|
| | | Magnetic permeability | | | Saturation | | Specific | Dielectric |
| | Composite composition | at 6 GHz μ = μ′ − iμ″ | | | magnetization | Coercivity | resistance | constant |
| | amount [mol %] | | | tan δ | Is | Hcj | ρ | ε |
| No. | D | μ′ | μ″ | μ″/μ′ | [mT] | [kA/m] | [Ω · m] | 1 GHz |
| 114 | 10.4 | 1.45 | 0.013 | 0.009 | 404 | 41 | 2 × 10 [symbol] | 10 |
| 115 | 10.4 | 1.61 | 0.042 | 0.026 | 361 | 36 | 8 × 10⁷ | 16 |
| 116 | 10.4 | 1.88 | 0.050 | 0.027 | 322 | 29 | 2 × 10 [symbol] | 10 |
| 117 | 10.4 | 1.51 | 0.023 | 0.015 | 428 | 4 | 8 × 10⁷ | 14 |
| 118 | 10.4 | 1.47 | 0.002 | 0.001 | 412 | 22 | 8 × 10⁷ | 15 |
| 119 | 10.4 | 1.62 | 0.006 | 0.004 | 401 | 2 [symbol] | 2 × 10 [symbol] | 10 |
| 120 | 10.4 | 1.41 | 0.029 | 0.021 | 346 | 67 | 8 × 10⁷ | 13 |
| 121 | 10.4 | 1.38 | 0.046 | 0.033 | 297 | 92 | 2 × 10 [symbol] | 10 |

[symbol]

indicates data missing or illegible when filed

The composition, magnetic properties, and the like of the composition formula BaCa_{0.3}Co_{0.2}Mg_{1.8+x}MeₓFe₁₆₋₂ₓO_{27-δ} and the composition formula BaCa_{0.3}Co_{0.2}Mg_{1.8}ZnₓMeₓFe₁₆₋₂ₓO_{27-δ} are shown in Table 9.

TABLE 9
Composition formula: BaC [symbol] Co [symbol] Mg [symbol] Me [symbol] Fe [symbol] O [symbol] and composition formula: BaCa [symbol] Co [symbol] Mg [symbol] Zn [symbol] Fe [symbol] O

[symbol]

| | | | Composition formula [mol] | | | | | | | | | | | | | | | | |
|---|---|---|---|---|---|---|---|---|---|---|---|---|---|---|---|---|---|---|---|
| | | | Me (II) element | | Me (IV) element | | | | | Composition ratio | | | | | | | | | |
| | | Fe | Mg | Z [symbol] | Ge | Si | S [symbol] | Ti | Z [symbol] | [mol %] | | | | | | | | | |
| No. | | 1 [symbol] -2x | 1.8 [symbol] x | x | x | x | x | x | x | B [symbol] | C [symbol] | Co | Mg | Ge | Si | Sn | Ti | Z [symbol] | Z [symbol] |
| 122 | | 16.00 | 1.80 | 0.00 | 0.00 | 0.00 | 0.00 | 0.00 | 0.00 | 5.2 | 1. [symbol] | 1.0 | 9.3 | 0.0 | 0.0 | 0.0 | 0.0 | 0.0 | 0.0 |
| 123 | | 15.00 | 2.30 | 0.00 | 0.50 | 0.00 | 0.00 | 0.00 | 0.00 | 5.2 | 1. [symbol] | 1.0 | 11.9 | 2.6 | 0.0 | 0.0 | 0.0 | 0.0 | 0.0 |
| 124 | * | 14.00 | 2.80 | 0.00 | 1.00 | 0.00 | 0.00 | 0.00 | 0.00 | 5.2 | 1.8 | 1.0 | 14.5 | 5.2 | 0.0 | 0.0 | 0.0 | 0.0 | 0.0 |
| 125 | | 15.00 | 2.30 | 0.00 | 0.00 | 0.50 | 0.00 | 0.00 | 0.00 | 5.2 | 1. [symbol] | 1.0 | 11.9 | 0.0 | 2. [symbol] | 0.0 | 0.0 | 0.0 | 0.0 |
| 126 | * | 14.00 | 2.80 | 0.00 | 0.00 | 1.00 | 0.00 | 0.00 | 0.00 | 5.2 | 1. [symbol] | 1.0 | 14.5 | 0.0 | [symbol] .2 | 0.0 | 0.0 | 0.0 | 0.0 |
| 127 | | 15.00 | 2.30 | 0.00 | 0.00 | 0.00 | 0.50 | 0.00 | 0.00 | 5.2 | 1.8 | 1.0 | 11.9 | 0.0 | 0.0 | 2.6 | 0.0 | 0.0 | 0.0 |
| 128 | | 14.00 | 2.80 | 0.00 | 0.00 | 0.00 | 1.00 | 0.00 | 0.00 | 5.2 | 1. [symbol] | 1.0 | 14.5 | 0.0 | 0.0 | 5.2 | 0.0 | 0.0 | 0.0 |
| 129 | | 13.00 | 3.30 | 0.00 | 0.00 | 0.00 | 1.50 | 0.00 | 0.00 | 5.2 | 1. [symbol] | 1.0 | 17.1 | 0.0 | 0.0 | 7.8 | 0.0 | 0.0 | 0.0 |
| 130 | * | 12.00 | 3.80 | 0.00 | 0.00 | 0.00 | 2.00 | 0.00 | 0.00 | 5.2 | 1.8 | 1.0 | 1 [symbol] .7 | 0.0 | 0.0 | 10.4 | 0.0 | 0.0 | 0.0 |
| 131 | | 15.00 | 2.30 | 0.00 | 0.00 | 0.00 | 0.00 | 0.50 | 0.00 | 5.2 | 1.8 | 1.0 | 11.9 | 0.0 | 0.0 | 0.0 | 2.6 | 0.0 | 0.0 |
| 132 | * | 14.00 | 2.80 | 0.00 | 0.00 | 0.00 | 0.00 | 1.00 | 0.00 | 5.2 | 1. [symbol] | 1.0 | 14.5 | 0.0 | 0.0 | 0.0 | 5.2 | 0.0 | 0.0 |
| 133 | | 15.00 | 2.30 | 0.00 | 0.00 | 0.00 | 0.00 | 0.00 | 0.50 | 5.2 | 1.8 | 1.0 | 11.9 | 0.0 | 0.0 | 0.0 | 0.0 | 0.0 | 2.6 |
| 134 | | 14.00 | 2.80 | 0.00 | 0.00 | 0.00 | 0.00 | 0.00 | 1.00 | 5.2 | 1.8 | 1.0 | 14.5 | 0.0 | 0.0 | 0.0 | 0.0 | 0.0 | 5.2 |
| 135 | | 13.00 | 3.30 | 0.00 | 0.00 | 0.00 | 0.00 | 0.00 | 1.50 | 5.2 | 1. [symbol] | 1.0 | 17.1 | 0.0 | 0.0 | 0.0 | 0.0 | 0.0 | 7.8 |
| 136 | * | 12.00 | 3.80 | 0.00 | 0.00 | 0.00 | 0.00 | 0.00 | 2.00 | 5.2 | 1. [symbol] | 1.0 | 10.7 | 0.0 | 0.0 | 0.0 | 0.0 | 0.0 | 10.4 |
| 137 | | 15.00 | 1.80 | 0.50 | 0.50 | 0.00 | 0.00 | 0.00 | 0.00 | 5.2 | 1.8 | 1.0 | 9.3 | 2.6 | 0.0 | 0.0 | 0.0 | 2. [symbol] | 0.0 |
| 138 | * | 14.00 | 1.80 | 1.00 | 1.00 | 0.00 | 0.00 | 0.00 | 0.00 | 5.2 | 1. [symbol] | 1.0 | 9.3 | 5.2 | 0.0 | 0.0 | 0.0 | 5.2 | 0.0 |
| 139 | | 15.00 | 1.80 | 0.50 | 0.00 | 0.50 | 0.00 | 0.00 | 0.00 | 5.2 | 1.8 | 1.0 | 9.3 | 0.0 | 2.6 | 0.0 | 0.0 | 2.6 | 0.0 |
| 140 | * | 14.00 | 1.80 | 1.00 | 0.00 | 1.00 | 0.00 | 0.00 | 0.00 | 5.2 | 1.8 | 1.0 | 9.3 | 0.0 | 5.2 | 0.0 | 0.0 | 5.2 | 0.0 |
| 141 | | 15.00 | 1.80 | 0.20 | 0.00 | 0.00 | 0.20 | 0.00 | 0.00 | 5.2 | 1. [symbol] | 1.0 | 9.3 | 0.0 | 0.0 | 1.0 | 0.0 | 1.0 | 0.0 |
| 142 | | 15.00 | 1.80 | 0.50 | 0.00 | 0.00 | 0.00 | 0.00 | 0.00 | 5.2 | 1. [symbol] | 1.0 | 9.3 | 0.0 | 0.0 | 2.6 | 0.0 | 2.6 | 0.0 |
| 143 | | 14.00 | 1.80 | 1.00 | 0.00 | 0.00 | 1.00 | 0.00 | 0.00 | 5.2 | 1.8 | 1.0 | 9.3 | 0.0 | 0.0 | 5.2 | 0.0 | 5.2 | 0.0 |
| 144 | | 13.00 | 1.80 | 1.50 | 0.00 | 0.00 | 1.50 | 0.00 | 0.00 | 5.2 | 1.8 | 1.0 | 9.3 | 0.0 | 0.0 | 7.8 | 0.0 | 7.8 | 0.0 |
| 145 | * | 12.00 | 1.80 | 2.00 | 0.00 | 0.00 | 2.00 | 0.00 | 0.00 | 5.2 | 1. [symbol] | 1.0 | 9.3 | 0.0 | 0.0 | 10.4 | 0.0 | 10.4 | 0.0 |
| 146 | | 15.00 | 1.80 | 0.50 | 0.00 | 0.00 | 0.00 | 0.50 | 0.00 | 5.2 | 1.8 | 1.0 | 9.3 | 0.0 | 0.0 | 0.0 | 2.6 | 2.6 | 0.0 |
| 147 | * | 14.00 | 1.80 | 1.00 | 0.00 | 0.00 | 0.00 | 1.00 | 0.00 | 5.2 | 1. [symbol] | 1.0 | 9.3 | 0.0 | 0.0 | 0.0 | 5.2 | 5.2 | 0.0 |
| 148 | | 15. [symbol] 0 | 1.80 | 0.20 | 0.00 | 0.00 | 0.00 | 0.00 | 0.20 | 5.2 | 1.8 | 1.0 | 9.3 | 0.0 | 0.0 | 0.0 | 0.0 | 1.0 | 1.0 |
| 149 | | 15.00 | 1.80 | 0.50 | 0.00 | 0.00 | 0.00 | 0.00 | 0.50 | 5.2 | 1. [symbol] | 1.0 | 9.3 | 0.0 | 0.0 | 0.0 | 0.0 | 2.6 | 2.6 |
| 150 | | 14.00 | 1.80 | 1.00 | 0.00 | 0.00 | 0.00 | 0.00 | 1.00 | 5.2 | 1. [symbol] | 1.0 | 9.3 | 0.0 | 0.0 | 0.0 | 0.0 | 5.2 | 5.2 |
| 151 | | 13.00 | 1.80 | 1.50 | 0.00 | 0.00 | 0.00 | 0.00 | 1.50 | 5.2 | 1. [symbol] | 1.0 | 9.3 | 0.0 | 0.0 | 0.0 | 0.0 | 7.8 | 7.8 |
| 152 | * | 12.00 | 1.80 | 2.00 | 0.00 | 0.00 | 0.00 | 0.00 | 2.00 | 5.2 | 1.8 | 1.0 | [symbol] .3 | 0.0 | 0.0 | 0.0 | 0.0 | 10.4 | 10.4 |

| | | | | | | | | Magnetization curve | | | |
|---|---|---|---|---|---|---|---|---|---|---|---|
| | | | | | Magnetic permeability | | | Saturation | | Specific | Dielectric |
| | Composition ratio | Composite composition | | | at 6 GHz μ = μ′ − iμ″ | | | magnetization | Coercivity | resistance | constant |
| | [mol %] | amount [mol %] | | | | | tan δ | Is | Hcj | ρ | ε |
| No. | Fe | Me(II) | Me(IV) | D | μ′ | μ″ | μ″/μ′ | [mT] | [kA/m] | [Ω · m] | 1 GHz |
| 122 | [symbol] 2.9 | 10.4 | 0.0 | 10.4 | 1.8 [symbol] | 0.050 | 0.027 | 322 | 29 | 2 × 10 [symbol] | 10 |
| 123 | 77.7 | 13.0 | 2.6 | 10.4 | 1. [symbol] 4 | 1.010 | 0.006 | 307 | 31 | 3 × 10 [symbol] | 9 |
| 124 | 72.5 | 15.5 | 5.2 | 10.4 | 1.09 | 0.270 | 0.248 | 154 | 102 | 3 × 10 [symbol] | 9 |
| 125 | 77.7 | 13.0 | 2.6 | 10.4 | 1.52 | 0.003 | 0.002 | 29 [symbol] | 13 | 3 × 10 [symbol] | 9 |
| 126 | 72.5 | 15.5 | 5.2 | 10.4 | 1.08 | 0.1 [symbol] 3 | 0.151 | 2 [symbol] 1 | 125 | 3 × 10 [symbol] | 9 |
| 127 | 77.7 | 13.0 | 2.6 | 10.4 | 1. [symbol] | 0.014 | 0.008 | 301 | 31 | 3 × 10 [symbol] | 9 |
| 128 | 72.5 | 15.5 | 5.2 | 10.4 | 2.14 | 0.034 | 0.016 | 254 | 34 | 1 × 10 [symbol] | 9 |
| 129 | 67.4 | 18.1 | 7.8 | 10.4 | 1.78 | 0.074 | 0.042 | 21 [symbol] | 52 | 2 × 10 [symbol] | 15 |
| 130 | 62.2 | 20.7 | 10.4 | 10.4 | 157 | 0.167 | 0.1 [symbol] 8 | 1 [symbol] 7 | 83 | 8 × 10 [symbol] | 23 |
| 131 | 77.7 | 13.0 | 2.6 | 10.4 | 1.63 | 0.014 | 0.009 | 311 | 27 | 3 × 10 [symbol] | 9 |
| 132 | 72.5 | 15.5 | 5.2 | 10.4 | 1.07 | 0.249 | 0.233 | 187 | 109 | 3 × 10 [symbol] | 9 |
| 133 | 77.7 | 13.0 | 2.6 | 10.4 | 1.78 | 0.01 [symbol] | 0.009 | 300 | 26 | 3 × 10 [symbol] | 9 |
| 134 | 72.5 | 15.5 | 5.2 | 10.4 | 2.03 | 0.052 | 0.026 | 2 [symbol] 1 | 39 | 1 × 10 [symbol] | 9 |
| 135 | 67.4 | 18.1 | 7.8 | 10.4 | 1.84 | 0.071 | 0.039 | 224 | 45 | 2 × 10 [symbol] | 15 |
| 136 | [symbol] 2.2 | 20.7 | 10.4 | 10.4 | 1.49 | 0.122 | 0.082 | 181 | 53 | 8 × 10 [symbol] | 23 |
| 137 | 77.7 | 13.0 | 2.6 | 10.4 | 1.88 | 0.049 | 0.026 | 275 | 31 | 3 × 10 [symbol] | 9 |
| 138 | 72.5 | 15.5 | 5.2 | 10.4 | 1.27 | 0.297 | 0.234 | 210 | 100 | 3 × 10 [symbol] | 9 |
| 139 | 77.7 | 13.0 | 2.6 | 10.4 | 1.79 | 0.037 | 0.021 | 2 [symbol] 4 | 39 | 3 × 10 [symbol] | 9 |
| 140 | 72.5 | 15.5 | 5.2 | 10.4 | 1.27 | 0.324 | 0.255 | 258 | 1 [symbol] 0 | 3 × 10 [symbol] | 9 |
| 141 | 80. [symbol] | 11.4 | 1.0 | 10.4 | 1. [symbol] 6 | 0.00 [symbol] | 0.004 | 32 [symbol] | 32 | 3 × 10 [symbol] | 9 |
| 142 | 77.7 | 13.0 | 2. [symbol] | 10.4 | 2.52 | 0.015 | 0.00 [symbol] | 309 | 20 | 2 × 10 [symbol] | 9 |
| 143 | 72.5 | 15.5 | 5.2 | 10.4 | 3.15 | 0.022 | 0.007 | 301 | 13 | 3 × 10 [symbol] | 10 |
| 144 | 67.4 | 18.1 | 7.8 | 10.4 | 3.00 | 0.101 | 0.034 | 24 [symbol] | 6 | 4 × 10 [symbol] | 16 |
| 145 | 62.2 | 20.7 | 10.4 | 10.4 | 2.80 | 0.300 | 0.107 | 210 | 25 | 8 × 10 [symbol] | 37 |
| 146 | 77.7 | 13.0 | 2.6 | 10.4 | 1.72 | 0.04 [symbol] | 0.02 [symbol] | 28 [symbol] | 30 | 3 × 10 [symbol] | 9 |
| 147 | 72.5 | 15.5 | 5.2 | 10.4 | 1.10 | 0.371 | 0.312 | 1 [symbol] 4 | 179 | 3 × 10 [symbol] | 9 |
| 148 | 80.8 | 11.4 | 1.0 | 10.4 | 2.03 | 0.010 | 0.005 | 324 | 26 | 3 × 10 [symbol] | 9 |
| 149 | 77.7 | 13.0 | 2.6 | 10.4 | 2.49 | 0.014 | 0.006 | 30 [symbol] | 21 | 3 × 10 [symbol] | 9 |
| 150 | 72.5 | 15.5 | 5.2 | 10.4 | 3.1 [symbol] | 0.023 | 0.007 | 301 | 13 | 1 × 10 [symbol] | 11 |
| 151 | 67.4 | 18.1 | 7.8 | 10.4 | 2.98 | 0.0 [symbol] 9 | 0.033 | 248 | 5 | 2 × 10 [symbol] | 14 |
| 152 | 82.2 | 20.7 | 10.4 | 10.4 | 2.79 | 0. [symbol] 1 [symbol] | 0.113 | 218 | 34 | 4 × 10 [symbol] | 3 [symbol] |

[symbol]

indicates data missing or illegible when filed

The composition, magnetic properties, and the like of the composition formula BaCa_{0.3}Co_{0.2}Mn_{1.8+x}MeₓFe₁₆₋₂ₓO_{27-δ} and the composition formula BaCa_{0.3}Co_{0.2}Mn_{1.8}ZnₓMeₓFe₁₆₋₂ₓO_{27-δ} are shown in Table 10.

TABLE 10
Composition formula: BaCa [symbol] Co [symbol] Mn [symbol] M [symbol] Fe [symbol] O [symbol] and composition formula: BaCa [symbol] Co [symbol] Mn [symbol] Zn [symbol] M [symbol] Fe [symbol] O

[symbol]

| | | Composition formula [mol] | | | | | | | | | | | | | | | | | |
|---|---|---|---|---|---|---|---|---|---|---|---|---|---|---|---|---|---|---|---|
| | | | Me (II) element | | Me (IV) element | | | | | Composition ratio | | | | | | | | | |
| | | Fe | Mn | Zn | Ge | Si | Sn | Ti | Z [symbol] | [mol %] | | | | | | | | | |
| No. | | 16-2x | 1.8 [symbol] x | x | x | x | x | x | x | Ba | C [symbol] | [symbol] | Mn | Ge | S [symbol] | S [symbol] | Ti | Z [symbol] | Z [symbol] |
| 153 | | 16.00 | 1.80 | 0.00 | 0.00 | 0.00 | 0.00 | 0.00 | 0.00 | 5.2 | 1. [symbol] | 1.0 | 9.3 | 0.0 | 0.0 | 0.0 | 0.0 | 0.0 | 0.0 |
| 154 | | 15.00 | 2.30 | 0.00 | 0.50 | 0.00 | 0.00 | 0.00 | 0.00 | 5.2 | 1. [symbol] | 1.0 | 11.9 | 2. [symbol] | 0.0 | 0.0 | 0.0 | 0.0 | 0.0 |
| 155 | * | 14.00 | 2.80 | 0.00 | 1.00 | 0.00 | 0.00 | 0.00 | 0.00 | 5.2 | 1. [symbol] | 1.0 | 14.5 | 5.2 | 0.0 | 0.0 | 0.0 | 0.0 | 0.0 |
| 156 | | 15.00 | 2.30 | 0.00 | 0.00 | 0.50 | 0.00 | 0.00 | 0.00 | 5.2 | 1. [symbol] | 1.0 | 11.9 | 0.0 | 2. [symbol] | 0.0 | 0.0 | 0.0 | 0.0 |
| 157 | * | 14.00 | 2.80 | 0.00 | 0.00 | 1.00 | 0.00 | 0.00 | 0.00 | 5.2 | 1. [symbol] | 1.0 | 14.5 | 0.0 | 5.2 | 0.0 | 0.0 | 0.0 | 0.0 |
| 158 | | 15.00 | 2.30 | 0.00 | 0.00 | 0.00 | 0.50 | 0.00 | 0.00 | 5.2 | 1. [symbol] | 1.0 | 11.9 | 0.0 | 0.0 | 2.8 | 0.0 | 0.0 | 0.0 |
| 159 | | 14.00 | 2.80 | 0.00 | 0.00 | 0.00 | 1.00 | 0.00 | 0.00 | 5.2 | 1. [symbol] | 1.0 | 14.5 | 0.0 | 0.0 | 5.2 | 0.0 | 0.0 | 0.0 |
| 160 | | 13.00 | 3.30 | 0.00 | 0.00 | 0.00 | 1.50 | 0.00 | 0.00 | 5.2 | 1. [symbol] | 1.0 | 17.1 | 0.0 | 0.0 | 7.8 | 0.0 | 0.0 | 0.0 |
| 161 | * | 12.00 | 3.80 | 0.00 | 0.00 | 0.00 | 2.00 | 0.00 | 0.00 | 5.2 | 1. [symbol] | 1.0 | 1 [symbol] .7 | 0.0 | 0.0 | 10.4 | 0.0 | 0.0 | 0.0 |
| 162 | | 15.00 | 2.30 | 0.00 | 0.00 | 0.00 | 0.00 | 0.50 | 0.00 | 5.2 | 1. [symbol] | 1.0 | 11.9 | 0.0 | 0.0 | 0.0 | 2.6 | 0.0 | 0.0 |
| 163 | * | 14.00 | 2. [symbol] 0 | 0.00 | 0.00 | 0.00 | 0.00 | 1.00 | 0.00 | 5.2 | 1. [symbol] | 1.0 | 14.5 | 0.0 | 0.0 | 0.0 | 5.2 | 0.0 | 0.0 |
| 164 | | 15.00 | 2.30 | 0.00 | 0.00 | 0.00 | 0.00 | 0.00 | 0.50 | 5.2 | 1. [symbol] | 1.0 | 11.9 | 0.0 | 0.0 | 0.0 | 0.0 | 0.0 | 2.6 |
| 165 | | 14.00 | 2. [symbol] 0 | 0.00 | 0.00 | 0.00 | 0.00 | 0.00 | 1.00 | 5.2 | 1. [symbol] | 1.0 | 14.5 | 0.0 | 0.0 | 0.0 | 0.0 | 0.0 | 5.2 |
| 166 | | 13.00 | 3.30 | 0.00 | 0.00 | 0.00 | 0.00 | 0.00 | 1.50 | 5.2 | 1. [symbol] | 1.0 | 17.1 | 0.0 | 0.0 | 0.0 | 0.0 | 0.0 | 7.8 |
| 167 | * | 12.00 | 3.80 | 0.00 | 0.00 | 0.00 | 0.00 | 0.00 | 2.00 | 5.2 | 1. [symbol] | 1.0 | 19.7 | 0.0 | 0.0 | 0.0 | 0.0 | 0.0 | 10.4 |
| 168 | | 15.00 | 1.80 | 0.50 | 0.50 | 0.00 | 0.00 | 0.00 | 0.00 | 5.2 | 1. [symbol] | 1.0 | [symbol] .3 | 2.6 | 0.0 | 0.0 | 0.0 | 2.6 | 0.0 |
| 169 | * | 14.00 | 1.80 | 1.00 | 1.00 | 0.00 | 0.00 | 0.00 | 0.00 | 5.2 | 1. [symbol] | 1.0 | [symbol] .3 | 5.2 | 0.0 | 0.0 | 0.0 | [symbol] .2 | 0.0 |
| 170 | | 15.00 | 1.80 | 0.50 | 0.00 | 0.50 | 0.00 | 0.00 | 0.00 | 5.2 | 1. [symbol] | 1.0 | 9.3 | 0.0 | 2. [symbol] | 0.0 | 0.0 | 2.6 | 0.0 |
| 171 | * | 14.00 | 1.80 | 1.00 | 0.00 | 1.00 | 0.00 | 0.00 | 0.00 | 5.2 | 1. [symbol] | 1.0 | [symbol] .3 | 0.0 | 5.2 | 0.0 | 0.0 | 5.2 | 0.0 |
| 172 | | 15.80 | 1.80 | 0.20 | 0.00 | 0.00 | 0.20 | 0.00 | 0.00 | 5.2 | 1. [symbol] | 1.0 | 9.3 | 0.0 | 0.0 | 1.0 | 0.0 | 1.0 | 0.0 |
| 173 | | 15.00 | 1.80 | 0.50 | 0.00 | 0.00 | 0.50 | 0.00 | 0.00 | 5.2 | 1. [symbol] | 1.0 | 9.3 | 0.0 | 0.0 | 2. [symbol] | 0.0 | 2. [symbol] | 0.0 |
| 174 | | 14.00 | 1.80 | 1.00 | 0.00 | 0.00 | 1.00 | 0.00 | 0.00 | 5.2 | 1. [symbol] | 1.0 | [symbol] .3 | 0.0 | 0.0 | 5.2 | 0.0 | 5.2 | 0.0 |
| 175 | | 13.00 | 1.80 | 1.50 | 0.00 | 0.00 | 1.50 | 0.00 | 0.00 | 5.2 | 1. [symbol] | 1.0 | [symbol] .3 | 0.0 | 0.0 | 7. [symbol] | 0.0 | 7. [symbol] | 0.0 |
| 176 | * | 12.00 | 1.80 | 2.00 | 0.00 | 0.00 | 2.00 | 0.00 | 0.00 | 5.2 | 1. [symbol] | 1.0 | 9.3 | 0.0 | 0.0 | 10.4 | 0.0 | 10.4 | 0.0 |
| 177 | | 15.00 | 1.80 | 0.50 | 0.00 | 0.00 | 0.00 | 0.50 | 0.00 | 5.2 | 1. [symbol] | 1.0 | 9.3 | 0.0 | 0.00 | 0.0 | 2.6 | 2.6 | 0.0 |
| 178 | * | 14.00 | 1. [symbol] 0 | 1.00 | 0.00 | 0.00 | 0.00 | 1.00 | 0.00 | 5.2 | 1. [symbol] | 1.0 | 9.3 | 0.0 | 0.0 | 0.0 | 5.2 | 5.2 | 0.0 |
| 179 | | 15. [symbol] 0 | 1. [symbol] 0 | 0.20 | 0.00 | 0.00 | 0.00 | 0.00 | 0.20 | 5.2 | 1. [symbol] | 1.0 | 9.3 | 0.0 | 0.0 | 0.0 | 0.0 | 1.0 | 1.0 |
| 1 [symbol] 0 | | 15.00 | 1.80 | 0.50 | 0.00 | 0.00 | 0.00 | 0.00 | 0.50 | 5.2 | 1. [symbol] | 1.0 | [symbol] .3 | 0.0 | 0.0 | 0.0 | 0.0 | 2.6 | 2.6 |
| 1 [symbol] 1 | | 14.00 | 1.80 | 1.00 | 0.00 | 0.00 | 0.00 | 0.00 | 1.00 | 5.2 | 1. [symbol] | 1.0 | [symbol] .3 | 0.0 | 0.0 | 0.0 | 0.0 | 5.2 | 5.2 |
| 182 | | 13.00 | 1.80 | 1.50 | 0.00 | 0.00 | 0.00 | 0.00 | 1.50 | 5.2 | 1. [symbol] | 1.0 | 9.3 | 0.0 | 0.0 | 0.0 | 0.0 | 7.8 | 7.8 |
| 183 | * | 12.00 | 1.80 | 2.00 | 0.00 | 0.00 | 0.00 | 0.00 | 2.00 | 5.2 | 1. [symbol] | 1.0 | 9.3 | 0.0 | 0.0 | 0.0 | 0.0 | 10.4 | 10.4 |

| | | | | | | | | Magnetization curve | | | |
|---|---|---|---|---|---|---|---|---|---|---|---|
| | | | | | Magnetic permeability | | | Saturation | | Specific | Dielectric |
| | Composition ratio | Composite composition | | | at 6 GHz μ = μ′ − iμ″ | | | magnetization | Coercivity | resistance | constant |
| | [mol %] | amount [mol %] | | | | | tan δ | Is | Hcj | ρ | ε |
| No. | Fe | M [symbol] (II) | M [symbol] (IV) | D | μ′ | μ″ | μ″/μ′ | [mT] | [kA/m] | [Ω · m] | 1 GHz |
| 153 | [symbol] 2.9 | 10.4 | 0.0 | 10.4 | 1.62 | 0.006 | 0.004 | 401 | 25 | 2 × 10 [symbol] | 10 |
| 154 | 77.7 | 13.0 | 2.6 | 10.4 | 1.54 | 0.010 | 0.006 | 387 | 31 | 3 × 10 [symbol] | 9 |
| 155 | 72.5 | 15.5 | 5.2 | 10.4 | 1.09 | 0.270 | 0.24 [symbol] | 209 | 102 | 3 × 10 [symbol] | 9 |
| 156 | 77.7 | 13.0 | 2.6 | 10.4 | 1. [symbol] 2 | 0.0 [symbol] 3 | 0.002 | 390 | 13 | 3 × 10 [symbol] | 9 |
| 157 | 72.5 | 15.5 | 5.2 | 10.4 | 1.08 | 0.1 [symbol] 3 | 0.151 | 228 | 125 | 3 × 10 [symbol] | [symbol] |
| 158 | 77.7 | 13.0 | 2.6 | 10.4 | 1.87 | 0.014 | 0.00 [symbol] | 3 [symbol] 3 | 31 | 3 × 10 [symbol] | 9 |
| 159 | 72.5 | 15.5 | 5.2 | 10.4 | 2.14 | 0.034 | 0.016 | 349 | 34 | 1 × 10 [symbol] | 9 |
| 160 | 67.4 | 18.1 | 7.8 | 10.4 | 1.93 | 0.078 | 0.040 | 310 | 51 | [symbol] × 10 [symbol] | 15 |
| 161 | 62.2 | 20.7 | 10.4 | 10.4 | 1.57 | 0.167 | 0.106 | 277 | [symbol] 9 | 8 × 10 [symbol] | 23 |
| 162 | 77.7 | 13.0 | 2. [symbol] | 10.4 | 1. [symbol] 3 | 0.014 | 0.009 | 392 | 27 | 3 × 10 [symbol] | 9 |
| 163 | 72.5 | 15.5 | 5.2 | 10.4 | 1.07 | 0.249 | 0.233 | 20 [symbol] | 109 | 3 × 10 [symbol] | 9 |
| 164 | 77.7 | 13. [symbol] | 2. [symbol] | 10.4 | 1.78 | 0.016 | 0.009 | 410 | 26 | 3 × 10 [symbol] | [symbol] |
| 165 | 72.5 | 15.5 | [symbol] .2 | 10.4 | 2.25 | 0.072 | 0.0 [symbol] 2 | 372 | 23 | 1 × 10 [symbol] | 9 |
| 166 | [symbol] 7.4 | 18.1 | 7.8 | 10.4 | 1.77 | 0.0 [symbol] | 0.050 | 321 | 45 | 2 × 10 [symbol] | 15 |
| 167 | 62.2 | 20.7 | 10.4 | 10.4 | 1.49 | 0.122 | 0.0 [symbol] 2 | 27 [symbol] | 53 | 8 × 10 [symbol] | 23 |
| 168 | 77.7 | 13.0 | 2.6 | 10.4 | 1. [symbol] 8 | 0.049 | 0.026 | 374 | 31 | 3 × 10 [symbol] | 9 |
| 169 | 72.5 | 15.5 | 5.2 | 10.4 | 1.27 | 0.297 | 0.234 | 20 [symbol] | 100 | 3 × 10 [symbol] | 9 |
| 170 | 77.7 | 13.0 | 2.6 | 10.4 | 1.79 | 0.037 | 0.021 | 3 [symbol] | 39 | 3 × 10 [symbol] | [symbol] |
| 171 | 72.5 | 15.5 | 5.2 | 10.4 | 1.27 | 0.324 | 0.253 | 251 | 180 | 3 × 10 [symbol] | 9 |
| 172 | [symbol] 0. [symbol] | 11.4 | 1.0 | 10.4 | 1.96 | 0.009 | 0.004 | 3 [symbol] | 32 | 3 × 10 [symbol] | 9 |
| 173 | 77.7 | 13.0 | 2.6 | 10.4 | 2.57 | 0.015 | 0.006 | 3 [symbol] 4 | 20 | 2 × 10 [symbol] | 9 |
| 174 | 72.5 | 15.5 | 5.2 | 10.4 | 3.15 | 0.022 | 0.007 | 3 [symbol] | 13 | 3 × 10 [symbol] | 10 |
| 175 | [symbol] 7.4 | 10.1 | 7.8 | 10.4 | 2 [symbol] 8 | 0.101 | 0.034 | 351 | 10 | 4 × 10 [symbol] | 1 [symbol] |
| 176 | 62.2 | 20.7 | 10.4 | 10.4 | 2.80 | 0.300 | 0.107 | 312 | 6 | 6 × 10 [symbol] | 37 |
| 177 | 77.7 | 13.0 | 2.6 | 10.4 | 1.72 | 0.04 [symbol] | 0.02 [symbol] | 374 | 30 | 3 × 10 [symbol] | [symbol] |
| 178 | 72.5 | 15.5 | 5.2 | 10.4 | 1.19 | 0.371 | 0.312 | 206 | 179 | 3 × 10 [symbol] | 9 |
| 179 | [symbol] 0. [symbol] | 11.4 | 1.0 | 10.4 | 2.03 | 0.052 | 0.026 | 3 [symbol] 1 | 26 | 3 × 10 [symbol] | 9 |
| 1 [symbol] 0 | 77.7 | 13.0 | 2. [symbol] | 10.4 | 2.49 | 0.014 | 0.00 [symbol] | 3 [symbol] 3 | 13 | 3 × 10 [symbol] | [symbol] |
| 1 [symbol] 1 | 72.5 | 15.5 | 5.2 | 10.4 | 3.15 | 0.023 | 0.007 | 395 | 13 | 1 × 10 [symbol] | 11 |
| 182 | 67.4 | 18.1 | 7.8 | 10.4 | 2.88 | 0.124 | 0.043 | 3 [symbol] 4 | [symbol] | 2 × 10 [symbol] | 14 |
| 183 | 62.2 | 20.7 | 10.4 | 10.4 | 2.7 [symbol] | 0.316 | 0.113 | 310 | 5 | 4 × 10 [symbol] | 36 |

[symbol]

indicates data missing or illegible when filed

The composition, magnetic properties, and the like of the composition formula BaCa_{0.3}Co_{0.2}Ni_{1.8+x}MeₓFe₁₆₋₂ₓO_{27-δ} and the composition formula

BaCa_{0.3}Co_{0.2}Ni_{1.8}ZnₓMeₓFe₁₆₋₂ₓO_{27-δ} are shown in Table 11.

TABLE 11
Composition formula: BaCa [symbol] Co [symbol] Ni [symbol] M [symbol] Fe [symbol] O [symbol] and composition formula: BaCa [symbol] Co [symbol] Ni [symbol] Zn [symbol] M [symbol] Fe [symbol] O

[symbol]

| | | Composition formula [mol] | | | | | | | | | | | | | | | | | |
|---|---|---|---|---|---|---|---|---|---|---|---|---|---|---|---|---|---|---|---|
| | | | Me (II) element | | Me (IV) element | | | | | Composition ratio | | | | | | | | | |
| | | Fe | Ni | Zn | Ge | Si | Sn | Ti | Z [symbol] | [mol %] | | | | | | | | | |
| No. | | 1 [symbol] -2x | 1.8 [symbol] | x | x | x | x | x | x | B [symbol] | Ca | Co | Ni | Ge | Si | Sn | Ti | Zn | Z [symbol] |
| 184 | | 15.00 | 1.80 | 0.00 | 0.00 | 0.00 | 0.00 | 0.00 | 0.00 | 5.2 | 1. [symbol] | 1.0 | [symbol] .3 | 0.0 | 0.0 | 0.0 | 0.0 | 0.0 | 0.0 |
| 185 | | 15.00 | 2.30 | 0.00 | 0.50 | 0.00 | 0.00 | 0.00 | 0.00 | 5.2 | 1.6 | 1.0 | 11.9 | 2.6 | 0.0 | 0.0 | 0.0 | 0.0 | 0.0 |
| 186 | * | 14.00 | 2.80 | 0.00 | 1.00 | 0.00 | 0.00 | 0.00 | 0.00 | 5.2 | 1. [symbol] | 1.0 | 14.5 | 5.2 | 0.0 | 0.0 | 0.0 | 0.0 | 0.0 |
| 187 | | 15.00 | 2.30 | 0.00 | 0.00 | 0.50 | 0.00 | 0.00 | 0.00 | 5.2 | 1.6 | 1.0 | 11.9 | 0.0 | 2. [symbol] | 0.0 | 0.0 | 0.0 | 0.0 |
| 188 | * | 14.00 | 2.80 | 0.00 | 0.00 | 1.00 | 0.00 | 0.00 | 0.00 | 5.2 | 1. [symbol] | 1.0 | 14.5 | 0.0 | 5.2 | 0.0 | 0.0 | 0.0 | 0.0 |
| 189 | | 15.00 | 2.30 | 0.00 | 0.00 | 0.00 | 0.50 | 0.00 | 0.00 | 5.2 | 1. [symbol] | 1.0 | 11.9 | 0.0 | 0.0 | 2.6 | 0.0 | 0.0 | 0.0 |
| 190 | | 14.00 | 2.80 | 0.00 | 0.00 | 0.00 | 1.00 | 0.00 | 0.00 | 5.2 | 1. [symbol] | 1.0 | 14.5 | 0.0 | 0.0 | 5.2 | 0.0 | 0.0 | 0.0 |
| 191 | | 13.00 | 3.30 | 0.00 | 0.00 | 0.00 | 1.50 | 0.00 | 0.00 | 5.2 | 1.6 | 1.0 | 17.1 | 0.0 | 0.0 | 7.8 | 0.0 | 0.0 | 0.0 |
| 192 | * | 12.00 | 3.80 | 0.00 | 0.00 | 0.00 | 2.00 | 0.00 | 0.00 | 5.2 | 1.6 | 1.0 | 19.7 | 0.0 | 0.0 | 10.4 | 0.0 | 0.0 | 0.0 |
| 193 | | 15.00 | 2.30 | 0.00 | 0.00 | 0.00 | 0.00 | 0.50 | 0.00 | 5.2 | 1. [symbol] | 1.0 | 11. [symbol] | 0.0 | 0.0 | 0.0 | 2.6 | 0.0 | 0.0 |
| 194 | * | 14.00 | 2. [symbol] 0 | 0.00 | 0.00 | 0.00 | 0.00 | 1.00 | 0.00 | 5.2 | 1.6 | 1.0 | 14.5 | 0.0 | 0.0 | 0.0 | 5.2 | 0.0 | 0.0 |
| 195 | | 15.00 | 2.30 | 0.00 | 0.00 | 0.00 | 0.00 | 0.00 | 0.50 | 5.2 | 1 [symbol] | 1.0 | 11.9 | 0.0 | 0.0 | 0.0 | 0.0 | 0.0 | 2.6 |
| 19 [symbol] | | 14.00 | 2. [symbol] 0 | 0.00 | 0.00 | 0.00 | 0.00 | 0.00 | 1.00 | 5.2 | 1. [symbol] | 1.0 | 14.5 | 0.0 | 0.0 | 0.0 | 0.0 | 0.0 | 5.2 |
| 197 | | 13.00 | 3.30 | 0.00 | 0.00 | 0.00 | 0.00 | 0.00 | 1.50 | 5.2 | 1.6 | 1.0 | 17.1 | 0.0 | 0.0 | 0.0 | 0.0 | 0.0 | 7.8 |
| 198 | * | 12.00 | 3.80 | 0.00 | 0.00 | 0.00 | 0.00 | 0.00 | 2.00 | 5.2 | 1. [symbol] | 1.0 | 1 [symbol] .7 | 0.0 | 0.0 | 0.0 | 0.0 | 0.0 | 10.4 |
| 1 [symbol] 9 | | 15.00 | 1.80 | 0.50 | 0.50 | 0.00 | 0.00 | 0.00 | 0.00 | 5.2 | 1.6 | 1.0 | [symbol] .3 | 2. [symbol] | 0.0 | 0.0 | 0.0 | 2.6 | 0.0 |
| 200 | * | 14.00 | 1.80 | 1.00 | 1.00 | 0.00 | 0.00 | 0.00 | 0.00 | 5.2 | 1. [symbol] | 1.0 | 9.3 | 5.2 | 0.0 | 0.0 | 0.0 | 5.2 | 0.0 |
| 201 | | 15.00 | 1.80 | 0.50 | 0.00 | 0.50 | 0.00 | 0.00 | 0.00 | 5.2 | 1. [symbol] | 1.0 | 9.3 | 0.0 | 2. [symbol] | 0.0 | 0.0 | 2.6 | 0.0 |
| 202 | * | 14.00 | 1.80 | 1.00 | 0.00 | 1.00 | 0.00 | 0.00 | 0.00 | 5.2 | 1.6 | 1.0 | [symbol] .3 | 0.0 | 5.2 | 0.0 | 0.0 | 5.2 | 0.0 |
| 203 | | 15.80 | 1.80 | 0.20 | 0.00 | 0.00 | 0.20 | 0.00 | 0.00 | 5.2 | 1. [symbol] | 1.0 | 9.3 | 0.0 | 0.0 | 1.0 | 0.0 | 1.0 | 0.0 |
| 204 | | 15.00 | 1.80 | 0.50 | 0.00 | 0.00 | 0.50 | 0.00 | 0.00 | 5.2 | 1. [symbol] | 1.0 | 9.3 | 0.0 | 0.0 | 2.6 | 0.0 | 2.6 | 0.0 |
| 205 | | 14.00 | 1.80 | 1.00 | 0.00 | 0.00 | 1.00 | 0.00 | 0.00 | 5.2 | 1.6 | 1.0 | [symbol] .3 | 0.0 | 0.0 | 5.2 | 0.0 | 5.2 | 0.0 |
| 206 | | 13.00 | 1.80 | 1.50 | 0.00 | 0.00 | 1.50 | 0.00 | 0.00 | 5.2 | 1.6 | 1.0 | [symbol] .3 | 0.0 | 0.0 | 7.8 | 0.0 | 7.8 | 0.0 |
| 207 | * | 12.00 | 1.80 | 2.00 | 0.00 | 0.00 | 2.00 | 0.00 | 0.00 | 5.2 | 1. [symbol] | 1.0 | 9.3 | 0.0 | 0.0 | 10.4 | 0.0 | 10.4 | 0.0 |
| 208 | | 15.00 | 1.80 | 0.50 | 0.00 | 0.00 | 0.00 | 0.50 | 0.00 | 5.2 | 1. [symbol] | 1.0 | 9.3 | 0.0 | 0.0 | 0.0 | 2.6 | 2.6 | 0.0 |
| 209 | * | 14.00 | 1.80 | 1.00 | 0.00 | 0.00 | 0.00 | 1.00 | 0.00 | 5.2 | 1.6 | 1.0 | [symbol] .3 | 0.0 | 0.0 | 0.0 | 5.2 | 5.2 | 0.0 |
| 210 | | 15. [symbol] 0 | 1.80 | 0.20 | 0.00 | 0.00 | 0.00 | 0.00 | 0.20 | 5.2 | 1.6 | 1.0 | 9.3 | 0.0 | 0.0 | 0.0 | 0.0 | 1.0 | 1.0 |
| 211 | | 15.00 | 1.80 | 0.50 | 0.00 | 0.00 | 0.00 | 0.00 | 0.50 | 5.2 | 1. [symbol] | 1.0 | 9.3 | 0.0 | 0.0 | 0.0 | 0.0 | 2.6 | 2. [symbol] |
| 212 | | 14.00 | 1.80 | 1.00 | 0.00 | 0.00 | 0.00 | 0.00 | 1.00 | 5.2 | 1. [symbol] | 1.0 | 9.3 | 0.0 | 0.0 | 0.0 | 0.0 | 5.2 | 5.2 |
| 213 | | 13.00 | 1.80 | 1.50 | 0.00 | 0.00 | 0.00 | 0.00 | 1.50 | 5.2 | 1.6 | 1.0 | 9.3 | 0.0 | 0.0 | 0.0 | 0.0 | 7.8 | 7.8 |
| 214 | * | 12.00 | 1.80 | 2.00 | 0.00 | 0.00 | 0.00 | 0.00 | 2.00 | 5.2 | 1.6 | 1.0 | 9.3 | 0.0 | 0.0 | 0.0 | 0.0 | 10.4 | 10.4 |

| | | | | | | | | Magnetization curve | | | |
|---|---|---|---|---|---|---|---|---|---|---|---|
| | | | | | Magnetic permeability | | | Saturation | | Specific | Dielectric |
| | Composition ratio | Composite composition | | | at 6 GHz μ = μ′ − iμ″ | | | magnetization | Coercivity | resistance | constant |
| | [mol %] | amount [mol %] | | | | | tan δ | Is | Hcj | ρ | ε |
| No. | Fe | Me(II) | Me(IV) | D | μ′ | μ″ | μ″/μ′ | [mT] | [kA/m] | [Ω · m] | 1 GHz |
| 184 | 82.9 | 10.4 | 0.0 | 10.4 | 1.38 | 0.046 | 0.033 | 297 | [symbol] 2 | 2 × 10 [symbol] | 10 |
| 185 | 77.7 | 13.0 | 2.6 | 10.4 | 1.30 | 0.035 | 0.027 | 286 | 31 | 3 × 10 [symbol] | 9 |
| 186 | 72.5 | 15.5 | 5.2 | 10.4 | 0. [symbol] 1 | 0.345 | 0.379 | 147 | 102 | 3 × 10 [symbol] | 9 |
| 187 | 77.7 | 13.0 | 2. [symbol] | 10.4 | 1.31 | 0.011 | 0.002 | 287 | 13 | 3 × 10 [symbol] | 9 |
| 188 | 72.5 | 15.5 | 5.2 | 10.4 | 1.05 | 0.157 | 0.150 | 164 | 125 | 3 × 10 [symbol] | 9 |
| 189 | 77.7 | 13.0 | 2. [symbol] | 10.4 | 1.48 | 0.03 [symbol] | 0.02 [symbol] | 291 | 31 | 3 × 10 [symbol] | 9 |
| 190 | 72.5 | 15.5 | 5.2 | 10.4 | 1.96 | 0.0 [symbol] | 0.030 | 2 [symbol] 7 | 34 | 1 × 10 [symbol] | 9 |
| 191 | 67.4 | 18.1 | 7.8 | 10.4 | 1.75 | 0.105 | 0.0 [symbol] 0 | 231 | 45 | 2 × 10 [symbol] | 15 |
| 192 | 52.2 | 20.7 | 10.4 | 10.4 | 1.43 | 0.158 | 0.117 | 197 | [symbol] 9 | 8 × 10 [symbol] | 23 |
| 193 | 77.7 | 13.0 | 2. [symbol] | 10.4 | 1.33 | 0.03 [symbol] | 0.009 | 302 | 27 | 3 × 10 [symbol] | 9 |
| 194 | 72.5 | 15.5 | 5.2 | 10.4 | 1.04 | 0.23 [symbol] | 0.2 [symbol] | 154 | 109 | 3 × 10 [symbol] | 9 |
| 195 | 77.7 | 13.0 | 2. [symbol] | 10.4 | 1.47 | 0.0 [symbol] 7 | 0.025 | 290 | 26 | 3 × 10 [symbol] | 9 |
| 19 [symbol] | 72.5 | 15.5 | 5.2 | 10.4 | 1. [symbol] | 0.0 [symbol] 1 | 0.027 | 284 | 39 | 1 × 10 [symbol] | 9 |
| 197 | [symbol] 7.4 | 18.1 | 7. [symbol] | 10.4 | 1. [symbol] 9 | 0.078 | 0.045 | 267 | 44 | 2 × 10 [symbol] | 15 |
| 198 | [symbol] 2.2 | 20.7 | 10.4 | 10.4 | 1.34 | 0.123 | 0.0 [symbol] 2 | 24 [symbol] | 53 | [symbol] × 10 [symbol] | 23 |
| 1 [symbol] 9 | 77.7 | 13.0 | 2.6 | 10.4 | 1.44 | 0.045 | 0.031 | 274 | 31 | 3 × 10 [symbol] | 9 |
| 200 | 72.5 | 15.5 | 5.2 | 10.4 | 1.09 | 0.2 [symbol] | 0.2 [symbol] 5 | 209 | 100 | 3 × 10 [symbol] | 9 |
| 201 | 77.7 | 13.0 | 2.6 | 10.4 | 1.39 | 0.034 | 0.024 | 286 | 39 | 3 × 10 [symbol] | 9 |
| 202 | 72.5 | 15.5 | 5.2 | 10.4 | 1.08 | 0.315 | 0.292 | 251 | 180 | 3 × 10 [symbol] | 9 |
| 203 | [symbol] 0. [symbol] | 11.4 | 1.0 | 10.4 | 1.79 | 0.039 | 0.022 | 30 [symbol] | 32 | 3 × 10 [symbol] | 9 |
| 204 | 77.7 | 13.0 | 2. [symbol] | 10.4 | 2.37 | 0.041 | 0.017 | 321 | 21 | 2 × 10 [symbol] | 9 |
| 205 | 72.5 | 15.5 | 5.2 | 10.4 | 2. [symbol] | 0.047 | 0.018 | 354 | 13 | 3 × 10 [symbol] | 10 |
| 206 | [symbol] 7.4 | 1 [symbol] .1 | 7.8 | 10.4 | 2.51 | 0.121 | 0.048 | 326 | 10 | 4 × 10 [symbol] | 16 |
| 207 | [symbol] 2.2 | 20.7 | 10.4 | 10.4 | 2.34 | 0.302 | 0.129 | 291 | [symbol] | [symbol] × 10 [symbol] | 37 |
| 208 | 77.7 | 13.0 | 2. [symbol] | 10.4 | 1.42 | 0.046 | 0.034 | 275 | 30 | 3 × 10 [symbol] | 9 |
| 209 | 72.5 | 15.5 | 5.2 | 10.4 | 1.14 | 0.372 | 0.326 | 208 | 179 | 3 × 10 [symbol] | 9 |
| 210 | [symbol] 0. [symbol] | 11.4 | 1.0 | 10.4 | 1.71 | 0.041 | 0.024 | 2 [symbol] 9 | 2 [symbol] | 3 × 10 [symbol] | 9 |
| 211 | 77.7 | 13.0 | 2.0 | 10.4 | 2.11 | 0.0 [symbol] 3 | 0.025 | 282 | 20 | 3 × 10 [symbol] | 9 |
| 212 | 72.5 | 15.5 | 5.2 | 10.4 | 2.56 | 0.064 | 0.025 | 27 [symbol] | 13 | 1 × 10 [symbol] | 11 |
| 213 | 87.4 | 18.1 | 7.8 | 10.4 | 2.47 | 0.105 | 0.043 | 245 | 9 | 2 × 10 [symbol] | 14 |
| 214 | [symbol] 2.2 | 20.7 | 10.4 | 10.4 | 2.31 | 0.315 | 0.13 [symbol] | 210 | [symbol] | 4 × 10 [symbol] | 36 |

[symbol]

indicates data missing or illegible when filed

The composition, magnetic properties, and the like of the composition formula BaCa_{0.3}Co_{0.2}Zn_{1.8+x}MeₓFe₁₆₋₂ₓO_{27-δ} and the composition formula BaCa_{0.3}Co_{0.2}Zn_{1.8}NiₓMeₓFe₁₆₋₂ₓO_{27-δ} are shown in Table 12.

TABLE 12
Composition formula: BaCa [symbol] Co [symbol] Z [symbol] M [symbol] Fe [symbol] O [symbol] and composition formula: BaCa [symbol] Co [symbol] Zn [symbol] Ni [symbol] Me [symbol] Fe [symbol] O

[symbol]

| | | Composition formula [mol] | | | | | | | | | | | | | | | | | |
|---|---|---|---|---|---|---|---|---|---|---|---|---|---|---|---|---|---|---|---|
| | | | Me (II) element | | Me (IV) element | | | | | Composition ratio | | | | | | | | | |
| | | Fe | Zn | Ni | Ge | Si | S [symbol] | Ti | | [mol %] | | | | | | | | | |
| No. | | 16-2x | 1.8 [symbol] x | x | [symbol] | x | x | x | Z [symbol] | B [symbol] | Ca | Co | G [symbol] | Ni | Si | S [symbol] | Ti | Z [symbol] | Z [symbol] |
| 215 | | 1 [symbol] .00 | 1. [symbol] 0 | 0.00 | 0.00 | 0.00 | 0.00 | 0.00 | 0.00 | 5.2 | 1.6 | 1.0 | 0.0 | 0.0 | 0.0 | 0.0 | 0.0 | [symbol] .3 | 0.0 |
| 216 | | 15.00 | 2.30 | 0.00 | 0.50 | 0.00 | 0.00 | 0.00 | 0.00 | 5.2 | 1.6 | 1.0 | 2. [symbol] | 0.0 | 0.0 | 0.0 | 0.0 | 11. [symbol] | 0.0 |
| 217 | * | 14.00 | 2.80 | 0.00 | 1.00 | 0.00 | 0.00 | 0.00 | 0.00 | 5.2 | 1.6 | 1.0 | 5.2 | 0.0 | 0.0 | 0.0 | 0.0 | 14.5 | 0.0 |
| 218 | | 15.00 | 2.30 | 0.00 | 0.00 | 0.50 | 0.00 | 0.00 | 0.00 | 5.2 | 1. [symbol] | 1.0 | 0.0 | 0.0 | 2.6 | 0.0 | 0.0 | 11. [symbol] | 0.0 |
| 219 | * | 14.00 | 2.80 | 0.00 | 0.00 | 1.00 | 0.00 | 0.00 | 0.00 | 5.2 | 1.6 | 1.0 | 0.0 | 0.0 | 5.2 | 0.0 | 0.0 | 14.5 | 0.0 |
| 220 | | 15.00 | 2.30 | 0.00 | 0.00 | 0.00 | 0.50 | 0.00 | 0.00 | 5.2 | 1.6 | 1.0 | 0.0 | 0.0 | 0.0 | 2. [symbol] | 0.0 | 11.9 | 0.0 |
| 221 | | 14.00 | 2.80 | 0.00 | 0.00 | 0.00 | 1.00 | 0.00 | 0.00 | 5.2 | 1. [symbol] | 1.0 | 0.0 | 0.0 | 0.0 | 5.2 | 0.0 | 14.5 | 0.0 |
| 222 | | 13.00 | 3.30 | 0.00 | 0.00 | 0.00 | 1.50 | 0.00 | 0.00 | 5.2 | 1.6 | 1.0 | 0.0 | 0.0 | 0.0 | 7.8 | 0.0 | 17.1 | 0.0 |
| 223 | * | 12.00 | 3.80 | 0.00 | 0.00 | 0.00 | 2.00 | 0.00 | 0.00 | 5.2 | 1.6 | 1.0 | 0.0 | 0.0 | 0.0 | 10.4 | 0.0 | 1 [symbol] .7 | 0.0 |
| 224 | | 15.00 | 2.30 | 0.00 | 0.00 | 0.00 | 0.00 | 0.50 | 0.00 | 5.2 | 1.6 | 1.0 | 0.0 | 0.0 | 0.0 | 0.0 | 2. [symbol] | 11.9 | 0.0 |
| 225 | * | 14.00 | 2.80 | 0.00 | 0.00 | 0.00 | 0.00 | 1.00 | 0.00 | 5.2 | 1. [symbol] | 1.0 | 0.0 | 0.0 | 0.0 | 0.0 | 5.2 | 14.5 | 0.0 |
| 226 | | 15.00 | 2.30 | 0.00 | 0.00 | 0.00 | 0.00 | 0.00 | 0.50 | 5.2 | 1.6 | 1.0 | 0.0 | 0.0 | 0.0 | 0.0 | 0.0 | 11.9 | 2.6 |
| 227 | | 14.00 | 2.80 | 0.00 | 0.00 | 0.00 | 0.00 | 0.00 | 1.00 | 5.2 | 1.6 | 1.0 | 0.0 | 0.0 | 0.0 | 0.0 | 0.0 | 14.5 | 5.2 |
| 228 | | 13.00 | 3.30 | 0.00 | 0.00 | 0.00 | 0.00 | 0.00 | 1.50 | 5.2 | 1.6 | 1.0 | 0.0 | 0.0 | 0.0 | 0.0 | 0.0 | 17.1 | 7. [symbol] |
| 229 | * | 12.00 | 3.80 | 0.00 | 0.00 | 0.00 | 0.00 | 0.00 | 2.00 | 5.2 | 1.6 | 1.0 | 0.0 | 0.0 | 0.0 | 0.0 | 0.0 | 1 [symbol] .7 | 10.4 |
| 230 | | 15.00 | 1.80 | 0.50 | 0.50 | 0.00 | 0.00 | 0.00 | 0.00 | 5.2 | 1. [symbol] | 1.0 | 2. [symbol] | 2. [symbol] | 0.0 | 0.0 | 0.0 | 9.3 | 0.0 |
| 231 | * | 14.00 | 1. [symbol] 0 | 1.00 | 1.00 | 0.00 | 0.00 | 0.00 | 0.00 | 5.2 | 1.6 | 1.0 | 5.2 | 5.2 | 0.0 | 0.0 | 0.0 | 9.3 | 0.0 |
| 232 | | 15.00 | 1.80 | 0.50 | 0.00 | 0.50 | 0.00 | 0.00 | 0.00 | 5.2 | 1.6 | 1.0 | 0.0 | 2. [symbol] | 2. [symbol] | 0.0 | 0.0 | 9.3 | 0.0 |
| 233 | * | 14.00 | 1.80 | 1.00 | 0.00 | 1.00 | 0.00 | 0.00 | 0.00 | 5.2 | 1. [symbol] | 1.0 | 0.0 | 5.2 | 5.2 | 0.0 | 0.0 | 9.3 | 0.0 |
| 234 | | 15. [symbol] 0 | 1.80 | 0.20 | 0.00 | 0.00 | 0.20 | 0.00 | 0.00 | 5.2 | 1.6 | 1.0 | 0.0 | 1.0 | 0.0 | 1.0 | 0.0 | 9.3 | 0.0 |
| 235 | | 15.00 | 1.80 | 0.50 | 0.00 | 0.00 | 0.50 | 0.00 | 0.00 | 5.2 | 1.6 | 1.0 | 0.0 | 2. [symbol] | 0.0 | 2. [symbol] | 0.0 | 9.3 | 0.0 |
| 236 | | 14.00 | 1.80 | 1.00 | 0.00 | 0.00 | l.00 | 0.00 | 0.00 | 5.2 | 1.6 | 1.0 | 0.0 | 5.2 | 0.0 | 5.2 | 0.0 | 9.3 | 0.0 |
| 237 | | 13.00 | 1.80 | 1.50 | 0.00 | 0.00 | 1.50 | 0.00 | 0.00 | 5.2 | 1.6 | 1.0 | 0.0 | 7.8 | 0.0 | 7.8 | 0.0 | 9.3 | 0.0 |
| 238 | * | 12.00 | 1.80 | 2.00 | 0.00 | 0.00 | 2.00 | 0.00 | 0.00 | 5.2 | 1.6 | 1.0 | 0.0 | 10.4 | 0.0 | 10.4 | 0.0 | 9.3 | 0.0 |
| 23 [symbol] | | 15.00 | 1.80 | 0.50 | 0.00 | 0.00 | 0.00 | 0.50 | 0.00 | 5.2 | 1.6 | 1.0 | 0.0 | 2.6 | 0.0 | 0.0 | 2. [symbol] | 9.3 | 0.0 |
| 240 | * | 14.00 | 1.80 | 1.00 | 0.00 | 0.00 | 0.00 | 1.00 | 0.00 | 5.2 | 1.6 | 1.0 | 0.0 | 5.2 | 0.0 | 0.0 | 5.2 | 9.3 | 0.0 |
| 241 | | 15.80 | 1.80 | 0.20 | 0.00 | 0.00 | 0.00 | 0.00 | 0.20 | 5.2 | 1.6 | 1.0 | 0.0 | 1.0 | 0.0 | 0.0 | 0.0 | 9.3 | 1.0 |
| 242 | | 15.00 | 1.80 | 0.50 | 0.00 | 0.00 | 0.00 | 0.00 | 0.50 | 5.2 | 1.6 | 1.0 | 0.0 | 2. [symbol] | 0.0 | 0.0 | 0.0 | 9.3 | 2.8 |
| 243 | | 14.00 | 1.80 | 1.00 | 0.00 | 0.00 | 0.00 | 0.00 | 1.00 | 5.2 | 1.6 | 1.0 | 0.0 | [symbol] .2 | 0.0 | 0.0 | 0.0 | 9.3 | 5.2 |
| 244 | | 13.00 | 1.80 | 1.50 | 0.00 | 0.00 | 0.00 | 0.00 | 1.50 | 5.2 | 1.6 | 1.0 | 0.0 | 7.8 | 0.0 | 0.0 | 0.0 | 9.3 | 7 [symbol] |
| 245 | * | 12.00 | 1.80 | 2.00 | 0.00 | 0.00 | 0.00 | 0.00 | 2.00 | 5.2 | 1.6 | 1.0 | 0.0 | 10.4 | 0.0 | 0.0 | 0.0 | 9.3 | 10.4 |

| | | | | | | | | Magnetization curve | | | |
|---|---|---|---|---|---|---|---|---|---|---|---|
| | | | | | Magnetic permeability | | | Saturation | | Specific | Dielectric |
| | Composition ratio | Composite composition | | | at 6 GHz μ = μ′ − iμ″ | | | magnetization | Coercivity | resistance | constant |
| | [mol %] | amount [mol %] | | | | | tan δ | Is | Hcj | ρ | ε |
| No. | Fe | Me(II) | Me(IV) | D | μ′ | μ″ | μ″/μ′ | [mT] | [kA/m] | [Ω · m] | 1 GHz |
| 215 | 82. [symbol] | 10.4 | 0.0 | 10.4 | 1.45 | 0.013 | 0.00 [symbol] | 404 | 41 | 2 × 10 [symbol] | 10 |
| 216 | 77.7 | 13.0 | 2.6 | 10.4 | 1.34 | 0.015 | 0.011 | 38 [symbol] | 40 | 3 × 10 [symbol] | [symbol] |
| 217 | 72.5 | 15.5 | 5.2 | 10.4 | 1.05 | 0.2 [symbol] 4 | 0.270 | 216 | 106 | 3 × 10 [symbol] | 9 |
| 218 | 77.7 | 13.0 | 2. [symbol] | 10.4 | 1.42 | 0.014 | 0.002 | 3 [symbol] | 23 | 3 × 10 [symbol] | 9 |
| 219 | 72.5 | 15.5 | 5.2 | 10.4 | 0.97 | 0.15 [symbol] | 0.1 [symbol] 1 | 231 | 134 | 3 × 10 [symbol] | 9 |
| 220 | 77.7 | 13.0 | 2.6 | 10.4 | 1. [symbol] 2 | 0.015 | 0.010 | 3 [symbol] 5 | 33 | 3 × 10 [symbol] | 9 |
| 221 | 72.5 | 15.5 | 5.2 | 10.4 | 1. [symbol] 7 | 0.052 | 0.026 | 351 | 36 | 1 × 10 [symbol] | 9 |
| 222 | 67.4 | 18.1 | 7.8 | 10.4 | 1.76 | 0.104 | 0.05 [symbol] | 326 | 51 | 2 × 10 [symbol] | 1 [symbol] |
| 223 | 62.2 | 20.7 | 10.4 | 10.4 | 1.56 | 0.149 | 0.0 [symbol] | 268 | 79 | 8 × 10 [symbol] | 23 |
| 224 | 77.7 | 13.0 | 2.6 | 10.4 | 1.53 | 0.014 | 0.009 | 399 | 27 | 3 × 10 [symbol] | 9 |
| 225 | 72.5 | 15.5 | 5.2 | 10.4 | 1.08 | 0.245 | 0.231 | 216 | 110 | 3 × 10 [symbol] | 9 |
| 226 | 77.7 | 13.0 | 2.6 | 10.4 | 1. [symbol] | 0.017 | 0.010 | 3 [symbol] 9 | 27 | 3 × 10 [symbol] | 9 |
| 227 | 72.5 | 15.5 | 5.2 | 10.4 | 1.87 | 0.049 | 0.025 | 325 | 36 | 2 × 10 [symbol] | 9 |
| 228 | 67.4 | 18.1 | 7.8 | 10.4 | 1. [symbol] 4 | 0.08 [symbol] | 0.0 [symbol] 4 | 301 | 45 | 1 × 10 [symbol] | 9 |
| 229 | 82.2 | 20.7 | 10.4 | 10.4 | 1.4 [symbol] | 0.114 | 0.077 | 2 [symbol] 1 | [symbol] 2 | 4 × 10 [symbol] | 9 |
| 230 | 77.7 | 13.0 | 2. [symbol] | 10.4 | 1.79 | 0.048 | 0.027 | 376 | 34 | 3 × 10 [symbol] | 9 |
| 231 | 72.5 | 15.5 | 5.2 | 10.4 | 1.26 | 0.279 | 0.221 | 251 | 101 | 3 × 10 [symbol] | 9 |
| 232 | 77.7 | 13.0 | 2.6 | 10.4 | 1. [symbol] | 0.034 | 0.020 | 2 [symbol] 8 | 38 | 3 × 10 [symbol] | 9 |
| 233 | 72.5 | 15.5 | 5.2 | 10.4 | 1.25 | 0.3 [symbol] 1 | 0.2 [symbol] 1 | 249 | 179 | 3 × 10 [symbol] | 9 |
| 234 | 80. [symbol] | 11.4 | 1.0 | 10.4 | 1.87 | 0.015 | 0.004 | 3 [symbol] 4 | 33 | 3 × 10 [symbol] | 9 |
| 235 | 77.7 | 13.0 | 2.6 | 10.4 | 2.29 | 0.019 | 0.008 | 3 [symbol] | 22 | 2 × 10 [symbol] | 9 |
| 236 | 72.5 | 15.5 | 5.2 | 10.4 | 2. [symbol] 7 | 0.027 | 0.009 | 3 [symbol] 7 | 14 | 3 × 10 [symbol] | 10 |
| 237 | 67.4 | 18.1 | 7.8 | 10.4 | 2. [symbol] 1 | 0.10 [symbol] | 0.039 | 355 | 10 | 4 × 10 [symbol] | 16 |
| 238 | [symbol] 2.2 | 20.7 | 10.4 | 10.4 | 2. [symbol] 7 | 0.31 [symbol] | 0.107 | 311 | 7 | 6 × 10 [symbol] | 37 |
| 23 [symbol] | 77.7 | 13.0 | 2.6 | 10.4 | 1.67 | 0.051 | 0.031 | 374 | 36 | 3 × 10 [symbol] | 9 |
| 240 | 72.5 | 15.5 | 5.2 | 10.4 | 1.18 | 0.376 | 0.313 | 24 [symbol] | 1 [symbol] | 3 × 10 [symbol] | 9 |
| 241 | 80. [symbol] | 11.4 | 1.0 | 10.4 | 1.9 [symbol] | 0.013 | 0.007 | 3 [symbol] 2 | 29 | 3 × 10 [symbol] | 9 |
| 242 | 77.7 | 13.0 | 2.6 | 10.4 | 2.34 | 0.020 | 0.009 | 3 [symbol] | 21 | 3 × 10 [symbol] | 9 |
| 243 | 72.5 | 15.5 | 5.2 | 10.4 | 2.79 | 0.027 | 0.010 | 401 | 14 | 1 × 10 [symbol] | 11 |
| 244 | 67.4 | 18.1 | 7.8 | 10.4 | 2. [symbol] 2 | 0.121 | 0.04 [symbol] | 380 | 11 | 2 × 10 [symbol] | 14 |
| 245 | 62.2 | 20.7 | 10.4 | 10.4 | 2.51 | 0.329 | 0.131 | 315 | 5 | 4 × 10 [symbol] | 36 |

[symbol]

indicates data missing or illegible when filed

The composition, magnetic properties, and the like of the composition formula BaCa_{0.3}Co_{0.2}Mg_{1.8}(Fe₁₆₋ₓMeₓ)O_{27-δ} are shown in Table 13.

TABLE 13
Composition formula: BaCa_{0.3}Co_{0.2}Mg [symbol] (Fe [symbol] ₁₆₋ₓM [symbol] )O₂₇

[symbol]

| | | Composition formula [mol] | | | | | | | | | | | | | | |
|---|---|---|---|---|---|---|---|---|---|---|---|---|---|---|---|---|
| | | | Me (III) element | | | | Composition ratio | | | | | | | | | Composite composition |
| | | Fe | Al | Ga | In | S [symbol] | [mol %] | | | | | | | | | amount [mol %] |
| No. | | 16-x | x | x | x | x | Ba | Ca | Co | Mg | Al | Ga | In | S [symbol] | Fe | Me(II) |
| 246 | | 16.00 | 0.00 | 0.00 | 0.00 | 0.00 | 5.2 | 1.6 | 1.0 | 9.3 | 0.0 | 0.0 | 0.0 | 0.0 | 82.9 | 10.4 |
| 247 | | 15.50 | 0.50 | 0.00 | 0.00 | 0.00 | 5.2 | 1.6 | 1.0 | 9.3 | 2.6 | 0.0 | 0.0 | 0.0 | 80.3 | 10.4 |
| 248 | * | 15.00 | 1.00 | 0.00 | 0.00 | 0.00 | 5.2 | 1.6 | 1.0 | 9.3 | 5.2 | 0.0 | 0.0 | 0.0 | 77.7 | 10.4 |
| 249 | | 15.50 | 0.00 | 0.50 | 0.00 | 0.00 | 5.2 | 1.6 | 1.0 | 9.3 | 0.0 | 2.6 | 0.0 | 0.0 | 80.3 | 10.4 |
| 250 | * | 15.00 | 0.00 | 1.00 | 0.00 | 0.00 | 5.2 | 1.6 | 1.0 | 9.3 | 0.0 | 5.2 | 0.0 | 0.0 | 77.7 | 10.4 |
| 251 | | 15.80 | 0.00 | 0.00 | 0.20 | 0.00 | 5.2 | 1.6 | 1.0 | 9.3 | 0.0 | 0.0 | 1.0 | 0.0 | 81.9 | 10.4 |
| 252 | | 15.50 | 0.00 | 0.00 | 0.50 | 0.00 | 5.2 | 1.6 | 1.0 | 9.3 | 0.0 | 0.0 | 2. [symbol] | 0.0 | 80.3 | 10.4 |
| 253 | | 15.00 | 0.00 | 0.00 | 1.00 | 0.00 | 5.2 | 1.6 | 1.0 | 9.3 | 0.0 | 0.0 | 5.2 | 0.0 | 77.7 | 10.4 |
| 254 | | 14.50 | 0.00 | 0.00 | 1.50 | 0.00 | 5.2 | 1.6 | 1.0 | 9.3 | 0.0 | 0.0 | 7.8 | 0.0 | 75.1 | 10.4 |
| 255 | * | 14.00 | 0.00 | 0.00 | 2.00 | 0.00 | 5.2 | 1.6 | 1.0 | 9.3 | 0.0 | 0.0 | 10.4 | 0.0 | 72.5 | 10.4 |
| 256 | | 15.80 | 0.00 | 0.00 | 0.00 | 0.20 | 5.2 | 1.6 | 1.0 | 9.3 | 0.0 | 0.0 | 0.0 | 1.0 | 81.9 | 10.4 |
| 257 | | 15.50 | 0.00 | 0.00 | 0.00 | 0.50 | 5.2 | 1.6 | 1.0 | 9.3 | 0.0 | 0.0 | 0.0 | 2. [symbol] | 80.3 | 10.4 |
| 258 | | 15.00 | 0.00 | 0.00 | 0.00 | 1.00 | 5.2 | 1.6 | 1.0 | 9.3 | 0.0 | 0.0 | 0.0 | 5.2 | 77.7 | 10.4 |
| 259 | | 14.50 | 0.00 | 0.00 | 0.00 | 1.50 | 5.2 | 1.6 | 1.0 | 9.3 | 0.0 | 0.0 | 0.0 | 7.8 | 75.1 | 10.4 |
| 260 | * | 14.00 | 0.00 | 0.00 | 0.00 | 2.00 | 5.2 | 1.6 | 1.0 | 9.3 | 0.0 | 0.0 | 0.0 | 10.4 | 72.5 | 10.4 |

| | | | | | | Magnetization curve | | | |
|---|---|---|---|---|---|---|---|---|---|
| | | | Magnetic permeability | | | Saturation | | Specific | Dielectric |
| | Composite composition | | at 6 GHz μ = μ′ − iμ″ | | | magnetization | Coercivity | resistance | constant |
| | amount [mol %] | | | | tan δ | Is | Hcj | ρ | ε |
| No. | Me(IV) | D | μ′ | μ″ | μ″/μ′ | [mT] | [kA/m] | [Ω · m] | 1 GHz |
| 246 | 0.0 | 10.4 | 1.88 | 0.050 | 0.027 | 322 | 29 | 2 × 10 [symbol] | 10 |
| 247 | 0.0 | 10.4 | 1.41 | 0.044 | 0.031 | 304 | 39 | 3 × 10 [symbol] | 9 |
| 248 | 0.0 | 10.4 | 1.09 | 0.305 | 0.280 | 258 | 141 | 4 × 10 [symbol] | 9 |
| 249 | 0.0 | 10.4 | 1.39 | 0.061 | 0.044 | 306 | 51 | 3 × 10 [symbol] | 9 |
| 250 | 0.0 | 10.4 | 1.0 [symbol] | 0.318 | 0.294 | 249 | 134 | 4 × 10 [symbol] | 9 |
| 251 | 0.0 | 10.4 | 2.01 | 0.041 | 0.020 | 316 | 25 | 3 × 10 [symbol] | 9 |
| 252 | 0.0 | 10.4 | 2.29 | 0.079 | 0.034 | 299 | 22 | 4 × 10 [symbol] | 9 |
| 253 | 0.0 | 10.4 | 2.51 | 0.101 | 0.040 | 274 | 19 | 4 × 10 [symbol] | 9 |
| 254 | 0.0 | 10.4 | 2.16 | 0.126 | 0.058 | 236 | 14 | 3 × 10 [symbol] | 10 |
| 255 | 0.0 | 10.4 | 1.61 | 0.364 | 0.226 | 187 | 10 | 1 × 10 [symbol] | 15 |
| 256 | 0.0 | 10.4 | 1.91 | 0.051 | 0.027 | 318 | 24 | 3 × 10 [symbol] | 9 |
| 257 | 0.0 | 10.4 | 2.24 | 0.078 | 0.035 | 301 | 20 | 4 × 10 [symbol] | 9 |
| 258 | 0.0 | 10.4 | 2.49 | 0.098 | 0.039 | 264 | 16 | 4 × 10 [symbol] | 9 |
| 259 | 0.0 | 10.4 | 1.87 | 0.112 | 0.0 [symbol] 0 | 241 | 11 | 2 × 10 [symbol] | 10 |
| 260 | 0.0 | 10.4 | 1.49 | 0.344 | 0.231 | 197 | 7 | 9 × 10 [symbol] | 16 |

[symbol]

indicates data missing or illegible when filed

The composition, magnetic properties, and the like of the composition formula BaCa_{0.3}Co_{0.2}Mn_{1.8}(Fe₁₆₋ₓMeₓ)O_{27-δ} are shown in Table 14.

TABLE 14
Composition formula: BaCa_{0.3}Co_{0.2}Mn_{1.0}(Fe₁₆₋ₓMe [symbol] )O₂₇

[symbol]

| | | Composition formula [mol] | | | | | | | | | | | | | | |
|---|---|---|---|---|---|---|---|---|---|---|---|---|---|---|---|---|
| | | | Me (III) element | | | | Composition ratio | | | | | | | | | Composite composition |
| | | Fe | Al | Ga | In | Sc | [mol %] | | | | | | | | | amount [mol %] |
| No. | | 16-x | x | x | x | x | Ba | Ca | Co | Mn | Al | Ga | In | Sc | Fe | Me(II) |
| 261 | | 16.00 | 0.00 | 0.00 | 0.00 | 0.00 | 5.2 | 1.6 | 1.0 | 9.3 | 0.0 | 0.0 | 0.0 | 0.0 | 82.9 | 10.4 |
| 262 | | 15.50 | 0.50 | 0.00 | 0.00 | 0.00 | 5.2 | 1. [symbol] | 1.0 | 9.3 | 2.6 | 0.0 | 0.0 | 0.0 | 80.3 | 10.4 |
| 263 | * | 15.00 | 1.00 | 0.00 | 0.00 | 0.00 | 5.2 | 1.6 | 1.0 | 9.3 | 5.2 | 0.0 | 0.0 | 0.0 | 77.7 | 10.4 |
| 264 | | 15.50 | 0.00 | 0.50 | 0.00 | 0.00 | 5.2 | 1.6 | 1.0 | 9.3 | 0.0 | 2.6 | 0.0 | 0.0 | 80.3 | 10.4 |
| 265 | * | 15.00 | 0.00 | 1.00 | 0.00 | 0.00 | 5.2 | 1.6 | 1.0 | 9.3 | 0.0 | 5.2 | 0.0 | 0.0 | 77.7 | 10.4 |
| 266 | | 15.80 | 0.00 | 0.00 | 0.20 | 0.00 | 5.2 | 1.6 | 1.0 | 9.3 | 0.0 | 0.0 | 1.0 | 0.0 | 81.9 | 10.4 |
| 267 | | 15.50 | 0.00 | 0.00 | 0.50 | 0.00 | 5.2 | 1. [symbol] | 1.0 | 9.3 | 0.0 | 0.0 | 2.6 | 0.0 | 80.3 | 10.4 |
| 268 | | 15.00 | 0.00 | 0.00 | 1.00 | 0.00 | 5.2 | 1.6 | 1.0 | 9.3 | 0.0 | 0.0 | 5.2 | 0.0 | 77.7 | 10.4 |
| 269 | | 14.50 | 0.00 | 0.00 | 1.50 | 0.00 | 5.2 | 1.6 | 1.0 | 9.3 | 0.0 | 0.0 | 7.8 | 0.0 | 75.1 | 10.4 |
| 270 | * | 14.00 | 0.00 | 0.00 | 2.00 | 0.00 | 5.2 | 1.6 | 1.0 | 9.3 | 0.0 | 0.0 | 10.4 | 0.0 | 72.5 | 10.4 |
| 271 | | 15.80 | 0.00 | 0.00 | 0.00 | 0.20 | 5.2 | 1.6 | 1.0 | 9.3 | 0.0 | 0.0 | 0.0 | 1.0 | 81.9 | 10.4 |
| 272 | | 15.50 | 0.00 | 0.00 | 0.00 | 0.50 | 5.2 | 1.6 | 1.0 | 9.3 | 0.0 | 0.0 | 0.0 | 2.6 | 80.3 | 10.4 |
| 273 | | 15.00 | 0.00 | 0.00 | 0.00 | 1.00 | 5.2 | 1. [symbol] | 1.0 | 9.3 | 0.0 | 0.0 | 0.0 | 5.2 | 77.7 | 10.4 |
| 274 | | 14.50 | 0.00 | 0.00 | 0.00 | 1.50 | 5.2 | 1.6 | 1.0 | 9.3 | 0.0 | 0.0 | 0.0 | 7.8 | 75.1 | 10.4 |
| 275 | * | 14.00 | 0.00 | 0.00 | 0.00 | 2.00 | 5.2 | 1.6 | 1.0 | 9.3 | 0.0 | 0.0 | 0.0 | 10.4 | 72.5 | 10.4 |

| | | | | | | Magnetization curve | | | |
|---|---|---|---|---|---|---|---|---|---|
| | | | Magnetic permeability | | | Saturation | | Specific | Dielectric |
| | Composite composition | | at 6 GHz μ = μ′ − iμ″ | | | magnetization | Coercivity | resistance | constant |
| | amount [mol %] | | | | tan δ | Is | Hcj | ρ | ε |
| No. | Me(IV) | D | μ′ | μ″ | μ″/μ′ | [mT] | [kA/m] | [Ω · m] | 1 GHz |
| 261 | 0.0 | 10.4 | 1.62 | 0.00 [symbol] | 0.004 | 401 | 2 [symbol] | 2 × 10 [symbol] | 10 |
| 262 | 0.0 | 10.4 | 1.57 | 0.038 | 0.024 | 364 | 45 | 3 × 10 [symbol] | 9 |
| 263 | 0.0 | 10.4 | 1.28 | 0.264 | 0.206 | 315 | 151 | 4 × 10 [symbol] | 9 |
| 264 | 0.0 | 10.4 | 1.56 | 0.041 | 0.026 | 359 | 51 | 3 × 10 [symbol] | 9 |
| 265 | 0.0 | 10.4 | 1.21 | 0.310 | 0.256 | 312 | 312 | 4 × 10 [symbol] | 9 |
| 266 | 0.0 | 10.4 | 1.66 | 0.018 | 0.010 | 391 | 21 | 3 × 10 [symbol] | 9 |
| 267 | 0.0 | 10.4 | 1.98 | 0.067 | 0.034 | 364 | 18 | 4 × 10 [symbol] | 9 |
| 268 | 0.0 | 10.4 | 2.45 | 0.102 | 0.042 | 315 | 15 | 4 × 10 [symbol] | 9 |
| 269 | 0.0 | 10.4 | 2.01 | 0.116 | 0.058 | 265 | 12 | 3 × 10 [symbol] | 11 |
| 270 | 0.0 | 10.4 | 1.49 | 0.247 | 0.166 | 207 | 9 | 1 × 10 [symbol] | 17 |
| 271 | 0.0 | 10.4 | 1.81 | 0.015 | 0.008 | 389 | 22 | 3 × 10 [symbol] | 9 |
| 272 | 0.0 | 10.4 | 2.23 | 0.046 | 0.021 | 351 | 19 | 4 × 10 [symbol] | 9 |
| 273 | 0.0 | 10.4 | 2.51 | 0.089 | 0.035 | 312 | 14 | 4 × 10 [symbol] | 9 |
| 274 | 0.0 | 10.4 | 1.95 | 0.115 | 0.0 [symbol] | 267 | 11 | 2 × 10 [symbol] | 12 |
| 275 | 0.0 | 10.4 | 1.56 | 0.315 | 0.202 | 210 | 8 | 9 × 10 [symbol] | 18 |

[symbol]

indicates data missing or illegible when filed

The composition, magnetic properties, and the like of the composition formula BaCa_{0.3}Co_{0.2}Ni_{1.8}(Fe₁₆₋ₓMeₓ)O_{27-δ} are shown in Table 15.

TABLE 15
Composition formula: BaCa_{0.3}Co_{0.2}Ni [symbol] (Fe [symbol] Me [symbol] )O₂₇₋

[symbol]

| | | Composition formula [mol] | | | | | | | | | | | | | | |
|---|---|---|---|---|---|---|---|---|---|---|---|---|---|---|---|---|
| | | | Me (III) element | | | | Composition ratio | | | | | | | | | Composite composition |
| | | Fe | Al | Ga | In | Sc | [mol %] | | | | | | | | | amount [mol %] |
| No. | | 16-x | x | x | x | x | Ba | Ca | Co | Ni | Al | Ga | In | Sc | Fe | Me(II) |
| 276 | | 16.00 | 0.00 | 0.00 | 0.00 | 0.00 | 5.2 | 1.6 | 1.0 | 9.3 | 0.0 | 0.0 | 0.0 | 0.0 | 82.9 | 10.4 |
| 277 | | 15.50 | 0.50 | 0.00 | 0.00 | 0.00 | 5.2 | 1. [symbol] | 1.0 | 9.3 | 2.6 | 0.0 | 0.0 | 0.0 | 80.3 | 10.4 |
| 278 | * | 15.00 | 1.00 | 0.00 | 0.00 | 0.00 | 5.2 | 1.6 | 1.0 | 9.3 | 5.2 | 0.0 | 0.0 | 0.0 | 77.7 | 10.4 |
| 279 | | 15.50 | 0.00 | 0.50 | 0.00 | 0.00 | 5.2 | 1.6 | 1.0 | 9.3 | 0.0 | 2.6 | 0.0 | 0.0 | 80.3 | 10.4 |
| 280 | * | 15.00 | 0.00 | 1.00 | 0.00 | 0.00 | 5.2 | 1.6 | 1.0 | 9.3 | 0.0 | 5.2 | 0.0 | 0.0 | 77.7 | 10.4 |
| 281 | | 15.80 | 0.00 | 0.00 | 0.20 | 0.00 | 5.2 | 1.6 | 1.0 | 9.3 | 0.0 | 0.0 | 1.0 | 0.0 | 81.9 | 10.4 |
| 282 | | 15.50 | 0.00 | 0.00 | 0.50 | 0.00 | 5.2 | 1.6 | 1.0 | 9.3 | 0.0 | 0.0 | 2.6 | 0.0 | 80.3 | 10.4 |
| 283 | | 15.00 | 0.00 | 0.00 | 1.00 | 0.00 | 5.2 | 1.6 | 1.0 | 9.3 | 0.0 | 0.0 | 5.2 | 0.0 | 77.7 | 10.4 |
| 284 | | 14.50 | 0.00 | 0.00 | 1.50 | 0.00 | 5.2 | 1.6 | 1.0 | 9.3 | 0.0 | 0.0 | 7.8 | 0.0 | 75.1 | 10.4 |
| 285 | * | 14.00 | 0.00 | 0.00 | 2.00 | 0.00 | 5.2 | 1.6 | 1.0 | 9.3 | 0.0 | 0.0 | 10.4 | 0.0 | 72.5 | 10.4 |
| 286 | | 15.80 | 0.00 | 0.00 | 0.00 | 0.20 | 5.2 | 1.6 | 1.0 | 9.3 | 0.0 | 0.0 | 0.0 | 1.0 | 81.9 | 10.4 |
| 287 | | 15.50 | 0.00 | 0.00 | 0.00 | 0.50 | 5.2 | 1.6 | 1.0 | 9.3 | 0.0 | 0.0 | 0.0 | 2.6 | 80.3 | 10.4 |
| 288 | | 15.00 | 0.00 | 0.00 | 0.00 | 1.00 | 5.2 | 1.6 | 1.0 | 9.3 | 0.0 | 0.0 | 0.0 | 5.2 | 77.7 | 10.4 |
| 289 | | 14.50 | 0.00 | 0.00 | 0.00 | 1.50 | 5.2 | 1.6 | 1.0 | 9.3 | 0.0 | 0.0 | 0.0 | 7.8 | 75.1 | 10.4 |
| 290 | * | 14.00 | 0.00 | 0.00 | 0.00 | 2.00 | 5.2 | 1.6 | 1.0 | 9.3 | 0.0 | 0.0 | 0.0 | 10.4 | 72.5 | 10.4 |

| | | | | | | Magnetization curve | | | |
|---|---|---|---|---|---|---|---|---|---|
| | | | Magnetic permeability | | | Saturation | | Specific | Dielectric |
| | Composite composition | | at 6 GHz μ = μ′ − iμ″ | | | magnetization | Coercivity | resistance | constant |
| | amount [mol %] | | | | tan δ | Is | Hcj | ρ | ε |
| No. | Me(IV) | D | μ′ | μ″ | μ″/μ′ | [mT] | [kA/m] | [Ω · m] | 1 GHz |
| 276 | 0.0 | 10.4 | 1.38 | 0.048 | 0.033 | 297 | 92 | 2 × 10 [symbol] | 10 |
| 277 | 0.0 | 10.4 | 1.25 | 0.0 [symbol] 1 | 0.049 | 252 | 99 | 3 × 10 [symbol] | 9 |
| 278 | 0.0 | 10.4 | 1.08 | 0.357 | 0.331 | 191 | 204 | 4 × 10 [symbol] | 9 |
| 279 | 0.0 | 10.4 | 1.24 | 0.067 | 0.054 | 249 | 9 [symbol] | 3 × 10 [symbol] | 9 |
| 280 | 0.0 | 10.4 | 1.09 | 0.401 | 0.368 | 203 | 251 | 4 × 10 [symbol] | 9 |
| 281 | 0.0 | 10.4 | 1.56 | 0.030 | 0.019 | 289 | [symbol] 2 | 3 × 10 [symbol] | 9 |
| 282 | 0.0 | 10.4 | 1.78 | 0.068 | 0.038 | 261 | 48 | 4 × 10 [symbol] | 9 |
| 283 | 0.0 | 10.4 | 2.26 | 0.094 | 0.042 | 240 | 34 | 4 × 10 [symbol] | 10 |
| 284 | 0.0 | 10.4 | 2.01 | 0.101 | 0.050 | 15 [symbol] | 27 | 3 × 10 [symbol] | 16 |
| 285 | 0.0 | 10.4 | 1.89 | 0.216 | 0.114 | 109 | 21 | 1 × 10 [symbol] | 23 |
| 286 | 0.0 | 10.4 | 1.52 | 0.02 [symbol] | 0.019 | 284 | 66 | 3 × 10 [symbol] | 9 |
| 287 | 0.0 | 10.4 | 1.86 | 0.059 | 0.032 | 265 | 49 | 4 × 10 [symbol] | 9 |
| 288 | 0.0 | 10.4 | 2.27 | 0.111 | 0.049 | 241 | 32 | 4 × 10 [symbol] | 10 |
| 289 | 0.0 | 10.4 | 2.12 | 0.120 | 0.0 [symbol] 7 | 171 | 27 | 2 × 10 [symbol] | 15 |
| 290 | 0.0 | 10.4 | 1.94 | 0.214 | 0.110 | 111 | 17 | 9 × 10 [symbol] | 24 |

[symbol]

indicates data missing or illegible when filed

The composition, magnetic properties, and the like of the composition formula BaCa_{0.3}Co_{0.2}Zn_{1.8}(Fe₁₆₋ₓMeₓ)O_{27-δ} are shown in Table 16.

TABLE 16
Composition formula: BaCa_{0.3}Co_{0.2}Zn_{1.0}(Fe₁₆₋ₓMe [symbol] )O

[symbol]

| | | Composition formula [mol] | | | | | | | | | | | | | | |
|---|---|---|---|---|---|---|---|---|---|---|---|---|---|---|---|---|
| | | | Me (III) element | | | | Composition ratio | | | | | | | | | Composite composition |
| | | Fe | Al | Ga | In | Sc | [mol %] | | | | | | | | | amount [mol %] |
| No. | | 16-x | x | x | x | x | Ba | Ca | Co | Zn | Al | Ga | In | Sc | Fe | Me(II) |
| 291 | | 16.00 | 0.00 | 0.00 | 0.00 | 0.00 | 5.2 | 1.6 | 1.0 | 9.3 | 0.0 | 0.0 | 0.0 | 0.0 | 82.9 | 10.4 |
| 292 | | 15.50 | 0.50 | 0.00 | 0.00 | 0.00 | 5.2 | 1.6 | 1.0 | 9.3 | 2.6 | 0.0 | 0.0 | 0.0 | 80.3 | 10.4 |
| 293 | * | 15.00 | 1.00 | 0.00 | 0.00 | 0.00 | 5.2 | 1.6 | 1.0 | 9.3 | 5.2 | 0.0 | 0.0 | 0.0 | 77.7 | 10.4 |
| 294 | | 15.50 | 0.00 | 0.50 | 0.00 | 0.00 | 5.2 | 1. [symbol] | 1.0 | 9.3 | 0.0 | 2.6 | 0.0 | 0.0 | 80.3 | 10.4 |
| 295 | * | 15.00 | 0.00 | 1.00 | 0.00 | 0.00 | 5.2 | 1.6 | 1.0 | 9.3 | 0.0 | 5.2 | 0.0 | 0.0 | 77.7 | 10.4 |
| 296 | | 15.80 | 0.00 | 0.00 | 0.20 | 0.00 | 5.2 | 1.6 | 1.0 | 9.3 | 0.0 | 0.0 | 1.0 | 0.0 | 81.9 | 10.4 |
| 297 | | 15.50 | 0.00 | 0.00 | 0.50 | 0.00 | 5.2 | 1.6 | 1.0 | 9.3 | 0.0 | 0.0 | 2.6 | 0.0 | 80.3 | 10.4 |
| 298 | | 15.00 | 0.00 | 0.00 | 1.00 | 0.00 | 5.2 | 1.6 | 1.0 | 9.3 | 0.0 | 0.0 | 5.2 | 0.0 | 77.7 | 10.4 |
| 299 | | 14.50 | 0.00 | 0.00 | 1.50 | 0.00 | 5.2 | 1.6 | 1.0 | 9.3 | 0.0 | 0.0 | 7.8 | 0.0 | 75.1 | 10.4 |
| 300 | * | 14.00 | 0.00 | 0.00 | 2.00 | 0.00 | 5.2 | 1.6 | 1.0 | 9.3 | 0.0 | 0.0 | 10.4 | 0.0 | 72.5 | 10.4 |
| 301 | | 15.80 | 0.00 | 0.00 | 0.00 | 0.20 | 5.2 | 1.6 | 1.0 | 9.3 | 0.0 | 0.0 | 0.0 | 1.0 | 81.9 | 10.4 |
| 302 | | 15.50 | 0.00 | 0.00 | 0.00 | 0.50 | 5.2 | 1.6 | 1.0 | 9.3 | 0.0 | 0.0 | 0.0 | 2. [symbol] | 80.3 | 10.4 |
| 303 | | 15.00 | 0.00 | 0.00 | 0.00 | 1.00 | 5.2 | 1.6 | 1.0 | 9.3 | 0.0 | 0.0 | 0.0 | 5.2 | 77.7 | 10.4 |
| 304 | | 14.50 | 0.00 | 0.00 | 0.00 | 1.50 | 5.2 | 1.6 | 1.0 | 9.3 | 0.0 | 0.0 | 0.0 | 7.8 | 75.1 | 10.4 |
| 305 | * | 14.00 | 0.00 | 0.00 | 0.00 | 2.00 | 5.2 | 1.6 | 1.0 | 9.3 | 0.0 | 0.0 | 0.0 | 10.4 | 72.5 | 10.4 |

| | | | | | | Magnetization curve | | | |
|---|---|---|---|---|---|---|---|---|---|
| | | | Magnetic permeability | | | Saturation | | Specific | Dielectric |
| | Composite composition | | at 6 GHz μ = μ′ − iμ″ | | | magnetization | Coercivity | resistance | constant |
| | amount [mol %] | | | | tan δ | Is | Hcj | ρ | ε |
| No. | Me(IV) | D | μ′ | μ″ | μ″/μ′ | [mT] | [kA/m] | [Ω · m] | 1 GHz |
| 291 | 0.0 | 10.4 | 1.45 | 0.013 | 0.009 | 404 | 41 | 2 × 10 [symbol] | 10 |
| 292 | 0.0 | 10.4 | 1.37 | 0.04 [symbol] | 0.036 | 354 | 38 | 3 × 10 [symbol] | 9 |
| 293 | 0.0 | 10.4 | 1.19 | 0.264 | 0.222 | 304 | 131 | 4 × 10 [symbol] | 9 |
| 294 | 0.0 | 10.4 | 1.36 | 0.051 | 0.038 | 349 | 45 | 3 × 10 [symbol] | 9 |
| 295 | 0.0 | 10.4 | 1.16 | 0.310 | 0.267 | 299 | 130 | 4 × 10 [symbol] | 9 |
| 296 | 0.0 | 10.4 | 1.50 | 0.026 | 0.017 | 3 [symbol] 1 | 39 | 3 × 10 [symbol] | 9 |
| 297 | 0.0 | 10.4 | 1.56 | 0.033 | 0.021 | 352 | 32 | 4 × 10 [symbol] | 9 |
| 298 | 0.0 | 10.4 | 2.49 | 0.101 | 0.041 | 306 | 20 | 4 × 10 [symbol] | 10 |
| 299 | 0.0 | 10.4 | 1.98 | 0.118 | 0.060 | 306 | 15 | 3 × 10 [symbol] | 16 |
| 300 | 0.0 | 10.4 | 1. [symbol] 1 | 0.254 | 0.168 | 199 | 11 | 1 × 10 [symbol] | 25 |
| 301 | 0.0 | 10.4 | 1.53 | 0.016 | 0.010 | 379 | 36 | 3 × 10 [symbol] | 9 |
| 302 | 0.0 | 10.4 | 1.60 | 0.021 | 0.013 | 345 | 33 | 4 × 10 [symbol] | 9 |
| 303 | 0.0 | 10.4 | 2.50 | 0.144 | 0.057 | 303 | 18 | 4 × 10 [symbol] | 10 |
| 304 | 0.0 | 10.4 | 2.01 | 0.116 | 0.058 | 256 | 12 | 2 × 10 [symbol] | 16 |
| 305 | 0.0 | 10.4 | 1.54 | 0.310 | 0.202 | 201 | 8 | 9 × 10 [symbol] | 24 |

[symbol]

indicates data missing or illegible when filed

The composition, magnetic properties, and the like of the composition formula SrCa_{0.3}Co_{0.2}Me_{1.8}Fe₂ₘO_{27-δ} are shown in Table 17.

TABLE 17
Composition formula: SrCa₀ [symbol] Co_{0.2}Me [symbol] Fe [symbol] O₂₇₋

[symbol]

| | | Composition formula | | | | | | | | | | | | | | |
|---|---|---|---|---|---|---|---|---|---|---|---|---|---|---|---|---|
| | | [mol] | | | | | Composition ratio | | | | | | | | Composite composition | |
| | | | | | | Fe | [mol %] | | | | | | | | amount [mol %] | |
| No. | | Mg | Mn | Ni | Zn | m | Sr | Ca | Co | Mg | Mn | Ni | Zn | Fe | Me(II) | Me(IV) |
| 306 | * | 1.80 | 0.00 | 0.00 | 0.00 | 6.50 | 6.1 | 1.8 | 1.2 | 11.0 | 0.0 | 0.0 | 0.0 | 79.8 | 12.3 | 0.0 |
| 307 | | 1.80 | 0.00 | 0.00 | 0.00 | 7.00 | 5.8 | 1.7 | 1.2 | 10.4 | 0.0 | 0.0 | 0.0 | 80.9 | 11.6 | 0.0 |
| 308 | | 1.80 | 0.00 | 0.00 | 0.00 | 8.00 | 5.2 | 1.6 | 1.0 | 9.3 | 0.0 | 0.0 | 0.0 | 82.9 | 10.4 | 0.0 |
| 309 | | 1.80 | 0.00 | 0.00 | 0.00 | 8.50 | 4.9 | 1.5 | 1.0 | 8.9 | 0.0 | 0.0 | 0.0 | 83.7 | 9.9 | 0.0 |
| 310 | * | 1.80 | 0.00 | 0.00 | 0.00 | 9.00 | 4.7 | 1.4 | 0.9 | 8. [symbol] | 0.0 | 0.0 | 0.0 | 84.5 | 9.4 | 0.0 |
| 311 | * | 0.00 | 1.80 | 0.00 | 0.00 | 6.50 | 6.1 | 1. [symbol] | 1.2 | 0.0 | 11.0 | 0.0 | 0.0 | 79.8 | 12.3 | 0.0 |
| 312 | | 0.00 | 1.80 | 0.00 | 0.00 | 7.00 | 5.8 | 1.7 | 1.2 | 0.0 | 10.4 | 0.0 | 0.0 | 80.9 | 11.6 | 0.0 |
| 313 | | 0.00 | 1.80 | 0.00 | 0.00 | 8.00 | 5.2 | 1.6 | 1.0 | 0.0 | 9.3 | 0.0 | 0.0 | 82.9 | 10.4 | 0.0 |
| 314 | | 0.00 | 1.80 | 0.00 | 0.00 | 8.50 | 4.9 | 1.5 | 1.0 | 0.0 | 8.9 | 0.0 | 0.0 | 83.7 | 9.9 | 0.0 |
| 315 | * | 0.00 | 1.80 | 0.00 | 0.00 | 9.00 | 4.7 | 1.4 | 0.9 | 0.0 | 8.5 | 0.0 | 0.0 | 84.5 | 9.4 | 0.0 |
| 316 | * | 0.00 | 0.00 | 1.80 | 0.00 | 6.50 | 6.1 | 1. [symbol] | 1.2 | 0.0 | 0.0 | 11.0 | 0.0 | 79.8 | 12.3 | 0.0 |
| 317 | | 0.00 | 0.00 | 1.80 | 0.00 | 7.00 | 5.8 | 1.7 | 1.2 | 0.0 | 0.0 | 10.4 | 0.0 | 80.9 | 11.6 | 0.0 |
| 318 | | 0.00 | 0.00 | 1.80 | 0.00 | 8.00 | 5.2 | 1. [symbol] | 1.0 | 0.0 | 0.0 | 9.3 | 0.0 | 82.9 | 10.4 | 0.0 |
| 319 | | 0.00 | 0.00 | 1.80 | 0.00 | 8.50 | 4.9 | 1.5 | 1.0 | 0.0 | 0.0 | 8.9 | 0.0 | 83.7 | 9.9 | 0.0 |
| 320 | * | 0.00 | 0.00 | 1.80 | 0.00 | 9.00 | 4.7 | 1.4 | 0.9 | 0.0 | 0.0 | 8.5 | 0.0 | 84.5 | 9.4 | 0.0 |
| 321 | * | 0.00 | 0.00 | 0.00 | 1.80 | 6.50 | [symbol] .1 | 1.8 | 1.2 | 0.0 | 0.0 | 0.0 | 11.0 | 79.8 | 12.3 | 0.0 |
| 322 | | 0.00 | 0.00 | 0.00 | 1.80 | 7.00 | 5.8 | 1.7 | 1.2 | 0.0 | 0.0 | 0.0 | 10.4 | 80.9 | 11.6 | 0.0 |
| 323 | | 0.00 | 0.00 | 0.00 | 1.80 | 8.00 | 5.2 | 1.8 | 1.0 | 0.0 | 0.0 | 0.0 | 9.3 | 82.9 | 10.4 | 0.0 |
| 324 | | 0.00 | 0.00 | 0.00 | 1.80 | 8.50 | 4.9 | 1.5 | 1.0 | 0.0 | 0.0 | 0.0 | 8.9 | 83.7 | 9.9 | 0.0 |
| 325 | * | 0.00 | 0.00 | 0.00 | 1.80 | 9.00 | 4.7 | 1.4 | 0.9 | 0.0 | 0.0 | 0.0 | 8.5 | 84.5 | 9.4 | 0.0 |

| | | | | | Magnetization curve | | | |
|---|---|---|---|---|---|---|---|---|
| | | Magnetic permeability | | | Saturation | | Specific | Dielectric |
| | Composite composition | at 6 GHz μ = μ′ − iμ″ | | | magnetization | Coercivity | resistance | constant |
| | amount [mol %] | | | tan δ | Is | Hcj | ρ | ε |
| No. | D | μ′ | μ″ | μ″/μ′ | [mT] | [kA/m] | [Ω · m] | 1 GHz |
| 305 | 12.3 | 1.48 | 0.198 | 0.134 | 311 | 121 | 1 × 10⁷ | 79 |
| 307 | 11.6 | 1.78 | 0.101 | 0.057 | 313 | 39 | 8 × 10⁷ | 3 [symbol] |
| 308 | 10.4 | 1.89 | 0.09 [symbol] | 0.049 | 316 | 23 | 5 × 10⁷ | 33 |
| 309 | 9.9 | 1.67 | 0.101 | 0.060 | 349 | 32 | 3 × 10⁶ | 34 |
| 310 | 9.4 | 1.20 | 0.312 | 0.260 | 378 | 102 | 2 × 10⁸ | 61 |
| 311 | 12.3 | 1.14 | 0.089 | 0.078 | 379 | 123 | 1 × 10⁷ | 64 |
| 312 | 11.6 | 1.33 | 0.048 | 0.036 | 381 | 39 | 8 × 10⁷ | 40 |
| 313 | 10.4 | 1.62 | 0.012 | 0.007 | 387 | 33 | 5 × 10⁷ | 31 |
| 314 | 9.9 | 1.49 | 0.078 | 0.052 | 406 | 32 | 3 × 10 [symbol] | 45 |
| 315 | 9.4 | 1.22 | 0.297 | 0.243 | 419 | 106 | 2 × 10 [symbol] | 64 |
| 316 | 12.3 | 1.10 | 0.122 | 0.111 | 281 | 157 | 1 × 10⁷ | 94 |
| 317 | 11.6 | 1.30 | 0.077 | 0.059 | 283 | 94 | 8 × 10⁷ | 51 |
| 318 | 10.4 | 1.3 [symbol] | 0.078 | 0.057 | 284 | 87 | 5 × 10⁷ | 32 |
| 319 | 9.9 | 1.29 | 0.078 | 0.060 | 304 | 95 | 3 × 10 [symbol] | 61 |
| 320 | 9.4 | 1.08 | 0.315 | 0.292 | 315 | 122 | 2 × 10 [symbol] | 105 |
| 321 | 12.3 | 1.11 | 0.167 | 0.150 | 359 | 119 | 1 × 10⁷ | 67 |
| 322 | 11.6 | 1.35 | 0.051 | 0.03 [symbol] | 388 | 55 | 8 × 10⁷ | 3 [symbol] |
| 323 | 10.4 | 1.44 | 0.026 | 0.018 | 391 | 47 | 5 × 10⁷ | 33 |
| 324 | 9.9 | 1.36 | 0.067 | 0.049 | 409 | 57 | 3 × 10⁸ | 37 |
| 325 | 9.4 | 1.09 | 0.254 | 0.233 | 418 | 112 | 2 × 10 [symbol] | 5 [symbol] |

[symbol]

indicates data missing or illegible when filed

The composition, magnetic properties, and the like of the composition formula BaCa_{0.3}Co_{0.2}Ni_{1.8+2x}MeₓFe₁₆₋₃ₓO_{27-δ} are shown in Table 18.

TABLE 18
Composition formula: BaCa [symbol] Co [symbol] Ni [symbol] M [symbol] Fe [symbol] O

[symbol]

| | | Composition formula [mol] | | | | | | | | | | | | | | | |
|---|---|---|---|---|---|---|---|---|---|---|---|---|---|---|---|---|---|
| | | Me (V) element | | | | | Composition ratio | | | | | | | | | | Composite composition |
| | | M [symbol] | N [symbol] | S [symbol] | W | V | [mol %] | | | | | | | | | | amount [mol %] |
| No. | | x | x | x | x | x | Ba | Ca | Co | Ni | Mo | Nb + Ta | S [symbol] | W | V | Fe | Me(II) |
| 326 | | 0.00 | 0.00 | 0.00 | 0.00 | 0.00 | 5.2 | 1.6 | 1.0 | 9.3 | 0.0 | 0.0 | 0.0 | 0.0 | 0.0 | 82.9 | 10.4 |
| 327 | | 0.50 | 0.00 | 0.00 | 0.00 | 0.00 | 5.2 | 1.6 | 1.0 | 14.5 | 2.6 | 0.0 | 0.0 | 0.0 | 0.0 | 75.1 | 15.5 |
| 328 | * | 1.00 | 0.00 | 0.00 | 0.00 | 0.00 | 5.2 | 1.6 | 1.0 | 19.7 | 5.2 | 0.0 | 0.0 | 0.0 | 0.0 | 67.4 | 20.7 |
| 329 | | 0.00 | 0.50 | 0.00 | 0.00 | 0.00 | 5.2 | 1.6 | 1.0 | 14.5 | 0.0 | 2.6 | 0.0 | 0.0 | 0.0 | 7 [symbol] .1 | 1 [symbol] .5 |
| 330 | * | 0.00 | 1.00 | 0.00 | 0.00 | 0.00 | 5.2 | 1.6 | 1.0 | 19.7 | 0.0 | 5.2 | 0.0 | 0.0 | 0.0 | 67.4 | 20.7 |
| 331 | | 0.00 | 0.00 | 0.50 | 0.00 | 0.00 | 5.2 | 1.6 | 1.0 | 14.5 | 0.0 | 0.0 | 2.6 | 0.0 | 0.0 | 75.1 | 15.5 |
| 332 | * | 0.00 | 0.00 | 1.00 | 0.00 | 0.00 | 5.2 | 1.6 | 1.0 | 19.7 | 0.0 | 0.0 | 5.2 | 0.0 | 0.0 | 67.4 | 20.7 |
| 333 | | 0.00 | 0.00 | 0.00 | 0.50 | 0.00 | 5.2 | 1.6 | 1.0 | 14.5 | 0.0 | 0.0 | 0.0 | 2.6 | 0.0 | 75.1 | 15.5 |
| 334 | * | 0.00 | 0.00 | 0.00 | 1.00 | 0.00 | 5.2 | 1.6 | 1.0 | 19.7 | 0.0 | 0.0 | 0.0 | 5.2 | 0.0 | [symbol] 7.4 | 20.7 |
| 335 | | 0.00 | 0.00 | 0.00 | 0.00 | 0.50 | 5.2 | 1.6 | 1.0 | 14.5 | 0.0 | 0.0 | 0.0 | 0.0 | 2. [symbol] | 75.1 | 1 [symbol] .5 |
| 336 | * | 0.00 | 0.00 | 0.00 | 0.00 | 1.00 | 5.2 | 1.6 | 1.0 | 19.7 | 0.0 | 0.0 | 0.0 | 0.0 | 5.2 | 67.4 | 20.7 |

| | | | | | | | Magnetization curve | | | |
|---|---|---|---|---|---|---|---|---|---|---|
| | | | | Magnetic permeability | | | Saturation | | Specific | Dielectric |
| | Composite composition | | | at 6 GHz μ = μ′ − iμ″ | | | magnetization | Coercivity | resistance | constant |
| | amount [mol %] | | | | | tan δ | Is | Hcj | ρ | ε |
| No. | Me(IV) | Me(V) | D | μ′ | μ″ | μ″/μ′ | [mT] | [kA/m] | [Ω · m] | 1 GHz |
| 326 | 0.0 | 0.0 | 10.4 | 1.38 | 0.04 [symbol] | 0.033 | 2 [symbol] 7 | 92 | 2 × 10 [symbol] | 10 |
| 327 | 0.0 | 2.6 | 10.4 | 1.31 | 0.07 [symbol] | 0.056 | 274 | [symbol] 4 | 3 × 10 [symbol] | 9 |
| 328 | 0.0 | 5.2 | 10.4 | 1.09 | 0.240 | 0.220 | 254 | 211 | 4 × 10 [symbol] | 76 |
| 329 | 0.0 | 2.6 | 10.4 | 1.29 | 0.068 | 0.0 [symbol] 3 | 277 | 95 | 3 × 10 [symbol] | 9 |
| 330 | 0.0 | 5.2 | 10.4 | 1.0 [symbol] | 0.344 | 0.31 [symbol] | 2 [symbol] 2 | 2 [symbol] 2 | [symbol] × 10 [symbol] | [symbol] 8 |
| 331 | 0.0 | 2.6 | 10.4 | 1.31 | 0.071 | 0.0 [symbol] 4 | 278 | 89 | 3 × 10 [symbol] | 9 |
| 332 | 0.0 | 5.2 | 10.4 | 1.07 | 0.221 | 0.207 | 255 | 204 | 2 × 10 [symbol] | [symbol] 1 |
| 333 | 0.0 | 2.6 | 10.4 | 1.29 | 0.0 [symbol] | 0.0 [symbol] 3 | 279 | 91 | 3 × 10 [symbol] | 9 |
| 334 | 0.0 | 5.2 | 10.4 | 1.06 | 0.115 | 0.106 | 258 | 224 | 1 × 10 [symbol] | 59 |
| 335 | 0.0 | 2.6 | 10.4 | 1.1 [symbol] | 0.0 [symbol] | 0.0 [symbol] 6 | 275 | [symbol] 2 | 3 × 10 [symbol] | 9 |
| 336 | 0.0 | 5.2 | 10.4 | 0.97 | 0.744 | 0.767 | 150 | 345 | 8 × 10 [symbol] | 84 |

[symbol]

indicates data missing or illegible when filed

The composition, magnetic properties, and the like of the composition formula BaCa_{0.3}Co_{0.2}Ni_{1.8}LiₓFe₁₆₋₃ₓSn₂ₓO_{27-δ} are shown in Table 19.

TABLE 19
Composition formula: BaCa_{0.3}Co_{0.2}Ni_{1.8}LiₓFe₁₆₋₃ₓSn₂ [symbol] O₂₇₋

[symbol]

| | | Composition | | | | | | | | | | | |
|---|---|---|---|---|---|---|---|---|---|---|---|---|---|
| | | formula | | | | | | | | | | | |
| | | [mol] | Composition ratio | | | | | | | Composite composition | | | |
| | | Li | [mol % ] | | | | | | | amount [mol %] | | | |
| No. | | x | Ba | Ca | Co | Ni | Li | Sn | Fe | Me(I) | Me(II) | Me(IV) | D |
| 337 | | 0.00 | 5.2 | 1.6 | 1.0 | 9.3 | 0.0 | 0.0 | 82.9 | 0.0 | 10.4 | 0.0 | 10.4 |
| 338 | | 0.50 | 5.2 | 1.6 | 1.0 | 9.3 | 2.6 | 5.2 | 75.1 | 2.6 | 10.4 | 5.2 | 7.8 |
| 339 | * | 1.00 | 5.2 | 1.6 | 1.0 | 9.3 | 5.2 | 10.4 | 67.4 | 5.2 | 10.4 | 10.4 | 5.2 |

| | | | | Magnetization curve | | | |
|---|---|---|---|---|---|---|---|
| | Magnetic permeability | | | Saturation | | Specific | Dielectric |
| | at 6 GHz μ = μ′ − iμ″ | | | magnetization | Coercivity | resistance | constant |
| | | | tan δ | Is | Hcj | ρ | ε |
| No. | μ′ | μ″ | μ″/μ′ | [mT] | [kA/m] | [Ω · m] | 1 GHz |
| 337 | 1.38 | 0.046 | 0.033 | 297 | 92 | 2 × 10 [symbol] | 10 |
| 338 | 2.01 | 0.061 | 0.030 | 279 | 85 | 3 × 10 [symbol] | 9 |
| 339 | 1.49 | 0.180 | 0.121 | 251 | 204 | 4 × 10⁴ | 65 |

[symbol]

indicates data missing or illegible when filed

The composition, magnetic properties, and the like of the composition formula (Ba₁₋ₓLaₓ)Ca_{0.3}(Co_{0.2}Ni_{1.8}Li_{0.5x})Fe_{16-0.5x}O_{27-δ} are shown in Table 20.

TABLE 20
Composition formula: (Ba [symbol] Laₓ)Ca_{0.3}(Co_{0.2}Ni_{1.8}Li [symbol] )Fe₁₆₋ [symbol] ₓO₂₇₋

[symbol]

| | | Composition | | | | | | | | | | | | |
|---|---|---|---|---|---|---|---|---|---|---|---|---|---|---|
| | | formula | | Composition ratio | | | | | | | | | | |
| | | [mol] | | [mol %] | | | | | | | Composite composition | | | |
| | | La | Li | Ba | | | | La | Li | | amount [mol %] | | | |
| No. | | x | 0.5x | 1-x | Ca | Co | Ni | x | 0.5x | Fe | Me(I) | Me(II) | Me(IV) | D |
| 340 | | 0.00 | 0.00 | 5.2 | 1.6 | 1.0 | 9.3 | 0.0 | 0.0 | 82.9 | 0.0 | 10.4 | 0.0 | 10.4 |
| 341 | | 0.20 | 0.10 | 4.1 | 1.6 | 1.0 | 9.3 | 1.0 | 0.5 | 82.4 | 0.5 | 10.4 | 0.0 | 10.9 |
| 342 | | 0.40 | 0.20 | 3.1 | 1.6 | 1.0 | 9.3 | 2.1 | 1.0 | 81.9 | 1.0 | 10.4 | 0.0 | 11.4 |
| 343 | * | 0.50 | 0.25 | 2.6 | 1.6 | 1.0 | 9.3 | 2.6 | 1.3 | 81.6 | 1.3 | 10.4 | 0.0 | 11.7 |

| | | | | Magnetization curve | | | |
|---|---|---|---|---|---|---|---|
| | Magnetic permeability | | | Saturation | | Specific | Dielectric |
| | at 6 GHz μ = μ′ − iμ″ | | | magnetization | Coercivity | resistance | constant |
| | | | tan δ | Is | Hcj | ρ | ε |
| No. | μ′ | μ″ | μ″/μ′ | [mT] | [kA/m] | [Ω · m] | 1 GHz |
| 340 | 1.38 | 0.046 | 0.033 | 297 | 92 | 2 × 10 [symbol] | 10 |
| 341 | 1.83 | 0.050 | 0.027 | 294 | 78 | 2 × 10 [symbol] | 10 |
| 342 | 1.71 | 0.060 | 0.035 | 284 | 89 | 1 × 10 [symbol] | 12 |
| 343 | 1.56 | 0.150 | 0.096 | 251 | 201 | 1 × 10 [symbol] | 75 |

[symbol]

indicates data missing or illegible when filed

The composition, magnetic properties, and the like of the composition formula (Ba₁₋ₓMeₓ)Ca_{0.3}Co_{0.2}Ni_{1.8}(Fe₁₆₋ₓSnₓ)O_{27-δ} are shown in Table 21.

TABLE 21
Composition formula: (Ba [symbol] Meₓ)Ca_{0.3}Co_{0.2}Ni [symbol] (Fe [symbol] Snₓ)O₂₇

[symbol]

| | Composition | | | | | | | | | | | | | | |
|---|---|---|---|---|---|---|---|---|---|---|---|---|---|---|---|
| | formula [mol] | | Composition ratio | | | | | | | | | | | | |
| | Me element | | [mol %] | | | | | | | | Composite composition amount | | | | |
| | Na | K | Ba | | | | Na | K | | | [mol %] | | | | |
| No. | x | x | [symbol] -x | Ca | Co | Ni | x | x | Sn | Fe | Me(I) | Me(II) | Me(IV) | Me(V) | D |
| 344 | 0.00 | 0.00 | 5.2 | 1.6 | 1.0 | 9.3 | 0.0 | 0.0 | 0.0 | 82.9 | 0.0 | 10.4 | 0.0 | 0.0 | 10.4 |
| 345 | 0.50 | 0.00 | 2.6 | 1.6 | 1.0 | 9.3 | 2.6 | 0.0 | 2.6 | 80.3 | 2.6 | 10.4 | 2.6 | 0.0 | 10.4 |
| 346 | 1.00 | 0.00 | 0.0 | 1.6 | 1.0 | 9.3 | 5.2 | 0.0 | 5.2 | 77.7 | 5.2 | 10.4 | 5.2 | 0.0 | 10.4 |
| 347 | 0.00 | 0.50 | 2.6 | 1.6 | 1.0 | 9.3 | 0.0 | 2.8 | 2.6 | 80.3 | 2.6 | 10.4 | 2.6 | 0.0 | 10.4 |
| 348 | 0.00 | 1.00 | 0.0 | 1.6 | 1.0 | 9.3 | 0.0 | 5.2 | 5.2 | 77.7 | 5.2 | 10.4 | 5.2 | 0.0 | 10.4 |

| | | | | Magnetization curve | | | |
|---|---|---|---|---|---|---|---|
| | Magnetic permeability | | | Saturation | | Specific | Dielectric |
| | at 6 GHz μ = μ′ − iμ″ | | | magnetization | Coercivity | resistance | constant |
| | | | tan δ | Is | Hcj | ρ | ε |
| No. | μ′ | μ″ | μ″/μ′ | [mT] | [kA/m] | [Ω · m] | 1 GHz |
| 344 | 1.38 | 0.046 | 0.033 | 297 | 92 | 2 × 10 [symbol] | 10 |
| 345 | 1.46 | 0.040 | 0.027 | 294 | 89 | 7 × 10⁷ | 14 |
| 346 | 1.58 | 0.050 | 0.032 | 291 | 94 | 5 × 10⁷ | 34 |
| 347 | 1.36 | 0.040 | 0.029 | 2 [symbol] 3 | 97 | 3 × 10⁷ | 16 |
| 348 | 1.29 | 0.050 | 0.039 | 289 | 86 | 4 × 10⁷ | 35 |

[symbol]

indicates data missing or illegible when filed

As shown in Tables 9 to 16 among Tables 5 to 21, when Fe is partly substituted with at least one of the nonmagnetic elements M_{2d}=In, Sc, Sn, Zr, and Hf, substitution with which is likely to occur on the five-coordinate sites of the W-type hexagonal ferrite, the magnetic permeability can be greatly increased from the maximum value 2.12 in the case of not being substituted with the above elements to the maximum value 3.15 in the case of being substituted with the above elements.

On the other hand, when substitution with other nonmagnetic elements is performed, effects similar to those of Example 1 are obtained.

The frequency characteristics of the magnetic permeability μ in the composition formulas (Ba₁₋ₓSrₓ)Ca_{0.3}Mn_{1.8}Co_{0.2}Fe₁₆O₂₇ (x=0 or 1.0) and (Ba_{1-y}Bi_{y})Ca_{0.3}Mn_{1.8+y}Co_{0.2}Fe_{16-y}O₂₇ (y=0 or 0.2) are shown in FIG. 21, and the frequency characteristics of the magnetic loss tan δ in the composition formulas (Ba₁₋ₓSrₓ)Ca_{0.3}Mn_{1.8}Co_{0.2}Fe₁₆O₂₇ (x=0 or 1.0) and (Ba_{1-y}Bi_{y})Ca_{0.3}Mn_{1.8+y}Co_{0.2}Fe_{16-y}O₂₇ (y=0 or 0.2) are shown in FIG. 22.

In FIGS. 21 and 22, the case where x=0 and y=0 are No. 79 in Table 5, x=1.0 is No. 81 in Table 5, and y=0.2 is No. 82 in Table 5.

From FIGS. 21 and 22, it is considered that there is almost no difference in the magnetic permeability μ′ and in the magnetic loss tan δ due to the total substitution of Ba sites with Sr and the partial substitution of Ba sites with Bi.

The frequency characteristics of the magnetic permeability μ and the magnetic loss tan δ in the composition formula BaCa_{0.3}Mn_{1.8-x}CuₓCo_{0.2}Fe₁₆O₂₇ (x=0 or 0.3) are shown in FIG. 23.

In FIG. 23, the case where x=0 is No. 98 in Table 6, and x=0.3 is No. 99 in Table 6.

From FIG. 23, it is considered that the magnetic permeability was decreased due to partial substitution of Mn sites with Cu.

The frequency characteristics of the magnetic permeability μ and the magnetic loss tan δ in the composition formula BaCa_{0.3}Mn_{1.8-y}Ni_{y}Co_{0.2}Fe₁₆O₂₇ (y=0 or 0.9) are shown in FIG. 24.

In FIG. 24, the case where y=0 is No. 111 in Table 7, and y=0.9 is No. 110 in Table 7.

From FIG. 24, it is considered that there is almost no difference in the magnetic permeability and in the magnetic loss tan δ due to partial substitution of Mn sites with Ni.

The frequency characteristics of the magnetic permeability μ in the composition formula BaCa_{0.3}Mn_{1.8-x}Co_{0.2}ZnₓFe₁₆O₂₇ (x=0, 0.5, or 0.9) are shown in FIG. 25, and the frequency characteristics of the magnetic loss tan δ in the composition formula BaCa_{0.3}Mn_{1.8-x}Co_{0.2}ZnₓFe₁₆O₂₇ (x=0, 0.5, or 0.9) are shown in FIG. 26.

In FIGS. 25 and 26, the case where x=0 is No. 119 in Table 8, x=0.5 is No. 118 in Table 8, and x=0.9 is No. 117 in Table 4.

As seen from FIG. 25, the magnetic permeability μ′ at 6 GHz slightly decreased due to partial substitution of Mn sites with Zn. From FIG. 26, it is considered that by partial substitution of Mn sites with Zn, the magnetic loss tan δ≤0.06 at 6 GHz is satisfied, and the minimum frequency showing the magnetic loss tan δ≤0.06 can be reduced from 2.3 GHz to 1.1 GHz.

The frequency characteristics of the magnetic permeability μ in the composition formula BaCa_{0.3}Mn_{1.8+x}Co_{0.2}Fe₁₆₋₂ₓMeₓO₂₇ (x=0 or 0.5, Me=Si or Ti) are shown in FIG. 27, and the frequency characteristics of the magnetic loss tan δ in the composition formula BaCa_{0.3}Mn_{1.8+x}Co_{0.2}Fe₁₆₋₂ₓMeₓO₂₇ (x=0 or 0.5, Me=Si or Ti) are shown in FIG. 28.

In FIGS. 27 and 28, the case where x=0 is No. 153 in Table 10, x=0.5, Me=Si is No. 156 in Table 10, x=0.5, and Me=Ti is No. 162 in Table 10.

From FIGS. 27 and 28, it is considered that there is almost no difference in the magnetic permeability μ′ and in the magnetic loss tan δ due to partial substitution with Si or Ti.

The frequency characteristics of the magnetic permeability μ and the magnetic loss tan δ in the composition formula BaCa_{0.3}Mn_{1.8+x}Co_{0.2}Fe₁₆₋₂ₓZrₓO₂₇ (x=0 or 1) are shown in FIG. 29.

In FIG. 29, the case where x=0 is No. 153 in Table 10, and x=1 is No. 165 in Table 10.

As seen from FIG. 29, by substitution with Zr alone, the magnetic permeability μ′ can be increased, but the magnetic loss tan δ at 3 to 6 GHz is also increased. Since the magnetic permeability μ′ is substantially equal in the case of the addition of Si or Ti in FIG. 27, it is considered that the addition of Zr has an effect to increase magnetic permeability.

The magnetization curve in the composition formula BaCa_{0.3}Mn_{1.8}Co_{0.2}ZnₓSnₓFe₁₆₋₂ₓ O₂₇ (x=1.0, No. 174 in Table 10) is shown in FIG. 30.

As seen from FIG. 30, it is a soft magnetic material having a low coercivity, unlike the permanent magnet material or the magnetic recording material which have been frequently reported for the W-type hexagonal ferrite.

The frequency characteristics of the magnetic permeability μ in the composition formula BaCa_{0.3}Mn_{1.8}Co_{0.2}ZnₓSnₓFe₁₆₋₂ₓO₂₇ (x=0, 1.0, or 2.0) are shown in FIG. 31, and the frequency characteristics of the magnetic loss tan δ in the composition formula BaCa_{0.3}Mn_{1.8}Co_{0.2}ZnₓSnₓFe₁₆₋₂ₓO₂₇ (x=0, 1.0, or 2.0) are shown in FIG. 32.

In FIGS. 31 and 32, the case where x=0 is No. 153 in Table 10, x=1.0 is No. 174 in Table 10, and x=2.0 is No. 176 in Table 10.

As seen from FIG. 31, it is possible to double the magnetic permeability μ′ at 6 GHz by composite substitution of Fe sites with Zn and Sn.

As seen from FIG. 32, when the ZnSn composite substitution amount is increased from x=0 mol to x=1 mol, the magnetic loss tan δ at 3 to 6 GHz can be suppressed to 0.06 or less. When the ZnSn composite substitution amount is increased to x=2 mol, the magnetic loss tan δ becomes 0.06 or more, and the loss cannot be suppressed.

The frequency characteristics of the magnetic permeability μ in the composition formula BaCa_{0.3}Ni_{1.8}Co_{0.2}Fe₁₆₋ₓScₓO₂₇ (x=0, 0.2, or 1.0) are shown in FIG. 33, and the frequency characteristics of the magnetic loss tan δ in the composition formula BaCa_{0.3}Ni_{1.8}Co_{0.2}Fe₁₆₋ₓScₓO₂₇ (x=0, 0.2, or 1.0) are shown in FIG. 34.

In FIGS. 33 and 34, the case where x=0 is No. 276 in Table 15, x=0.2 is No. 286 in Table 15, and x=1.0 is No. 288 in Table 15.

As seen from FIG. 33, when the amount of Sc is increased, the magnetic permeability μ′ at 6 GHz can be increased, but the frequency at which the magnetic permeability is attenuated decreases.

As seen from FIG. 34, when substitution with Sc is not performed, the magnetic loss tan δ can be suppressed to 0.06 or less up to 20 GHz. When the Sc amount is increased, the frequency at which the magnetic loss tan δ starts to increase is reduced to 13 GHz for the Sc amount x=0.2 and 6 GHz for the Sc amount x=1.0.

The frequency characteristics of the magnetic permeability μ in the composition formula BaCa_{0.3}Zn_{1.8}Co_{0.2}Fe₁₆₋ₓScₓO₂₇ (x=0, 0.5, or 1.0) are shown in FIG. 35, and the frequency characteristics of the magnetic loss tan δ in the composition formula BaCa_{0.3}Zn_{1.8}Co_{0.2}Fe₁₆₋ₓScₓO₂₇ (x=0, 0.5, or 1.0) are shown in FIG. 36.

In FIGS. 35 and 36, the case where x=0 is No. 291 in Table 16, x=0.5 is No. 302 in Table 16, and x=1.0 is No. 303 in Table 16.

As seen from FIG. 35, when the amount of Sc is increased, the magnetic permeability μ′ at 6 GHz can be increased, but the frequency at which the magnetic permeability is attenuated decreases.

As seen from FIG. 36, when substitution with Sc is not performed, the magnetic loss tan δ can be suppressed to 0.06 or less up to 20 GHz. When the Sc amount is increased, the frequency at which the magnetic loss tan δ starts to increase is reduced to 13 GHz for the Sc amount x=0.2 and 6 GHz for the Sc amount x=1.0.

### Example 3-1

A winding coil can be produced from the calcined powder prepared in Example 1 or Example 2.

FIG. 37 is a perspective view schematically showing an example of the winding coil.

The winding coil 10 shown in FIG. 37 includes a core 11 as a magnetic body. A conductive wire 12 is spirally wound on the core 11. The core 11 includes a body portion 13 around which the conductive wire 12 is wound, and projecting portions 14 and 15 positioned at both end portions of the body portion 13. The projecting portions 14 and 15 have shapes projecting upward and downward from the body portion 13. Terminal electrodes 16 and 17 are formed on the lower surfaces of the projecting portions 14 and 15 by plating or the like, respectively. Although not shown, both end portions of the conductive wire 12 are fixed to the terminal electrodes 16 and 17, respectively, by thermal welding.

In a 500 cc pot made of polyester material, 80 g of the calcined powder of hexagonal ferrite prepared in Example 1 or 2, 60 to 100 g of pure water, 2 to 4 g of ammonium polycarboxylate as a dispersant, and 1000 g of 1 to 5 mmφ PSZ media are placed, and pulverized for 70 to 100 hours in a ball mill at a rotation speed of 100 to 200 rpm to obtain a slurry of finer particles. To the slurry of finer particles, 5 to 15 g of a binder having a molecular weight of 5000 to 30000 is added, and the mixture is dried with a spray granulator to obtain a granular powder. This powder is press-molded so as to form the core shape of the winding coil shown in FIG. 37 to obtain a workpiece.

The workpiece is placed on a zirconia setter, and heated in the atmosphere at a temperature ramp rate of 0.1 to 0.5° C./min and a maximum temperature of 400° C. for a maximum temperature holding time of 1 to 2 hours to thermally decompose and remove the binder and the like, and then firing is performed in the atmosphere at a firing temperature selected from 900 to 1400° C. at which the magnetic loss component at 6 GHz is minimized at a temperature ramp rate of 1 to 5° C./min for a maximum temperature holding time of 1 to 10 hours (oxygen concentration: about 21%) to obtain a sintered body.

As shown in FIG. 37, electrodes are formed on the substrate contact surface of the core-shaped sintered body, a copper wire is then wound around the core portion of the sintered body, and both ends of the copper wire are soldered to the electrodes formed on the substrate contact surface to produce a winding coil.

In the case of an air-core coil in which the winding has three turns and a magnetic body coil in which the magnetic body sample of No. 174 in Table 10 is used as the winding core and the winding has two turns, the frequency characteristic of the inductance L are shown in FIG. 38 and the frequency characteristic of Q of the coil are shown in FIG. 39.

As seen from FIG. 38, the inductance L shows a peak value at 4.2 GHz and rapidly decreases on the high frequency side in the air-core coil, but the frequency showing the peak value can be increased to 6.3 GHz in the case of the magnetic body sample. The inductance L values at 3 to 4 GHz are close values, and it is considered that the number of turns can be reduced by using a magnetic body as a winding core.

As seen from FIG. 39, by using the magnetic body sample as a winding core, the Q can be made higher than that of the air-core coil at 3 to 6 GHz, and the peak frequency of Q can be made higher. It is considered that the effect of decreasing the stray capacitance of the coil by reducing the number of turns is high.

### Example 3-2

The structure of the coil component is not limited to the winding coil, and the effect of high inductance L and high Q can be obtained also in a coil component such as a multilayer coil.

FIG. 40 is a transparent perspective view schematically showing an example of the multilayer coil.

The multilayer coil 20 shown in FIG. 40 includes a magnetic body 21. In the magnetic body 21, a coil-shaped internal electrode 23 electrically connected via through holes 22 is formed. External electrodes 24 and 25 electrically connected to the coil-shaped internal electrode 23 are formed on the surface of the magnetic body 21.

A sheet is produced in the same manner as in Example 1, and a coil is printed on a portion of the sheet, and then a pressure-bonded body is produced. The pressure-bonded body is fired in the same manner as in Example 3-1 to obtain a sintered body. The surface of the sintered body is subjected to barrel finishing to expose both end portions of the electrode, and then external electrodes are formed and baked to produce a multilayer coil having the shape shown in FIG. 40.

FIG. 41 is a transparent perspective view schematically showing another example of the multilayer coil.

A multilayer coil 20A shown in FIG. 41 includes a core portion 21A at the center and a winding portion 21B around the core portion. The core portion 21A is made of a magnetic body. The winding portion 21B is desirably composed of a nonmagnetic body and the coil-shaped internal electrode 23, but may be composed of a magnetic body and the coil-shaped internal electrode 23. In the winding portion 21B, a coil-shaped internal electrode 23 electrically connected via through holes 22 is formed. External electrodes 24 and 25 electrically connected to the coil-shaped internal electrode 23 are formed on the surface of the winding portion 21B.

In a 500 cc pot made of polyester material, 80 g of the calcined powder of hexagonal ferrite prepared in Example 1 or 2, 60 to 100 g of pure water, 2 to 4 g of ammonium polycarboxylate as a dispersant, and 1000 g of 1 to 5 mmφ PSZ media are placed, and pulverized for 70 to 100 hours in a ball mill at a rotation speed of 100 to 200 rpm to obtain a slurry of finer particles. To the slurry of finer particles, 5 to 15 g of a binder having a molecular weight of 5000 to 30000 is added, and by passing the slurry through a three-roll mill for pulverization, there is obtained a paste. This paste is poured into only the core portion 21A of the multilayer coil 20A shown in FIG. 41, and dried to lose fluidity, thereby producing a multilayer coil.

The winding portion 21B of the multilayer coil 20A shown in FIG. 41 is made of a nonmagnetic body having a low dielectric constant, and a magnetic body is inserted only in the core portion 21A, so that a stray capacitance component between windings can be reduced, and an inductance component due to the magnetic body can be used. Thus, by increasing the LC resonant frequency, it is possible to function as a wideband inductor.

### Example 4

The soft magnetic composition of the present invention can be used not only for coil component applications that function as inductors, but also for antenna applications that transmit and receive radio waves and that are required to have high magnetic permeability and low magnetic loss tan δ.

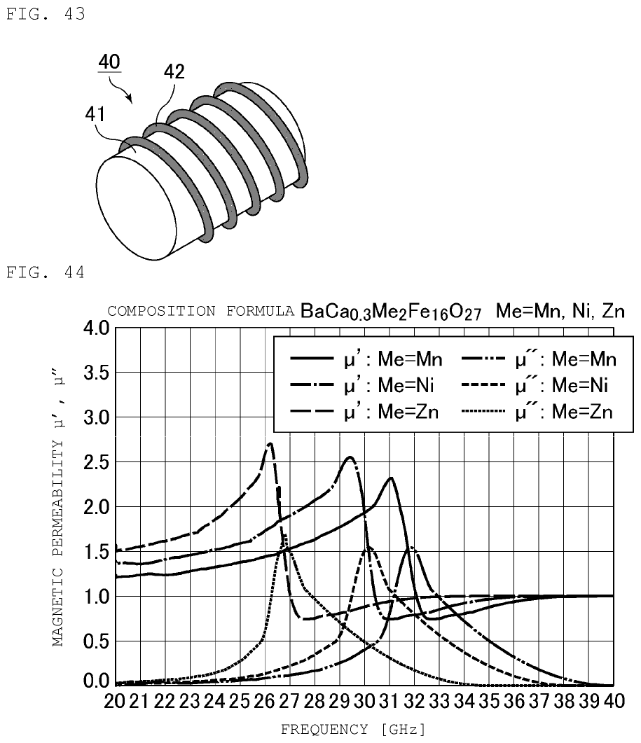

FIG. 42 is a perspective view schematically showing an example of an antenna.

In an antenna 30 shown in FIG. 42, a ring-shaped magnetic body 31 is disposed on a part or all of a metal antenna wire 32. The antenna can be miniaturized due to the wavelength shortening effect of the magnetic body.

The granular W-type hexagonal ferrite magnetic powder obtained by the spray granulator is press-molded into a ring shape to obtain a ring-shaped workpiece. The workpiece is placed on a zirconia setter, and heated in the atmosphere at a temperature ramp rate of 0.1 to 0.5° C./min and a maximum temperature of 400° C. for a maximum temperature holding time of 1 to 2 hours to thermally decompose and remove the binder and the like, and then firing is performed in the atmosphere at a firing temperature selected from 900 to 1400° C. at which the magnetic loss component at 6 GHz is minimized at a temperature ramp rate of 1 to 5° C./min for a maximum temperature holding time of 1 to 10 hours (oxygen concentration: about 21%) to obtain a ring-shaped magnetic body 31. A metal antenna wire 32 is passed through a hole of the ring-shaped magnetic body 31 to form an electric wire.

FIG. 43 is a perspective view schematically showing another example of the antenna.

In an antenna 40 shown in FIG. 43, a coil-shaped metal antenna wire 42 is wound around a magnetic body 41. The antenna can be miniaturized due to the wavelength shortening effect of the magnetic body.

### Example 5

In a communication market such as 5G which is a mobile information communication standard, ETC, and Wi-Fi of a 5 GHz band, it is assumed to be used in a range of about 4 to 6 GHz, and there is also a noise filter application in which it is desired to protect a circuit from these signals. In the noise filter made of only a magnetic body, since the loss component of the magnetic permeability μ′ at 4 to 6 GHz is too low, there is a limit in achieving both noise absorption performance and miniaturization. By using the inductor of the present invention and forming an LC resonance circuit in combination with a capacitor, it is possible to enhance a noise absorption effect near a resonant frequency as compared with a noise filter using only a magnetic body, and it is possible to achieve both noise absorption performance and miniaturization.

### Example 6

In the preparation method of Example 1, the composition, magnetic properties, and the like of the composition formula BaCa_{0.3}Me₂Fe₁₆O_{27-δ} (Me=Mn, Ni, or Zn) are shown in Table 22.

TABLE 22
Composition formula B [symbol] C [symbol] M [symbol] Fe [symbol] O [symbol] M [symbol] M [symbol] N

[symbol]

| | Composition | | | | | | | | | | | | | | | | | |
|---|---|---|---|---|---|---|---|---|---|---|---|---|---|---|---|---|---|---|
| | formula | | | | | Composition ratio | | | | | | Magnetic permeability | | | Magnetic permeability | | | |
| | [mol] | Me element [mol] | | | | [mol %] | | | | | | at 6 GHz μ = μ′ − [symbol] μ″ | | | at 20 GHz [symbol] | | | |
| No | B [symbol] | Mg | M [symbol] | Ni | Z [symbol] | [symbol] | C [symbol] | M [symbol] | Ni | Zn | F [symbol] | μ′ | μ″ | [symbol] | [symbol] | [symbol] | [symbol] | [symbol] |
| 34 [symbol] | 1.0 | 0.0 | 2.0 | 0.0 | 0.0 | [symbol] .2 | 1.6 | 10.4 | 0.0 | 0.0 | [symbol] 2.9 | 1.2 [symbol] | 0.0 [symbol] 1 | 0.0 [symbol] 1 | 1.21 | 0.001 | 0.001 | 1.2 |
| 350 | 1.0 | 0.0 | 0.0 | 2.0 | 0.0 | [symbol] .2 | 1.6 | 0.0 | 10.4 | 0.0 | [symbol] 2.9 | 1.26 | 0.033 | 0.02 [symbol] | 1.39 | 0.018 | 0.013 | 1.4 |
| 351 | 1.0 | 0.0 | 0.0 | 0.0 | 2.0 | [symbol] .2 | 1.6 | 0.0 | 0.0 | 10.4 | [symbol] 2.9 | 1.27 | 0.012 | 0.010 | 1.57 | 0. [symbol] 11 | 0.007 | 1.8 |

| | | | | | | | | | Magnetization curve | | | |
|---|---|---|---|---|---|---|---|---|---|---|---|---|
| | | | | | | | | | Saturation | | Specific | Dielectric |
| | Magnetic permeability | | | | Magnetic permeability | | | | [symbol] | Coercivity | resistance | constant |
| | at 25 GHz [symbol] | | | | at 30 GHz [symbol] | | | | Is | Hcj | ρ | ε |
| No | [symbol] | [symbol] | [symbol] | [symbol] | [symbol] | [symbol] | [symbol] | [symbol] | [mT] | [kA/m] | [Ω · m] | 1 [symbol] Hz |
| 349 | 1.3 [symbol] | 0.0 [symbol] | 0.043 | 1.4 | 1. [symbol] 3 | 0.402 | 0.20 [symbol] | 2.0 | 370 | 44 | 2 × 10 [symbol] | 3 [symbol] |
| 350 | 1. [symbol] | 0.0 [symbol] | 0.0 [symbol] 4 | 1.6 | 1.87 | 1.5 [symbol] | 0. [symbol] | 2.4 | 2 [symbol] 2 | 1 [symbol] | 2 × 10 [symbol] | [symbol] 3 |
| 351 | 2.1 [symbol] | 0.273 | 0.130 | 2.1 | 0. [symbol] | 0.4 [symbol] | 0. [symbol] 2 | 1.0 | 38 [symbol] | 69 | [symbol] × 10 [symbol] | 33 |

[symbol]

indicates data missing or illegible when filed

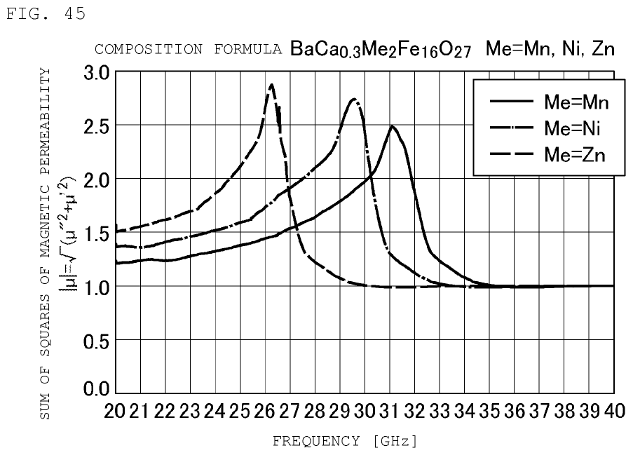

The frequency characteristics of the magnetic permeability μ in the composition formula BaCa_{0.3}Me₂Fe₁₆O₂₇ (Me=Mn, Ni, or Zn) are shown in FIG. 44, and the frequency characteristics of the sum of squares of the magnetic permeability: |μ|=√{μ″²+μ′²} in the composition formula BaCa_{0.3}Me₂Fe₁₆O₂₇ (Me=Mn, Ni, or Zn) are shown in FIG. 45.

In FIGS. 44 and 45, the case where Me=Mn is No. 349 in Table 22, Me=Ni is No. 350 in Table 22, and Me=Zn is No. 351 in Table 22.

As seen from FIG. 44 and Table 22, the magnetic permeability of the case where Me is any of Mn, Ni, and Zn was μ′>1.20 up to 20 GHz, and it was possible to achieve a magnetic permeability higher than that of the nonmagnetic body. The magnetic permeability had a maximum value at 31 GHz for Me=Mn, 29 GHz for Me=Ni, and 26 GHz for Me=Zn. The complex component of the magnetic permeability has a maximum value at 32 GHz for Me=Mn, 30 GHz for Me=Ni, and 27 GHz for Me=Zn, and it is considered that a natural resonance phenomenon has occurred.

The frequency characteristic of the sum of squares of the magnetic permeability are shown in FIG. 45 because it is considered that the sum of squares of the magnetic permeability: |μ|=√{μ″²+μ′²}>2.0 is desirable to increase the impedance Z, assuming it is an RL series circuit, in order to function independently as a noise filter and a radio wave absorber. With regard to the impedance Z, it is assumed that there is a relationship of Z=(R+ωL″)+jωL′ wherein R is a DC resistance, ω is an angular frequency, and inductance L=L′−jL″, assuming it is an RL series circuit. As seen from Table 22, in the composition formula BaCa_{0.3}Me₂Fe₁₆O₂₇ (Me=Mn, Ni, or Zn), the case where Me=Zn at 25 GHz and the case where Me=Mn or Ni at 30 GHz satisfy |μ|>2. Thus, it is considered that properties capable of functioning as a noise filter and a radio wave absorber at 25 GHz or 30 GHz which is a millimeter wave range were shown. As seen from FIG. 45, the sum of squares of the magnetic permeability: |μ| had a maximum value at 31 GHz for Me=Mn, 29 GHz for Me=Ni, and 26 GHz for Me=Zn.

In the communication market of the millimeter wave band of 5G, which is a mobile information communication standard, it is assumed to be used in a range of about 24 to 86 GHz, and there are also noise filter and radio wave absorber applications in which it is desired to protect a circuit from these signals. In the conventional magnetic body, since the loss component μ″ of the magnetic permeability at 24 to 40 GHz is too low, there is a limit in achieving both noise absorption performance and miniaturization. By using the magnetic body of the present invention, it is possible to achieve both noise absorption performance at 24 to 30 GHz, which is a part of the millimeter wave band, and miniaturization, and the magnetic body can be used for a noise filter and a radio wave absorber applications.

### DESCRIPTION OF REFERENCE SYMBOLS

10: Winding coil
11: Core (magnetic body)
12: Conductive wire
13: Body portion
14, 15: Projecting portion
16, 17: Terminal electrode
20, 20A: Multilayer coil
21: Magnetic body
21A: Core portion
21B: Winding portion
22: Through hole
23: Coil-shaped internal electrode
24, 25: External electrode
30, 40: Antenna
31, 41: Magnetic body
32, 42: Metal antenna wire

1. A soft magnetic composition comprising:
an oxide that contains a W-type hexagonal ferrite having a compositional formula of ACaMe₂Fe₁₆O₂₇ as a main phase, wherein:
A is one or more selected from Ba, Sr, Na, K, La, and Bi,
Ba+Sr+Na+K+La+Bi: 4.7 mol % to 5.8 mol %,
Ba: 0 mol % to 5.8 mol %,
Sr: 0 mol % to 5.8 mol %;
Na: 0 mol % to 5.2 mol %,
K: 0 mol % to 5.2 mol %,
La: 0 mol % to 2.1 mol %,
Bi: 0 mol % to 1.0 mol %,
Ca: 0.2 mol % to 5.0 mol %
Fe: 67.4 mol % to 84.5 mol %,
Me is one or more selected from Co, Cu, Mg, Mn, Ni, and Zn,
Co+Cu+Mg+Mn+Ni+Zn: 9.4 mol % to 18.1 mol %,
Cu: 0 mol % to 1.6 mol %,
Mg: 0 mol % to 17.1 mol %,
Mn: 0 mol % to 17.1 mol %,
Ni: 0 mol % to 17.1 mol %,
Zn: 0 mol % to 17.1 mol %,
Co: 0 mol % to 2.6 mol %,
a charge balance D is 7.8 mol % to 11.6 mol %, when: Me (I)=Na+K+Li, Me (II)=Co+Cu+Mg+Mn+Ni+Zn, Me (IV)=Ge+Si+Sn+Ti+Zr+Hf, Me (V)=Mo+Nb+Ta+Sb+W+V, and D=Me (I)+Me (II)−Me (IV)−2×Me (V),
at least part of the Fe is substituted with M_{2d} in an amount of 0 mol % to 7.8 mol %,
M_{2d} is at least one of In, Sc, Sn, Zr, or Hf,
Sn: 0 mol % to 7.8 mol %,
Zr+Hf: 0 mol % to 7.8 mol %,
In: 0 mol % to 7.8 mol %,
Sc: 0 mol % to 7.8 mol %,
Ge: 0 mol % to 2.6 mol %,
Si: 0 mol % to 2.6 mol %,
Ti: 0 mol % to 2.6 mol %,
Al: 0 mol % to 2.6 mol %,
Ga: 0 mol % to 2.6 mol %,
Mo: 0 mol % to 2.6 mol %,
Nb+Ta: 0 mol % to 2.6 mol %,
Sb: 0 mol % to 2.6 mol %,
W: 0 mol % to 2.6 mol %,
V: 0 mol % to 2.6 mol %,
Li: 0 mol % to 2.6 mol %, and
the soft magnetic composition has a coercivity Hcj of 100 kA/m or less.

2. The soft magnetic composition according to claim 1, wherein the Me is at least one of Mg, Mn, Ni, and Zn, and Mg+Mn+Ni+Zn: 7.8 mol % to 17.1 mol %.

3. The soft magnetic composition according to claim 1, wherein Co is 0.5 mol % or more.

4. The soft magnetic composition according to claim 3, wherein Co is 2.1 mol % or less.

5. The soft magnetic composition according to claim 1, wherein Co is 2.1 mol % or less.

6. The soft magnetic composition according to claim 1, wherein the amount of Mai is 1.0 mol % to 7.8 mol %.

7. The soft magnetic composition according to claim 1, wherein Sr is 0 mol %.

8. The soft magnetic composition according to claim 1, wherein the W-type hexagonal ferrite is a single phase.

9. A sintered body comprising a fired result of the soft magnetic composition according to claim 1.

10. A composite body comprising:
the soft magnetic composition according to claim 1; and
a nonmagnetic body.

11. A paste comprising a mixture of:
the soft magnetic composition according to claim 1; and
a nonmagnetic body.

12. A coil component comprising:
a core portion; and
a winding portion around the core portion,
wherein the core portion is the sintered body according to claim 6, and
the winding portion contains an electric conductor.

13. An antenna comprising:
the sintered body according to claim 6, and
an electric conductor.
